(19) United States
(12) Patent Application Publication
(10) Pub. No.: US 2017/0208132 A1
(43) Pub. Date: Jul. 20, 2017

(54) DYNAMIC ENDPOINT RESOLUTION WAGERING SYSTEM

(71) Applicant: Gamblit Gaming, LLC, Glendale, CA (US)

(72) Inventors: Miles Arnone, Sherborn, MA (US); Eric Meyerhofer, Pasadena, CA (US); Clifford Kaylin, Los Angeles, CA (US)

(21) Appl. No.: 15/473,523

(22) Filed: Mar. 29, 2017

Related U.S. Application Data
(63) Continuation of application No. PCT/US15/53020, filed on Sep. 29, 2015.
(60) Provisional application No. 62/057,096, filed on Sep. 29, 2014.
(60) Provisional application No. 62/056,860, filed on Sep. 29, 2014.

(51) Int. Cl. H04L 29/08

(52) U.S. Cl. CPC H04L 67/141; H04L 67/146; H04L 67/18

(57) ABSTRACT

A dynamic endpoint resolution interleaved wagering system is disclosed, including an interactive processing device constructed to: communicate, to a dynamic endpoint resolution (DER) server, session initiation request data; receive session information; communicate session establishment request; the process controller constructed to: receive session information; receive session establishment request data; determine whether session token received from the interactive processing device matches session token received from the DER server; determine that session token received from the interactive processing device matches session token received from the DER server; establish the session; the DER server operatively connecting the interactive processing device and the process controller, the DER server constructed to: receive session initiation request; communicate location information of the session initiation request; receive location ID data determined; determine a management information entry; determine a process controller to use for the session; generate session information; store session information; communicate session information; communicate session information.

### CROSS REFERENCE TO RELATED APPLICATIONS

This application is a continuation of Patent Cooperation Treaty Application No. PCT/US15/53020, filed on Sep. 29, 2015, which claims the benefit of U.S. Provisional Patent Application No. 62/056,860, filed Sep. 29, 2014 and U.S. Provisional Patent Application No. 62/057,096, filed Sep. 29, 2014, the disclosures of each of which are incorporated by reference herein in their entirety.

### FIELD OF THE INVENTION

Embodiments of the present invention are generally related to communications within data processing systems. More particularly, the present invention relates to the communication and processing of wagering data.

### BACKGROUND

The gaming industry has traditionally developed electronic gaming machines (EGMs) that implement simple wagering propositions. The communication and processing needs for these simple wagering propositions are easily met using conventional EGMs.

For example, U.S. Pat. No. 6,905,405 to McClintic describes a conventional gaming device provided with a central processor (CPU) operably coupled to input logic circuitry and output logic circuitry. The input logic circuitry is employed to operably couple the CPU to input devices such as, for example, a touch screen segment or physical button, a coin acceptor, a bill acceptor, a user tracking card reader or a credit/debit card reader. The output logic circuitry is employed to operably couple the CPU with output devices such as, for example, a hopper, a video monitor, meter displays, and a printer. The CPU is also operably coupled to controlling software memory, which includes assigned memory locations storing game software and system software. Such controlling software memory dictates when selected graphics or messages are displayed to a user, as well as when play sequences begin and end and management of wager input and award output. The CPU is also operably coupled to a second memory, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a user activates an initiator interactive element such as a handle, the physical button or the touch screen to initiate a play sequence. At this point, the game software, in conjunction with a random number generator, generates a random symbol configuration at for a random final outcome comprised of a pattern of symbols for depiction on video monitor. System software then animates the video monitor by simulating the movement of visible representations of symbol carriers including symbols thereon so that the user perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared with data stored in game software representing winning combinations to determine if any displayed combination on an active pay line is a winning combination. Any identified winning combination or combinations of symbols are then associated with winnings to be distributed to the user according to a paytable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Operation of another conventional computer gaming system is described in U.S. Pat. No. 6,409,602 issued to Wiltshire et al. A game program is executed on server/host computer. It is then determined whether an image is to be displayed on a screen of a client/terminal computer. If so, an image is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal computer. The input command may be a keystroke, movement or clicking of the mouse, a voice activated command or even the clicking of a “virtual button” on a touch screen. The client/terminal program causes the input command to be transmitted back to server/host computer via communication pathways, again using network services provided by the client operating system on one end and server operating system on the other. The command is thus received by the server/host interface program, that, in turn, passes the command back to the game program. The game program processes the input command and updates the state of the game accordingly.

However, more complicated wagering processes need communication and processing systems that are better suited for implementing these more complicated wagering processes. Various aspects of embodiments of the present invention meet such a need.

### SUMMARY OF THE INVENTION

Systems and methods in accordance with embodiments of the invention provide a communication and data processing system constructed for a dynamic endpoint resolution interleaved wagering system.

In an aspect of an embodiment of the invention, a process controller operates as an interface between an interactive processing device and a wager server. By virtue of this aspect, the wager server is isolated from the interactive processing device allowing the interactive processing device to operate in an unregulated environment will allowing the wager server to operate in a regulated environment, thus providing for more efficient management of the operations of such a system.

In another aspect of another embodiment of the invention, a single wager server may provide services to two or more interactive processing devices and/or two or more process controllers, thus allowing a dynamic endpoint resolution interleaved wagering system to operate more efficiently over a large range of scaling.

In another aspect of another embodiment of the invention, multiple types of interactive processing devices using different operating systems may be interfaced to a single type of process controller and/or wager server without requiring customization of the process controller and/or the wager server, thus improving the efficiency of the process controller and or the wager server by reducing complexity associated with maintaining separate process controllers and/or wager servers for each type of interactive processing device.

In another aspect of another embodiment of the invention, an interactive processing device may be provided as a user device under control of a user while maintaining the wager server in an environment under the control of a regulated operator of wagering equipment, thus providing for a more economical system as the regulated operator need not expend capital to purchase interactive processing devices.

In another aspect of another embodiment of the invention, data communicated between the controllers may be encrypted to increase security of the dynamic endpoint resolution interleaved wagering system.

In another aspect of another embodiment of the invention, a process controller isolates wager logic and application logic as unregulated logic from a regulated wager server, thus allowing errors in the application logic and/or wager logic to be corrected, new application logic and/or wager logic to be used, or modifications to be made to the application logic and/or wager logic without a need for time-consuming regulatory approval.

In another aspect of another embodiment of the invention, an interactive application may require extensive processing resources from an interactive processing device leaving few processing resources for the functions performed by a process controller and/or a wager server. By virtue of an architecture of the embodiments of the invention, processing loads may be distributed across multiple devices such that operations of the interactive processing device may be dedicated to the interactive application and the processes of the process controller and/or wager server are not burdened by the requirements of the interactive application.

In another aspect of another embodiment of the invention, a dynamic endpoint resolution interleaved wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of a dynamic endpoint resolution interleaved wagering system are distributed in close proximity to each other and communicate using a local area network and/or a communication bus. In several embodiments, an interactive processing device and a process controller of a dynamic endpoint resolution interleaved wagering system are in a common location and communicate with an external wager server. In some embodiments, a process controller and a wager server of a dynamic endpoint resolution interleaved wagering system are in a common location and communicate with an external interactive processing device. In many embodiments, an interactive processing device, a process controller, and a wager server of a dynamic endpoint resolution interleaved wagering system are located in a common location. In some embodiments, a session/management server is located in a common location with a process controller and/or a wager server. In various embodiments, these multiple devices can be constructed from or configured using a single device or a plurality of devices such that a dynamic endpoint resolution interleaved wagering system is executed as a system in a virtualized space such as, but not limited to, where a wager server and a process controller are large scale centralized servers in the cloud operatively connected to widely distributed interactive processing devices via a wide area network such as the Internet or a local area network. In such embodiments, the components of a dynamic endpoint resolution interleaved wagering system may communicate using a networking protocol or other type of device-to-device communications protocol.

In another aspect of another embodiment of the invention, a centralized wager server is operatively connected to, and communicates with, one or more process controllers using a communication link. The centralized wager server can generate wager outcomes for wagers in accordance with one or more wagering propositions. The centralized wager server can execute a number of simultaneous or pseudo-simultaneous wagers in order to generate wager outcomes for a variety of wagering propositions that one or more distributed dynamic endpoint resolution interleaved wagering systems can use.

In another aspect of another embodiment of the invention, a centralized process controller is operatively connected to one or more interactive processing devices and one or more wager servers using a communication link. The centralized process controller can perform the functionality of a process controller across various dynamic endpoint resolution interleaved wagering systems.

In another aspect of another embodiment of the invention, an interactive application server provides a host for managing head-to-head play operating over a network of interactive processing devices connected to the interactive application server using a communication link. The interactive application server provides an environment where users can compete directly with one another and interact with other users.

An embodiment includes an interactive processing device constructed to: communicate, to a dynamic endpoint resolution (DER) server, session initiation request data comprising location information; receive, from the DER server, session information; and communicate, to a process controller, session establishment request data to establish a session of an interactive application with the process controller, the session establishment request data comprising a session token that uniquely identifies the session; the process controller constructed to: receive, from the DER server, the session information; receive, from the interactive processing device, the session establishment request data; determine whether the session token received from the interactive processing device matches a session token received from the DER server; determine that the session token received from the interactive processing device matches the session token received from the DER server; and establish the session with the interactive processing device via an application control layer of the interactive processing device; and the DER server operatively connecting the interactive processing device and the process controller, the DER server constructed to: receive, from the interactive processing device, the session initiation request data; communicate, to a geolocation server, the location information of the session initiation request data; receive, from the geolocation server, location ID data determined based on the location information; determine a management information entry based on the session initiation request data; determine a process controller to use for the session requested in the session initiation request based on the determined management information entry; generate session information, the session information comprising connection information for the process controller, the session token, and a deployment attribute value and a real currency credit wagering attribute value included in the management information entry; store the session information in an active session database in association with the session initiation request data; communicate, to the process controller, the session information; and communicate, to the interactive processing device, the session information.

In a further embodiment, the interactive processing device and the process controller are constructed from the same device, and the process controller is operatively connected to the wager server using a communication link.

In a further embodiment, the wager server and the process controller are constructed from the same device, and the process controller is operatively connected to the interactive processing device using a communication link.

In a further embodiment, the session initiation request data comprises: an interactive application identification of the interactive application of the interactive processing device; a user identification of a user of the interactive processing device; location information of the interactive processing device; and an operator identification of an operator of the interactive application.

In a further embodiment, the interactive processing device determines the location information based on one or more of: information provided by a global positioning system (GPS) device of the interactive processing device, network data provided by a network device that is communicatively coupled to a communication interface device of the interactive processing device, and cellular tower location data received via the communication interface device of the interactive processing device.

In a further embodiment, the management information entry comprises a plurality of attributes.

In a further embodiment, the attributes comprise: a location identification attribute, an interactive application identification attribute, a user identification attribute, and an operator identification attribute.

In a further embodiment, a priority value is assigned to each attribute, and the DER server determines the management information entry based on the priority values.

An embodiment includes an interactive processing device of the dynamic endpoint resolution interleaved wagering system, the interactive processing device constructed to: communicate, to a dynamic endpoint resolution (DER) server, session initiation request data comprising location information; receive, from the DER server, session information; and communicate, to a process controller, session establishment request data to establish a session of an interactive application with the process controller, the session establishment request data comprising a session token that uniquely identifies the session; and the DER server of the dynamic endpoint resolution interleaved wagering system operatively connecting the interactive processing device to the process controller using a communication link, the DER server constructed to: receive, from the interactive processing device, the session initiation request data; communicate, to a geolocation server, the location information of the session initiation request data; receive, from the geolocation server, location ID data determined based on the location information; determine a management information entry based on the session initiation request data; determine a process controller to use for the session requested in the session initiation request based on the determined management information entry; generate session information, the session information comprising connection information for the process controller, the session token, and a deployment attribute value and a real currency credit wagering attribute value included in the management information entry; store the session information in an active session database in association with the session initiation request data; communicate, to the process controller, the session information; and communicate, to the interactive processing device, the session information.

An embodiment includes a process controller of the dynamic endpoint resolution interleaved wagering system, the process controller constructed to: receive, from a dynamic endpoint resolution (DER) server, session information; receive, from an interactive processing device, session establishment request data; determine whether a session token received from the interactive processing device matches a session token received from the DER server; determine that the session token received from the interactive processing device matches the session token received from the DER server; and establish a session with the interactive processing device via an application control layer of the interactive processing device; and the DER server of the dynamic endpoint resolution interleaved wagering system operatively connecting the process controller to the interactive processing device, the DER server constructed to: receive, from the interactive processing device, the session initiation request data; communicate, to a geolocation server, the location information of the session initiation request data; receive, from the geolocation server, location ID data determined based on the location information; determine a management information entry based on the session initiation request data; determine a process controller to use for the session requested in the session initiation request based on the determined management information entry; generate session information, the session information comprising connection information for the process controller, the session token, and a deployment attribute value and a real currency credit wagering attribute value included in the management information entry; store the session information in an active session database in association with the session initiation request data; communicate, to the process controller, the session information; and communicate, to the interactive processing device, the session information.

In an aspect of an embodiment of the invention, a dynamic endpoint resolution wagering system, including an interactive processing device constructed to communicate, to a dynamic endpoint resolution (DER) server, session initiation request data comprising location information; receive, from the DER server, session information; and communicate, to a process controller, session establishment request data to establish a session of an interactive application with the process controller, the session establishment request data comprising a session token that uniquely identifies the session; the process controller constructed to receive, from the DER server, the session information; receive, from the interactive processing device, the session establishment request data; determine whether the session token received from the interactive processing device matches a session token received from the DER server; determine that the session token received from the interactive processing device matches the session token received from the DER server; and establish the session with the interactive processing device via an application control layer of the interactive processing device; and the DER server operatively connecting the interactive processing device and the process controller, the DER server constructed to receive, from the interactive processing device, the session initiation request data; communicate, to a geolocation server, the location information of the session initiation request data; receive, from the geolocation server, location ID data determined based on the location information; determine a management information entry based on the session initiation request data; determine a process controller to use for the session requested in the session initiation request based on the determined management information entry; generate session information, the session information comprising connection information for the process controller, the session token, and a deployment attribute value and a real currency credit wagering attribute value included in the management information entry; store the session information in an active session database in association with the session initiation request data; communicate, to the process controller, the session information; and communicate, to the interactive processing device, the session information.

In another aspect of another embodiment of the invention, the interactive processing device and the process controller are constructed from the same device, and where the process controller is operatively connected to the DER server using a communication link.

In another aspect of another embodiment of the invention, the DER server and the process controller are constructed from the same device, and where the process controller is operatively connected to the interactive processing device using a communication link.

In another aspect of another embodiment of the invention, the session initiation request data comprises: an interactive application identification of the interactive application of the interactive processing device; a user identification of a user of the interactive processing device; location information of the interactive processing device; and an operator identification of an operator of the interactive application.

In another aspect of another embodiment of the invention, the interactive processing device determines the location information based on one or more of: information provided by a global positioning system (GPS) device of the interactive processing device, network data provided by a network device that is communicatively coupled to a communication interface device of the interactive processing device, and cellular tower location data received via the communication interface device of the interactive processing device.

In another aspect of another embodiment of the invention, the management information entry comprises a plurality of attributes.

In another aspect of another embodiment of the invention, the attributes comprise: a location identification attribute, an interactive application identification attribute, a user identification attribute, and an operator identification attribute.

In another aspect of another embodiment of the invention, a priority value is assigned to each attribute, and the DER server determines the management information entry based on the priority values.

In an aspect of an embodiment of the invention, a dynamic endpoint resolution wagering system, including an interactive processing device of the dynamic endpoint resolution interleaved wagering system, the interactive processing device constructed to communicate, to a dynamic endpoint resolution (DER) server, session initiation request data comprising location information; receive, from the DER server, session information; and communicate, to a process controller, session establishment request data to establish a session of an interactive application with the process controller, the session establishment request data comprising a session token that uniquely identifies the session; and the DER server of the dynamic endpoint resolution interleaved wagering system operatively connecting the interactive processing device to the process controller using a communication link, the DER server constructed to receive, from the interactive processing device, the session initiation request data; communicate, to a geolocation server, the location information of the session initiation request data; receive, from the geolocation server, location ID data determined based on the location information; determine a management information entry based on the session initiation request data; determine a process controller to use for the session requested in the session initiation request based on the determined management information entry; generate session information, the session information comprising connection information for the process controller, the session token, and a deployment attribute value and a real currency credit wagering attribute value included in the management information entry; store the session information in an active session database in association with the session initiation request data; communicate, to the process controller, the session information; and communicate, to the interactive processing device, the session information.

In an aspect of an embodiment of the invention, the session initiation request data comprises: an interactive application identification of the interactive application of the interactive processing device; a user identification of a user of the interactive processing device; location information of the interactive processing device; and an operator identification of an operator of the interactive application.

In an aspect of an embodiment of the invention, the interactive processing device determines the location information based on one or more of: information provided by a global positioning system (GPS) device of the interactive processing device, network data provided by a network device that is communicatively coupled to a communication interface device of the interactive processing device, and cellular tower location data received via the communication interface device of the interactive processing device.

In an aspect of an embodiment of the invention, the management information entry comprises a plurality of attributes.

In an aspect of an embodiment of the invention, the attributes comprise: a location identification attribute, an interactive application identification attribute, a user identification attribute, and an operator identification attribute.

In an aspect of an embodiment of the invention, a priority value is assigned to each attribute, and the DER server determines the management information entry based on the priority values.

In an aspect of an embodiment of the invention, including a process controller constructed to receive, from a dynamic endpoint resolution (DER) server, session information; receive, from an interactive processing device, session establishment request data; determine whether a session token received from the interactive processing device matches a session token received from the DER server; determine that the session token received from the interactive processing device matches the session token received from the DER server; and establish a session with the interactive processing device via an application control layer of the interactive processing device; and the DER server of the dynamic endpoint resolution interleaved wagering system operatively connecting the process controller to the interactive processing device, the DER server constructed to receive, from the interactive processing device, the session initiation request data; communicate, to a geolocation server, the location information of the session initiation request data; receive, from the geolocation server, location ID data determined based on the location information; determine a management information entry based on the session initiation request data; determine a process controller to use for the session requested in the session initiation request based on the determined management information entry; generate session information, the session information comprising connection information for the process controller, the session token, and a deployment attribute value and a real currency credit wagering attribute value included in the management information entry; store the session information in an active session database in association with the session initiation request data; communicate, to the process controller, the session information; and communicate, to the interactive processing device, the session information.

In an aspect of an embodiment of the invention, the session initiation request data comprises: an interactive application identification of the interactive application of the interactive processing device; a user identification of a user of the interactive processing device; location information of the interactive processing device; and an operator identification of an operator of the interactive application.

In an aspect of an embodiment of the invention, the interactive processing device determines the location information based on one or more of: information provided by a global positioning system (GPS) device of the interactive processing device, network data provided by a network device that is communicatively coupled to a communication interface device of the interactive processing device, and cellular tower location data received via the communication interface device of the interactive processing device.

In an aspect of an embodiment of the invention, the management information entry comprises a plurality of attributes.

In an aspect of an embodiment of the invention, the attributes comprise: a location identification attribute, an interactive application identification attribute, a user identification attribute, and an operator identification attribute.

In an aspect of an embodiment of the invention, a priority value is assigned to each attribute, and the DER server determines the management information entry based on the priority values.

### BRIEF DESCRIPTION OF THE DRAWINGS

FIG. 1A is a diagram of a structure of a dynamic endpoint resolution interleaved wagering system in accordance with various embodiments of the invention.

FIG. 1B is a diagram of a land-based configuration of a dynamic endpoint resolution interleaved wagering system in accordance with various embodiments of the invention.

FIG. 1C is another diagram of a land-based configuration of a dynamic endpoint resolution interleaved wagering system in accordance with various embodiments of the invention.

FIG. 1D is a diagram of a network configuration of a dynamic endpoint resolution interleaved wagering system in accordance with various embodiments of the invention.

FIG. 1E is a diagram of a mobile configuration of a dynamic endpoint resolution interleaved wagering system in accordance with various embodiments of the invention.

FIGS. 2A, 2B, 2C, and 2D are illustrations of interactive processing devices of a dynamic endpoint resolution interleaved wagering system in accordance with various embodiments of the invention.

FIGS. 3A, 3B and 3C are diagrams of distributed dynamic endpoint resolution interleaved wagering systems in accordance with various embodiments of the invention.

FIGS. 4A and 4B are diagrams of a structure of an interactive processing device of a dynamic endpoint resolution interleaved wagering system in accordance with various embodiments of the invention.

FIGS. 5A and 5B are diagrams of a structure of a wager server of a dynamic endpoint resolution interleaved wagering system in accordance with various embodiments of the invention.

FIGS. 6A and 6B are diagrams of a structure of a process controller of a dynamic endpoint resolution interleaved wagering system in accordance with various embodiments of the invention.

FIGS. 7A and 7B are diagrams of a structure of a session/management server of a dynamic endpoint resolution interleaved wagering system in accordance with various embodiments of the invention.

FIG. 8 is a sequence diagram of interactions between components of a dynamic endpoint resolution interleaved wagering system in accordance with various embodiments of the invention.

FIG. 9 is a collaboration diagram for components of a dynamic endpoint resolution interleaved wagering system in accordance with various embodiments of the invention.

FIG. 10 illustrates user registration and user profiles in accordance with an example embodiment.

FIG. 11 is a diagram in accordance with an embodiment of the dynamic endpoint resolution interleaved wagering system.

FIG. 12 is a diagram of a structure of a data processing device of an embodiment of a dynamic endpoint resolution interleaved wagering system.

FIG. 13 is a diagram of a structure of a data processing device of an embodiment of a dynamic endpoint resolution interleaved wagering system.

FIG. 14 is a diagram of a structure of a data processing device of an embodiment of a dynamic endpoint resolution interleaved wagering system.

FIG. 15 is a diagram of a structure of a data processing device of an embodiment of a dynamic endpoint resolution interleaved wagering system.

FIGS. 16A-H depict exemplary management information, namely application management information in accordance with an embodiment of the invention.

FIG. 17 depicts an exemplary process controller management information for configuration of process controllers.

FIG. 18 is a sequence diagram for a process of establishing a dynamic endpoint resolution interleaved wagering system session in accordance with embodiments of the invention.

FIG. 19 depicts a process diagram for a process of using a DER server, in accordance with embodiments of the invention.

FIG. 20 depicts a process diagram for determining a matching process controller management information entry, in accordance with embodiments of the invention.

FIG. 21 illustrates a diagram of an exemplary system in accordance with various embodiments of the invention.

FIG. 22 illustrates a diagram of an exemplary system according to various embodiments of the invention.

FIG. 23 illustrates an exemplary process for application feedback in a dynamic endpoint resolution interleaved wagering system based on wagering outcome, according to various embodiments of the invention.

### DETAILED DESCRIPTION

A dynamic endpoint resolution interleaved wagering system interleaves wagering with non-wagering activities. In some embodiments of a dynamic endpoint resolution interleaved wagering system, an interactive application executed by an interactive processing device provides non-wagering interactive components of the dynamic endpoint resolution interleaved wagering system. The interactive processing device is operatively connected to a process controller that manages and configures the interactive processing device and the interactive application, and determines when wagers should be interleaved with the operations of the interactive application. The process controller is further operatively connected to a wager server that provides one or more wagering propositions for one or more wagers.

In some embodiments, the interactive processing device also provides a wagering interface that is used to receive commands and display data for a wagering process, including but not limited to a wager outcome of a wager made in accordance with a wagering proposition. The content of the wagering interface is controlled by the process controller and includes content provided by the wager server.

In various embodiments, the interactive processing device provides a management interface used to manage a user profile including an electronic wallet for deposit and withdrawals of credits used for wagering.

Many different types of interactive applications may be utilized with the dynamic endpoint resolution interleaved wagering system. In some embodiments, the interactive application reacts to the physical activity of a user. In these embodiments, the interactive application senses user interactions with the interactive application through one or more sensors that monitor the user's physical activities. Such sensors may include, but are not limited to, physiological sensors that monitor the physiology of the user, environmental sensors that monitor the physical environment of the interactive processing device, accelerometers that monitor changes in motion of the interactive processing device, and location sensors that monitor the location of the interactive processing device such as global positioning sensors.

In some embodiments, the interactive application is skill-based and interacts with the user by sensing skillful interactions with an interactive display generated by the interactive application.

In some embodiments, the interactive application is a tool used to achieve some useful goal.

In operation, the interactive application generates various types of interactive elements in an interactive application environment. In some embodiments, these interactive elements are interactive application resources utilized within the interactive application environment to provide an interactive experience for a user. Wagers of credits or interactive elements are made in accordance with a wagering proposition as automatically triggered by interaction with one or more of the interactive elements of the interactive application. Wager outcomes of wagers of credits or interactive elements made in accordance with the wagering proposition can cause consumption, loss or accrual of credits or interactive elements.

In accordance with some embodiments, wager outcomes of wagering events can influence interactive elements in the interactive application environment such as, but not limited to, automatically providing one or more new interactive elements, automatically restoring one or more consumed interactive elements, automatically causing the loss of one or more interactive elements, and automatic restoration or placement of one or more fixed interactive elements.

In various embodiments, the wagers may be made using one or more credits (Cr).

In some embodiments, Cr can be one or more credits that are purchased using, and redeemed in, a real world currency having a real world value.

In many embodiments, Cr can be one or more credits in a virtual currency. Virtual currency is an alternate currency that can be acquired, purchased or transferred by or to a user, but does not necessarily directly correlate to a real world currency. In many such embodiments, Cr in a virtual currency are allowed to be purchased using a real world currency but are prevented from being redeemed in a real world currency having a real world value.

In several embodiments, interaction with the interactive elements of the interactive application, application environment credit (AC) can be optionally consumed and/or accrued within the interactive application as a result of interaction with the interactive elements. AC can be in the form of, but is not limited to, application environment credits, experience points, and points generally.

In various embodiments, AC is awarded on the basis of skillful interactions with the interactive elements of a skill-based interactive application. The skill-based interactive application can have one or more scoring criteria, embedded within a process controller and/or an interactive processing device that provides the skill-based interactive application, that can be used to determine performance against one or more goals of the skill-based interactive application.

In many embodiments, AC can be used to purchase in-application items, including but not limited to, application interactive elements that have particular properties, power ups for existing items, and other item enhancements.

In some embodiments, AC may be used to earn entrance into a sweepstakes drawing, to earn entrance in a tournament with prizes, to score in the tournament, and/or to participate and/or score in any other game event.

In several embodiments, AC can be stored on a user-tracking card or in a network-based user tracking system where the AC is attributed to a specific user.

In many embodiments, a wagering proposition includes a wager of AC for a wager outcome of a randomly generated payout of interactive application AC, interactive elements, and/or interactive application objects in accordance with a wagering proposition.

In a number of embodiments, a wager of an amount of Cr results in a wager outcome of a payout of AC, interactive elements, and/or interactive application objects that have a Cr value if cashed out.

In some embodiments, such as when an interactive application is a skill-based interactive application, interactive application objects include in-application objects that may be utilized to enhance interactions with the skill-based interactive application. Such objects include, but are not limited to, power-ups, enhanced in-application items, and the like. In some embodiments, the interactive application objects include objects that are detrimental to interactions with the skill-based interactive application such as, but not limited to, obstructions in the skill-based interactive application space, a temporary handicap, an enhanced opponent, and the like.

In some embodiments, interactive elements in an interactive application include, but are not limited to, enabling interactive elements (EIE) that are interactive application environment resources utilized during interaction with an interactive application and whose utilization automatically triggers execution of a wager in accordance with a wagering proposition. In some embodiments, interactive elements in an interactive application include, but are not limited to, a reserve enabling interactive element (REIE), that is an interactive element that is automatically converted into one or more enabling interactive elements upon occurrence of a release event during an interactive session of an interactive application. In yet another embodiment, interactive elements in an interactive application include, but are not limited to, an actionable interactive element (AIE) that is an interactive element that is acted upon during a session of the interactive application to automatically trigger a wager in accordance with a wagering proposition and may or may not be restorable during normal interaction with the interactive application. In yet another embodiment, interactive elements in an interactive application include a common enabling interactive element (CEIE) that is an interactive element that the interactive application shares between two or more users and causes a wagering event and associated wager to be automatically triggered in accordance with the wagering proposition when interacted with during a session. In some embodiments, a user can utilize interactive elements during interactions with a controlled entity (CE) provided by an interactive application to a user.

In accordance with some embodiments of a dynamic endpoint resolution interleaved wagering system, the triggering of the wagering event and/or wager can be dependent upon an interactive application environment variable such as, but not limited to, a required object (RO), a required environmental condition (REC), or a controlled entity characteristic (CEC). A RO is a specific interactive application object in an interactive application acted upon for an AE to be completed. A non-limiting example of an RO is a specific key needed to open a door. An REC is an interactive application state present within an interactive application for an AE to be completed. A non-limiting example of an REC is daylight whose presence enables a character to walk through woods. A CEC is a status of a controlled entity (CE) within an interactive application for an AE to be completed. A non-limiting example of a CEC is requirement that a CE have full health points before entering battle. Although various interactive application resources such as, but not limited to, the types of interactive application interactive elements as discussed herein may be used to automatically trigger a wager in accordance with a wagering proposition, one skilled in the art will recognize that any interactive application resource can be utilized in a dynamic endpoint resolution interleaved wagering system to automatically trigger a wager.

In several embodiments, a dynamic endpoint resolution interleaved wagering system can utilize a process controller to continuously monitor use of the interactive application executed by an interactive processing device in order to detect a trigger of a wagering event and automatically trigger a wager based on the wagering event. The trigger for the wagering event can be detected by the process controller from the utilization of the interactive application in accordance with at least one wagering event occurrence rule. The trigger of the wagering event can be communicated to a wager server. In response to notification of the trigger, the wager server executes a wager in accordance with a wagering proposition. In addition, use of an interactive application in a dynamic endpoint resolution interleaved wagering system can be controlled by the process controller based upon the wager outcome.

In several embodiments, a wagering event occurrence can be determined from one or more application environment variables within an interactive application environment that are used to trigger a wager and/or associated wager in accordance with a wagering proposition. Application environment variables can include, but are not limited to, passage of a period of time during dynamic endpoint resolution interleaved wagering system interactive application use, a result from a dynamic endpoint resolution interleaved wagering system interactive application session (such as, but not limited to, achieving a goal or a particular score), consumption of an interactive element, or an interaction that achieves a combination of interactive elements to be associated with a user profile.

In numerous embodiments, an interactive application instruction is an instruction by a process controller to an interactive processing device and/or an interactive application of the interactive processing device to modify a state of an interactive application or modify one or more interactive application resources or interactive elements. In some embodiments, the interactive application commands may be automatically generated by the process controller using one or more of a wager outcome and/or application environment variables. An interactive application instruction can be used by a process controller control many processes of an interactive application, such as, but not limited to, an causing an addition of a period of time available for a current interactive application session for the interactive application, an addition of a period of time available for a future dynamic endpoint resolution interleaved wagering system interactive application session or any other modification to the interactive application interactive elements that can be utilized during an interactive application session. In some embodiments, an interactive application instruction can be used by the process controller to modify a type of interactive element whose consumption triggers a wagering event occurrence. In many embodiments, an interactive application instruction can be used by the process controller to modify a type of interactive element whose consumption is not required in a wagering event occurrence.

In several embodiments, a process controller of a dynamic endpoint resolution interleaved wagering system may provide for a communications interface for asynchronous communications between a wager server and an interactive application provided by an interactive processing device, by operatively connecting the interactive processing device, and thus the interactive processing device's interactive application, with the wager server.

In some embodiments, asynchronous communications provided for by a dynamic endpoint resolution interleaved wagering system may reduce an amount of idle waiting time by an interactive processing device of the dynamic endpoint resolution interleaved wagering system, thus increasing an amount of processing resources that the interactive processing device may provide to an interactive application or other processes of the interactive processing device. In many embodiments, asynchronous communications provided for by a dynamic endpoint resolution interleaved wagering system reduces an amount of idle waiting time by a wager server, thus increasing an amount of processing resources that the wager server may provide to execution of wagers to determine wager outcomes, and other processes provided by the wager server.

In some embodiments, a wager server of a dynamic endpoint resolution interleaved wagering system may be operatively connected to a plurality of interactive processing devices through one or more process controllers and the asynchronous communications provided for by the one or more process controllers allows the wager server to operate more efficiently by providing wager outcomes to a larger number of interactive processing devices than would be achievable without the one or more process controllers of the dynamic endpoint resolution interleaved wagering system.

In some embodiments, a dynamic endpoint resolution interleaved wagering system including a process controller operatively connected to a wager server and operatively connected to an interactive processing device may provide for simplified communication protocols for communications of the interactive processing device as the interactive processing device may communicate interactions with an interactive application provided by the interactive processing device to the process controller without regard to a nature of a wagering proposition to be interleaved with processes of the interactive application.

In various embodiments, a dynamic endpoint resolution interleaved wagering system including a process controller operatively connected to a wager server and operatively connected to an interactive processing device may provide for simplified communication protocols for communications of the wager server as the wager server may receive wager requests and communicate wager outcomes without regard to a nature of an interactive application provided by the interactive processing device.

In some embodiments, a dynamic endpoint resolution interleaved wagering system including a process controller operatively connecting a wager server to an interactive processing device may provide for reduced processing requirement for the interactive processing device by offloading the execution of a pseudo random or random number generator from the interactive processing device to the wager server. In various such embodiments, additional processing resources may be made available to graphics processing or other processing intensive operations by the interactive processing device because of the offloaded random number processing.

In various embodiments, a dynamic endpoint resolution interleaved wagering system including a process controller operatively connecting a wager server to an interactive processing device provides for operation of the interactive processing device in an unsecure location or manner, while providing for operation of the wager server in a secure location or manner.

In some embodiments, a dynamic endpoint resolution interleaved wagering system including a process controller operatively connecting a wager server to an interactive processing device allows the interleaved wagering system to have regulated components coupled to unregulated components in a heterogeneous regulated environment. For example, in several such embodiments, the interactive processing device may be a device that is not regulated by a wagering regulatory agency whereas the wager server is regulated by the wagering regulatory agency. A process controller of a dynamic endpoint resolution interleaved wagering system may provide for isolation of the processing of the interactive processing device from the processing of the wager server. In such a heterogeneous regulatory environment, the process controller may or may not be itself a regulated by the wagering regulatory authority. In addition, components of an interactive application executed by the interactive processing device may be either regulated or unregulated by the wagering regulatory agency.

### Dynamic Endpoint Resolution Wagering Interleaved Systems

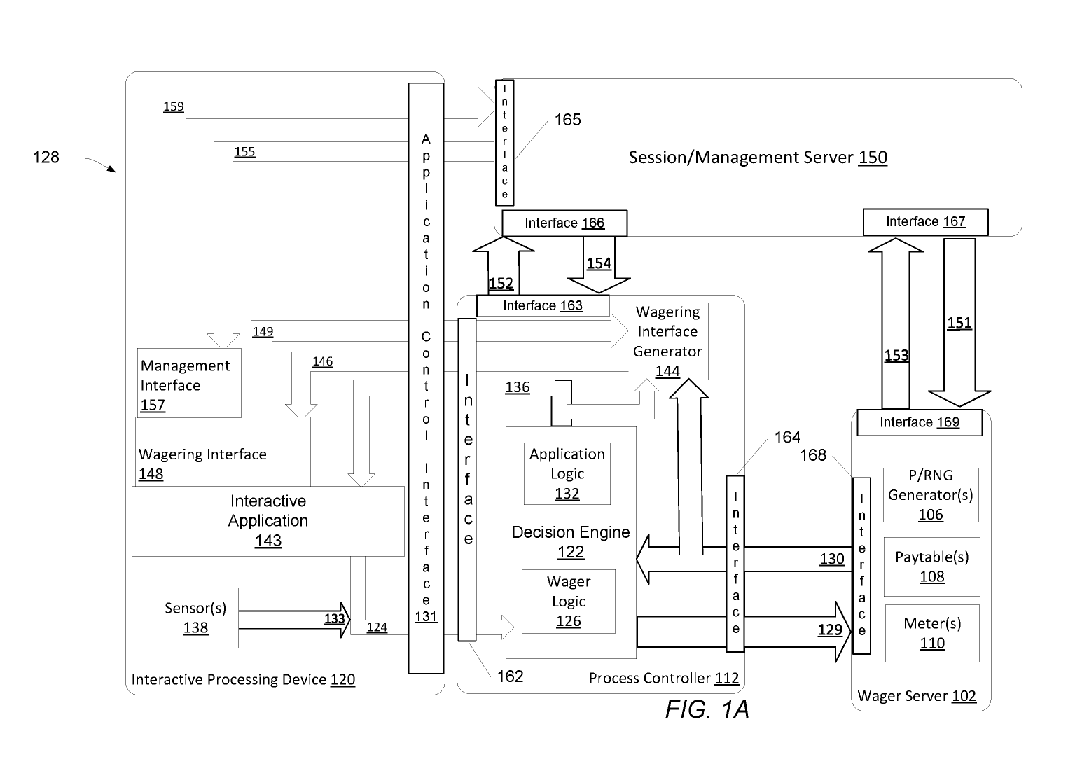

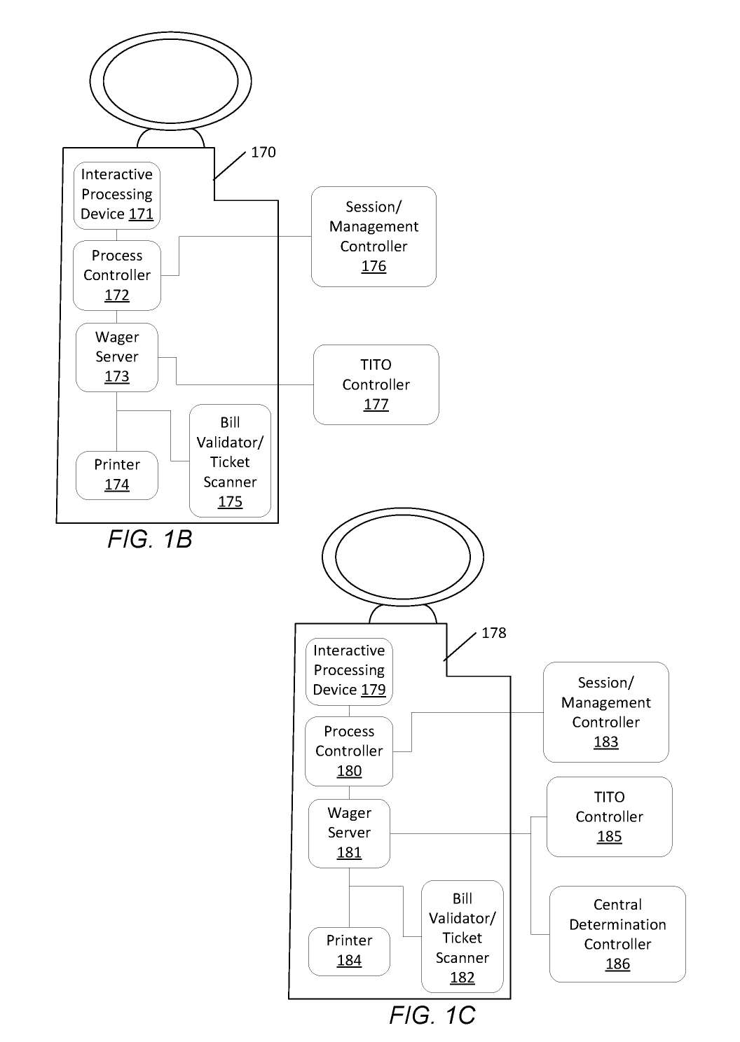

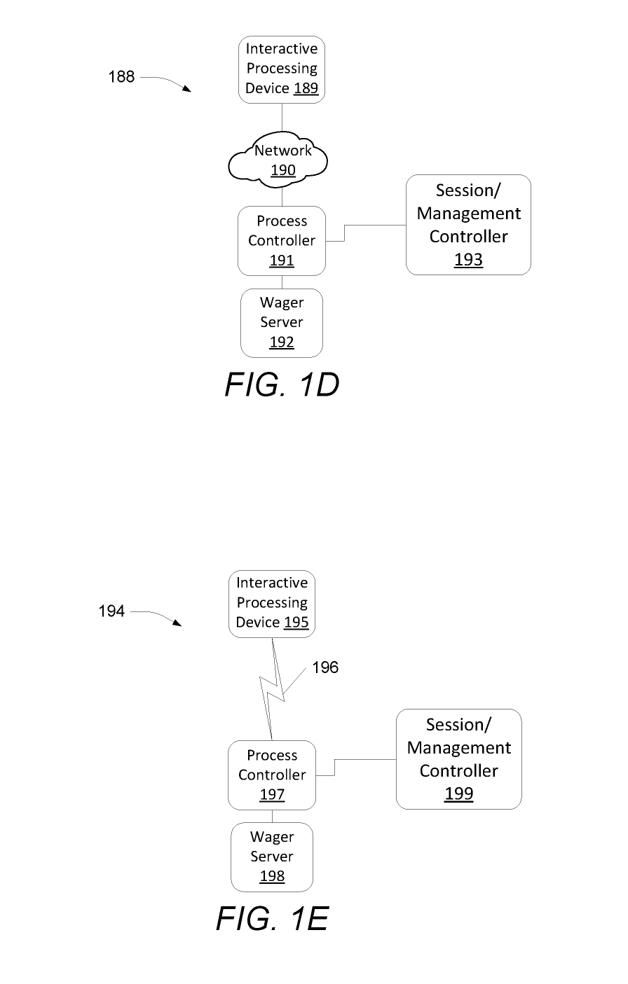

FIG. 1A is a diagram of a structure of a dynamic endpoint resolution interleaved wagering system in accordance with various embodiments of the invention. The dynamic endpoint resolution interleaved wagering system 128 includes an interactive processing device 120, a process controller 112, and a wager server 102. The interactive processing device 120 is operatively connected to, and communicates with, the process controller 112. The process controller 112 is also operatively connected to, and communicates with, the wager server 102. In some embodiments, a dynamic endpoint resolution interleaved wagering system includes a session/management server 150 operatively connected to one or more other components of the dynamic endpoint resolution interleaved wagering system.

In various embodiments, the wager server 102 includes one or more interfaces, 168 and 169, that operatively connect the wager server 102 to one or more session management servers, such as session/management server 150, and/or to one or more process controllers, such as process controller 112, by their respective interfaces.

In some embodiments, one or more of the wager server interfaces implement a wager server to device or server communication protocol employing an interprocess communication protocol so that the wager server and one or more of a process controller, and/or a session/management server may be implemented on the same device. In operation, the wager server interfaces provide application programming interfaces or the like that are used by the wager server to communicate outgoing data and receive incoming data by passing parameter data to another process or application running on the same device.

In some embodiments, one or more of the wager server interfaces implement a wager server communication protocol employing an interdevice communication protocol so that the wager server may be implemented on a device separate from the one or more process controllers and/or the one or more session/management servers. The interdevice protocol may utilize a wired communication bus or wireless connection as a physical layer. In various embodiments, one or more of the wager server interfaces implement a wager server communication protocol employing a networking protocol so that the wager server may be operatively connected to the one or more session/management servers, and/or the one or more process controllers by a network. The networking protocol may utilize a wired communication bus or wireless connection as a physical layer. In many such embodiments, the network includes a cellular telephone network or the like. During operation, the one or more wager server interfaces communicate outgoing data to an external device or server by encoding the data into a signal and transmitting the signal to the external device or server. The one or more wager server interfaces receive incoming data from an external device or server by receiving a signal transmitted by the external device or server and decoding the signal to obtain the incoming data.

In several embodiments, the wager server 102 is a controller for providing one or more wagering propositions provided by the dynamic endpoint resolution interleaved wagering system 128 and automatically executes wagers in accordance with the wagering propositions as instructed by the process controller 112. Types of value of a wager can be one or more of several different types. Types of value of a wager can include, but are not limited to, a wager of an amount of Cr corresponding to a real currency or a virtual currency, a wager of an amount of AC earned through interaction with an interactive application, a wager of an amount of interactive elements of an interactive application, and a wager of an amount of objects used in an interactive application. A wager outcome determined for a wager in accordance with a wagering proposition can increase or decrease an amount of the type of value used in the wager, such as, but not limited to, increasing or decreasing an amount of Cr for a wager of Cr. In various embodiments, a wager outcome determined for a wager in accordance with a wagering proposition can increase or decrease an amount of a type of value that is different than a type of value of the wager, such as, but not limited to, increasing an amount of an object of an interactive application for a wager of Cr.

In many embodiments, the wager server 102 includes one or more pseudo random or random number generators (P/RNG) 106 for generating random results, one or more paytables 108 for determining a wager outcome from the random results, and one or more credit or value meters 110 for storing amounts of wagered and won credits.

In operation, the one or more P/RNGs 106 execute processes that generate random or pseudo random results. The one or more paytables 108 are tables that the wager server 102 uses to map the random or pseudo random results to a wager outcome. The wager outcome can included, but is not limited to, an amount of Cr, AC, and/or interactive elements or objects won as a function of multiuser interleaved wagering system use. There can be one or more paytables 108 in the wager server 102. The paytables 108 are used to implement one or more wagering propositions in conjunction with a random output of the one or more P/RNGs. For example, in one embodiment of a wager server, the wager server continuously generates pseudo random numbers using the P/RNGs 106. A most current pseudo random number is stored in a buffer. When the wager server receives a request for a wager outcome, the wager server uses the stored pseudo random number along with a paytable that the wager server selects from the paytables 108. The selected paytable includes a mapping of values in the range of values of the pseudo random number to specified multipliers to be applied to an amount of Cr, AC and/or interactive application objects wagered. The multiplier is applied to the amount of Cr, AC and/or interactive application objects wagered and the resultant outcome is a wagering outcome for a wagering proposition.

In some embodiments, a range of the value of the pseudo random number is mapped to a symbol representing a random element of a traditional wagering proposition, and the mapped to symbol is used in conjunction with the paytable. In one such embodiment, the pseudo random number is mapped to a virtual card of a deck of virtual cards. In another such embodiment, the pseudo random number is mapped to a virtual face of a virtual die. In yet another such embodiment, the pseudo random number is mapped to symbol of a virtual reel strip on a virtual reel slot machine. In yet another such embodiment, the pseudo random number is mapped to a pocket of a virtual roulette wheel. In some embodiments, two or more pseudo numbers are mapped to appropriate symbols to represent a completed wagering proposition. In one such embodiment, two or more pseudo numbers are mapped to faces of two or more virtual dice to simulate a random outcome generated by throwing two or more dice. In another such embodiment, multiple pseudo random numbers are mapped to virtual cards from a virtual deck of cards without replacement. In yet another such embodiment, two or more pseudo random numbers are mapped to two or more virtual reel strips to create stop positions for a virtual multi-reel slot machine.

In some embodiments, a wager server executes a wager in accordance with a wagering proposition by executing wager execution commands that define processes of a wagering proposition where the wager execution commands are formatted in a scripting language. In operation, a decision engine of a process controller generates the wager execution commands in the form of a script written in the scripting language. The script includes the wager execution commands that describe how the wager server is to execute the wagering proposition. The completed script is encoded as wager execution command data and communicated to the wager server by the process controller. The wager server receives the wager execution command data and parses the script encoded in the wager execution command data and executes the commands included in the script to execute the wager.

In some embodiments, a wager server executes a wager in accordance with a wagering proposition by executing wager execution commands that define processes of the wagering interface. In operation, a decision engine of a process controller generates the wager execution commands and encodes the wager execution commands into wager execution command data that are communicated to the wager server by the process controller. The wager server receives the wager execution command data and executes the commands encoded in the wager execution command data to execute the wager.

In various embodiments, the interactive processing device 120 provides an interactive application 143 and provides human input devices (HIDs) and output devices for interacting with a user. The interactive processing device 120 provides for interactions 142 with the interactive application 143 by receiving input from a user through the HIDs and providing outputs such as video, audio and/or other sensory output to the user using the output devices.

The interactive processing device 120 is operatively connected to, and communicates with, the process controller 112. The interactive processing device communicates application telemetry data 124 to the process controller 112 and receives application instruction and resource data 136 from the process controller 112. Via the communication of application instruction and resource data 136, the process controller 112 can control the processing of the interactive processing device by communicating interactive application commands and resources including control parameters to the interactive application 143 during the interactive application's execution by the interactive processing device 120.

In some embodiments, during execution of the interactive application 143 by the interactive processing device 120, the interactive processing device 120 communicates, as application telemetry data, interactions with the interactive application to the process controller 112. The application telemetry data 124 includes, but is not limited to, utilization of the interactive elements in the interactive application 143.

In some embodiments, the interactive application 143 is a skill-based interactive application. In such embodiments, execution of the skill-based interactive application 143 by the interactive processing device 120 is based on a user's skillful interaction with the skill-based interactive application, such as, but not limited to, the user's utilization of the interactive elements of the skill-based interactive application 143 during the user's skillful interaction with the skill-based interactive application 143. In such an embodiment, the process controller 112 communicates with the interactive processing device 120 in order to allow the coupling of the skill-based interactive application 143 to wagers made in accordance with a wagering proposition of the wager controller 102.

In some embodiments, the interactive processing device 120 includes one or more sensors 138 that sense various aspects of the physical environment of the interactive processing device 120. Examples of sensors include, but are not limited to: global positioning sensors (GPSs) for sensing communications from a GPS system to determine a position or location of the interactive processing device; temperature sensors; accelerometers; pressure sensors; and the like. Sensor telemetry data 133 is communicated by the interactive processing device to the process controller 112 as part of the application telemetry data 124. The process controller 112 receives the sensor telemetry data 133 and uses the sensor telemetry data to make wager decisions.

In many embodiments, the interactive processing device 120 includes a wagering interface 148 used to display wagering data.

In various embodiments, an application control interface 131 resident in the interactive processing device 120 provides an interface between the interactive processing device 120 and the process controller 112.

In some embodiments, the application control interface 131 implements an interactive processing device to process controller communication protocol employing an interprocess communication protocol so that the interactive processing device and the process controller may be implemented on the same device. In operation, the application control interface 131 provides application programming interfaces that are used by the interactive processing application 143 of the interactive processing device 120 to communicate outgoing data and receive incoming data by passing parameter data to another process or application.

In some embodiments, the application control interface 131 implements an interactive processing device to process controller communication protocol employing an interdevice communication protocol so that the interactive processing device and the process controller may be implemented on different devices. The interdevice protocol may utilize a wired communication bus or wireless connection as a physical layer. In various embodiments, the application control interface 131 implements an interactive processing device to process controller communication protocol employing a networking protocol so that the interactive processing device and the process controller may be implemented on different devices connected by a network. The networking protocol may utilize a wired communication bus or wireless connection as a physical layer. In many such embodiments, the network includes a cellular telephone network or the like and the interactive processing device is a mobile device such as a smartphone or other device capable of using the telephone network. During operation, the application control interface 131 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the process controller 112 includes one or more interfaces, 162, 163 and 164, that operatively connect the process controller 112 to one or more interactive processing devices, such as interactive processing device 120, to one or more session management servers, such as session/management server 150, and/or to one or more wager servers, such as wager server 102, respectively.

In some embodiments, one or more of the process controller interfaces implement a process controller to device or server communication protocol employing an interprocess communication protocol so that the process controller and one or more of an interactive processing device, a wager server, and/or a session/management server may be implemented on the same device. In operation, the process controller interfaces provide application programming interfaces or the like that are used by the process controller to communicate outgoing data and receive incoming data by passing parameter data to another process or application running on the same device.

In some embodiments, one or more of the process controller interfaces implement a process controller communication protocol employing an interdevice communication protocol so that the process controller may be implemented on a device separate from the one or more interactive processing devices, the one or more session/management servers and/or the one or more wager servers. The interdevice protocol may utilize a wired communication bus or wireless connection as a physical layer. In various embodiments, one or more of the process controller interfaces implement a process controller communication protocol employing a networking protocol so that the process controller may be operatively connected to the one or more interactive processing devices, the one or more session/management servers, and/or the one or more wager servers by a network. The networking protocol may utilize a wired communication bus or wireless connection as a physical layer. In many such embodiments, the network includes a cellular telephone network or the like and the one or more interactive processing devices include a mobile device such as a smartphone or other device capable of using the telephone network. During operation, the one or more process controller interfaces communicate outgoing data to an external device or server by encoding the data into a signal and transmitting the signal to the external device or server. The one or more process controller interfaces receive incoming data from an external device or server by receiving a signal transmitted by the external device or server and decoding the signal to obtain the incoming data.

In many embodiments, process controller 112 provides an interface between the interactive application 143 provided by the interactive processing device 120 and a wagering proposition provided by the wager server 102.

The process controller 112 includes a rule-based decision engine 122 that receives telemetry data, such as application telemetry data 124 and sensor telemetry data 133, from the interactive processing device 120. The rule-based decision engine 122 uses the telemetry data, along with wager logic 126 to generate wager execution commands 129 that are used by the process controller 112 to command the wager server 102 to execute a wager. The wager execution command data is communicated by the process controller 112 to the wager server 102. The wager server 102 receives the wager execution command data 129 and automatically executes a wager in accordance with the wager execution command data 129.

In an embodiment, the application telemetry data 124 used by the decision engine 122 encodes data about the operation of the interactive application 143 executed by the interactive processing device 120. In some embodiments, the application telemetry data 124 encodes interactions of a user, such as a user's interaction with an interactive element of the interactive application 143. In many embodiments, the application telemetry data 124 includes a state of the interactive application 143, such as values of variables that change as the interactive application 143 is executed. The decision engine 122 includes one or more rules as part of wager logic 126 used by the decision engine 122 to determine when a wager should be automatically triggered. Each rule includes one or more variable values constituting a pattern that is to be matched by the process controller 112 using the decision engine 122 to one or more variable values encoded in the application telemetry data 124. Each rule also includes one or more actions that are to be taken if the pattern is matched. Actions can include automatically generating wager execution command data 129 and communicating the wager execution command data 129 to the wager server 102, thus commanding the wager server to automatically execute a wager as described herein. During operation, the decision engine 122 receives application telemetry data 124 from the interactive processing device 124 via interface 160. The decision engine 122 performs a matching process of matching the variable values encoded in the application telemetry data 124 to one or more variable patterns of one or more rules. If a match between the variable values and a pattern of a rule is determined, then the process controller 112 performs the action of the matched rule.

In some embodiments, the application telemetry data 124 includes, but is not limited to, application environment variables that indicate a state of the interactive application 143, interactive processing device data indicating a state of the interactive processing device 120, and interactions with the interactive application 143 during execution of the interactive application 143 by the interactive processing device 120. The wager execution command data 129 may include, but are not limited to, an amount and type of the wager, a trigger of the wager, and a selection of a paytable to be used when executing the wager.

In some embodiments, the process controller 112 receives wager outcome data 130 from the wager server 102. The decision engine 122 uses the wager outcome data 130, in conjunction with the telemetry data 124 and application logic 132, to automatically generate interactive application instruction and resource data 136 that the process controller 112 communicates to the interactive processing device 120 via interfaces 160 and 131.

In an embodiment, the wager outcome data 130 used by a decision engine encodes data about the execution of a wager executed by the wager server 102. In some embodiments, the wager outcome data 130 encodes values of variables including an amount of credits wagered, an amount of credits won and values of credits stored in the one or more meters 110 of the wager server. In many embodiments, the wager outcome data includes a state of the wager server 102, such as values of variables that change as the wager server 102 executes wagers. The decision engine 122 includes one or more rules as part of application logic 132 used by the decision engine 122 to automatically generate the interactive application instruction and resource data 136 that is then communicated to the interactive processing device 120. Each rule includes one or more variable values constituting a pattern that is to be matched to one or more variable values encoded in the wager outcome data 130. Each rule also includes one or more actions that are to be automatically taken by the process controller 112 if the pattern is matched. Actions can include automatically generating interactive application instruction and resource data 136 and using the interactive application instruction and resource data 136 to control the interactive processing device 120 to affect execution of the interactive application 143 as described herein. During operation, the process controller 112 receives the wager outcome data 130 from the wager server 102 via interface 162. The process controller 112 uses the decision engine 122 to match the variable values encoded in the wager outcome data to one or more patterns of one or more rules of the application logic 132. If a match between the variable values and a pattern of a rule is found, then the process controller automatically performs the action of the matched rule. In some embodiments, the process controller 112 uses the application telemetry data 124 received from the interactive processing device 120 in conjunction with the wager outcome data 130 to generate the interactive application instruction and resource data 136.

The interactive processing device receives the interactive application commands and resource data 136 and automatically uses the interactive application instruction and resource data 136 to configure and command the processes of the interactive application 143.

In some embodiments, the interactive application 143 operates utilizing a scripting language. The interactive application 143 parses scripts written in the scripting language and executes commands encoded in the scripts and sets variable values as defined in the scripts. In operation of such embodiments, the process controller 112 automatically generates interactive application instruction and resource data 136 in the form of scripts written in the scripting language that are communicated to the interactive processing device 120 during execution of the interactive application 143. The interactive processing device 120 receives the scripts and passes them to the interactive application 143. The interactive application 143 receives the scripts, parses the scripts and automatically executes the commands and sets the variable values as encoded in the scripts.

In many embodiments, the interactive application 143 automatically performs processes as instructed by commands communicated from the process controller 112. The commands command the interactive application 143 to perform specified operations such as executing specified commands and/or setting the values of variables utilized by the interactive application 143. In operation of such embodiments, the process controller 112 automatically generates commands that are encoded into the interactive application instruction and resource data 136 that are communicated to the interactive processing device 120. The interactive processing device 120 passes the application instruction and resource data 136 to the interactive application 143. The interactive application parses the application instruction and resource data and automatically performs operations in accordance with the commands encoded in the interactive application instruction and resource data 136.

In many embodiments, the process controller 112 includes a pseudo random or random result generator used to generate random results that are used by the decision engine 122 to generate portions of the interactive application instruction and resource data 136.

In various embodiments, the process controller 112 uses the rule-based decision engine 122 to automatically determine an amount of AC to award based at least in part on interactions with the interactive application 143 of the dynamic endpoint resolution interleaved wagering system as determined by the process controller 112 from the application telemetry data 124. In some embodiments, the process controller 112 may also use the wager outcome data 130 to determine the amount of AC that should be awarded.

In numerous embodiments, the interactive application 143 is a skill-based interactive application and the AC is awarded for skillful interaction with the interactive application.

In some embodiments, the interactive application instruction and resource data 136 are communicated to a wagering interface generator 144. The wagering interface generator 144 also receives wager outcome data 130. The process controller uses the wagering interface generator 144, the interactive application instruction and resource data 136 and the wager outcome data 130 to automatically generate wager telemetry commands 146 used by the process controller 112 to command the interactive processing device 120 to automatically generate a wagering interface 148 describing a state of wagering and credit accumulation and loss for the dynamic endpoint resolution interleaved wagering system. In some embodiments, the wager telemetry data 146 may include, but is not limited to, amounts of AC and interactive elements earned, lost or accumulated through interaction with interactive application, and Cr, AC and interactive elements amounts won, lost or accumulated as determined from the wager outcome data 130 and the one or more meters 110.

In some embodiments, the wager outcome data 130 also includes data about one or more game states of a wagering proposition as executed by the wager server 102. In various such embodiments, the wagering interface generator 144 generates a wagering process display and/or wagering state display using the one or more states of the wagering proposition. The wagering process display and/or wagering state display is included in the wager telemetry data 146 that is communicated to the interactive processing device 120. The wagering process display and/or wagering state display is automatically displayed by the interactive processing device 120 using the wagering interface 148. In other such embodiments, the one or more states of the wagering proposition are communicated to the interactive processing device 120 and the interactive processing device 120 is instructed to automatically generate the wagering process display and/or wagering state display of the wagering interface 148 using the one or more states of the wagering proposition for display.

In some embodiments, the wager outcome data 130 includes game state data about execution of the wagering proposition, including but not limited to a final state, intermediate state and/or beginning state of the wagering proposition. For example, in a wagering proposition that is based on slot machine math, the final state of the wagering proposition may be reel positions, in a wagering proposition that is based on roulette wheel math, the final state may be a pocket where a ball may have come to rest, in a wagering proposition that is a based on card math, the beginning, intermediate and final states may represent a sequence of cards being drawn from a deck of cards, etc.

In some embodiments, the interactive processing device 120 generates a wagering interface by executing commands that define processes of the wagering interface where the commands are formatted in a scripting language. In operation, a wagering interface generator of a process controller generates commands in the form of a script written in the scripting language. The script includes commands that describe how the interactive processing device is to display wagering outcome data. The completed script is encoded as wager telemetry data and communicated to the interactive processing device by the process controller. The interactive processing device receives the wager telemetry data and parses the script encoded in the wager telemetry data and executes the commands included in the script to generate the wagering interface.

In many embodiments, an interactive processing device generates a wagering interface based on a document written in a document markup language that includes commands that define processes of the wagering interface. In operation, a wagering interface generator of a process controller generates a document composed in the document markup language. The document includes commands that describe how the interactive processing device is to display wagering outcome data. The completed document is encoded as wager telemetry data and communicated to the interactive processing device by the process controller. The interactive processing device receives the wager telemetry data and parses the document encoded in the wager telemetry data and executes the commands encoded into the document to generate the wagering interface.

In some embodiments, an interactive processing device generates a wagering interface by executing commands that define processes of the wagering interface. In operation, a wagering interface generator of a process controller generates the commands and encodes the commands into wager telemetry data that is communicated to the interactive processing device by the process controller. The interactive processing device receives the wager telemetry data and executes the commands encoded in the wager telemetry data to generate the wagering interface.

In various embodiments, an interactive processing device includes a data store of graphic and audio display resources that the interactive processing device uses to generate a wagering interface as described herein.

In many embodiments, a process controller communicates graphic and audio display resources as part of wager telemetry data to an interactive processing device. The interactive processing device uses the graphic and audio display resources to generate a wagering interface as described herein.

When a user interacts with the wagering interface 148, wagering interface telemetry data 149 is generated by the wagering interface 148 and communicated by the interactive processing device 120 to the process controller 112 using interfaces 131 and 160.

The process controller 112 can further operatively connect to the wager server 102 to determine an amount of credit or interactive elements available and other wagering metrics of a wagering proposition. Thus, the process controller 112 may affect an amount of Cr in play for participation in the wagering events of a wagering proposition provided by the wager server 102 in some embodiments. The process controller 112 may additionally include various audit logs and activity meters. In some embodiments, the process controller 112 can also couple to a centralized session and/or management controller 150 for exchanging various data related to the user and the activities of the user during game play of a dynamic endpoint resolution interleaved wagering system.

In many embodiments, one or more users can be engaged in using the interactive application 143 executed by the interactive processing device 120. In various embodiments, a dynamic endpoint resolution interleaved wagering system can include an interactive application 143 that provides a skill-based interactive application that includes head-to-head play between a single user and a computing device, between two or more users against one another, or multiple users playing against a computer device and/or each other. In some embodiments, the interactive application 143 can be a skill-based interactive application where the user is not skillfully playing against the computer or any other user such as skill-based interactive applications where the user is effectively skillfully playing against himself or herself.

In some embodiments, the operation of the process controller 112 does not affect the provision of a wagering proposition by the wager server 102 except for user choice parameters that are allowable in accordance with the wagering proposition. Examples of user choice parameters include, but are not limited to: wager terms such as but not limited to a wager amount; speed of game play (for example, by pressing a button or pulling a handle of a slot machine); and/or agreement to wager into a bonus round.

In various embodiments, wager outcome data 130 communicated from the wager server 102 can also be used to convey a status operation of the wager server 102.

In a number of embodiments, communication of the wager execution commands 129 between the wager server 102 and the process controller 112 can further be used to communicate various wagering control factors that the wager server 102 uses as input. Examples of wagering control factors include, but are not limited to, an amount of Cr, AC, interactive elements, or objects consumed per wagering event, and/or the user's election to enter a jackpot round.

In some embodiments, the process controller 112 utilizes the wagering interface 148 to communicate certain interactive application data to the user, including but not limited to, club points, user status, control of the selection of choices, and messages which a user can find useful in order to adjust the interactive application experience or understand the wagering status of the user in accordance with the wagering proposition in the wager server 102.

In some embodiments, the process controller 112 utilizes the wagering interface 148 to communicate aspects of a wagering proposition to the user including, but not limited to, odds of certain wager outcomes, amount of Cr, AC, interactive elements, or objects in play, and amounts of Cr, AC, interactive elements, or objects available.

In a number of embodiments, the wager server 102 can accept wager proposition factors from the process controller 112, including, but not limited to, modifications in the amount of Cr, AC, interactive elements, or objects wagered on each individual wagering event, a number of wagering events per minute the wager server 102 can resolve, entrance into a bonus round, and other factors. An example of a varying wager amount that the user can choose can include, but is not limited to, using a more difficult interactive application level associated with an amount of a wager. These factors can increase or decrease an amount wagered per individual wagering proposition in the same manner that a standard slot machine user can decide to wager more or less credits for each pull of the handle. In several embodiments, the wager server 102 can communicate a number of factors back and forth to the process controller 112, via an interface, such that an increase/decrease in a wagered amount can be related to the change in user profile of the user in the interactive application. In this manner, a user can control a wager amount per wagering event in accordance with the wagering proposition with the change mapping to a parameter or component that is applicable to the interactive application experience.

In some embodiments, a session/management server 150 is used to regulate a dynamic endpoint resolution interleaved wagering system session.

In various embodiments, the session/management server 150 includes one or more interfaces, 165, 166 and 167 that operatively connect the session/management server 150 to one or more interactive processing devices, such as interactive processing device 120, to one or more process controllers, such as process controller 112, and/or to one or more wager servers, such as wager server 102, through their respective interfaces.

In some embodiments, one or more of the session/management server interfaces implement a session/management server to device or server communication protocol employing an interprocess communication protocol so that the session/management server and one or more of an interactive processing device, a wager server, and/or a process controller may be implemented on the same device. In operation, the session/management server interfaces provide application programming interfaces or the like that are used by the session/management server to communicate outgoing data and receive incoming data by passing parameter data to another process or application running on the same device.

In some embodiments, one or more of the session/management server interfaces implement a session/management server communication protocol employing an interdevice communication protocol so that the session/management server may be implemented on a device separate from the one or more interactive processing devices, the one or more process controllers and/or the one or more wager servers. The interdevice protocol may utilize a wired communication bus or wireless connection as a physical layer. In various embodiments, one or more of the session/management server interfaces implement a session/management server communication protocol employing a networking protocol so that the process session/management server may be operatively connected to the one or more interactive processing devices, the one or more process controllers, and/or the one or more wager servers by a network. The networking protocol may utilize a wired communication bus or wireless connection as a physical layer. In many such embodiments, the network includes a cellular telephone network or the like and the one or more interactive processing devices include a mobile device such as a smartphone or other device capable of using the telephone network. During operation, the one or more session/management server interfaces communicate outgoing data to an external device or server by encoding the data into a signal and transmitting the signal to the external device or server. The one or more session/management server interfaces receive incoming data from an external device or server by receiving a signal transmitted by the external device or server and decoding the signal to obtain the incoming data.

In various embodiments, the process controller 112 communicates outgoing session data 152 to the session/management server. The session data 152 may include, but is not limited to, user, interactive processing device, process controller and wager server data from the process controller 112. The session/management server 150 uses the user, interactive processing device, process controller and wager server data to regulate a dynamic endpoint resolution interleaved wagering system session.

In some embodiments, the session/management server 150 may also assert control of a dynamic endpoint resolution interleaved wagering system session by communicating session control data 154 to the process controller. Such control may include, but is not limited to, commanding the process controller 112 to end a dynamic endpoint resolution interleaved wagering system session, initiating wagering in a dynamic endpoint resolution interleaved wagering system session, ending wagering in a dynamic endpoint resolution interleaved wagering system session but not ending a user's use of the interactive application portion of the dynamic endpoint resolution interleaved wagering system, and changing from real credit wagering in a dynamic endpoint resolution interleaved wagering system to virtual credit wagering, or vice versa.

In many embodiments, the session/management server 150 manages user profiles for a plurality of users. The session/management server 150 stores and manages data about users in order to provide authentication and authorization of users of the dynamic endpoint resolution interleaved wagering system 128. In some embodiments, the session/management server 150 also manages geolocation information to ensure that the dynamic endpoint resolution interleaved wagering system 128 is only used by users in jurisdictions were wagering is approved. In various embodiments, the session/management server 150 stores application credits that are associated with the user's use of the interactive application of the dynamic endpoint resolution interleaved wagering system 128.

In some embodiments, the session/management server 150 communicates user and session management data 155 to the user using a management user interface 157 of the interactive processing device. The user 140 interacts with the management user interface 157 and the management user interface generates management telemetry data 159 that is communicated to the session/management server 150.

In some embodiments, the wager server 102 communicates wager session data 153 to the session/management server 150. In various embodiments, the session/management server communicates wager session control data 151 to the wager server 102.

In some embodiments, a process controller operates as an interface between an interactive processing device and a wager server. By virtue of this construction, the wager server is isolated from the interactive processing device allowing the interactive processing device to operate in an unregulated environment will allowing the wager server to operate in a regulated environment.

In some embodiments, a single wager server may provide services to two or more interactive processing devices and/or two or more process controllers, thus allowing a dynamic endpoint resolution interleaved wagering system to operate over a large range of scaling.

In various embodiments, multiple types of interactive processing devices using different operating systems may be interfaced to a single type of process controller and/or wager server without requiring customization of the process controller and/or the wager server.

In many embodiments, an interactive processing device may be provided as a user device under control of a user while maintaining the wager server in an environment under the control of a regulated operator of wagering equipment.

In several embodiments, data communicated between the controllers may be encrypted to increase security of the dynamic endpoint resolution interleaved wagering system.

In some embodiments, a process controller isolates wager logic and application logic as unregulated logic from a regulated wager server, thus allowing errors in the application logic and/or wager logic to be corrected, new application logic and/or wager logic to be used, or modifications to be made to the application logic and/or wager logic without a need for regulatory approval.

In various embodiments, an interactive application may require extensive processing resources from an interactive processing device leaving few processing resources for the functions performed by a process controller and/or a wager server. By virtue of the architecture described herein, processing loads may be distributed across multiple devices such that operations of the interactive processing device may be dedicated to the interactive application and the processes of the process controller and/or wager server are not burdened by the requirements of the interactive application.

In many embodiments, a dynamic endpoint resolution interleaved wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a dynamic endpoint resolution interleaved wagering system are distributed in close proximity to each other and communicate using a local area network and/or a communication bus. In several embodiments, an interactive processing device and a process controller of a dynamic endpoint resolution interleaved wagering system are in a common location and communicate with an external wager server. In some embodiments, a process controller and a wager server of a dynamic endpoint resolution interleaved wagering system are in a common location and communicate with an external interactive processing device. In many embodiments, an interactive processing device, a process controller, and a wager server of a dynamic endpoint resolution interleaved wagering system are located in a common location. In some embodiments, a session/management server is located in a common location with a process controller and/or a wager server.

In various embodiments, these multiple devices can be constructed from or configured using a single device or a plurality of devices such that a dynamic endpoint resolution interleaved wagering system is executed as a system in a virtualized space such as, but not limited to, where a wager server and a process controller are large scale centralized servers in the cloud operatively connected to widely distributed interactive processing devices via a wide area network such as the Internet or a local area network. In such embodiments, the components of a dynamic endpoint resolution interleaved wagering system may communicate using a networking protocol or other type of device-to-device communications protocol.

In many embodiments, a centralized wager server is operatively connected to, and communicates with, one or more process controllers using a communication link. The centralized wager server can generate wager outcomes for wagers in accordance with one or more wagering propositions. The centralized wager server can execute a number of simultaneous or pseudo-simultaneous wagers in order to generate wager outcomes for a variety of wagering propositions that one or more distributed dynamic endpoint resolution interleaved wagering systems can use.

In several embodiments, a centralized process controller is operatively connected to one or more interactive processing devices and one or more wager servers using a communication link. The centralized process controller can perform the functionality of a process controller across various dynamic endpoint resolution interleaved wagering systems.

In numerous embodiments, an interactive application server provides a host for managing head-to-head play operating over a network of interactive processing devices connected to the interactive application server using a communication link. The interactive application server provides an environment where users can compete directly with one another and interact with other users.

FIG. 1B is a diagram of a land-based configuration of a dynamic endpoint resolution interleaved wagering system in accordance with various embodiments of the invention. A land-based configuration of a dynamic endpoint resolution interleaved wagering system 156 includes an interactive processing device 158, a process controller 160 and a wager server 162 housed in a common enclosure. In many embodiments, the process controller 160 is operatively connected to an external session/management controller 164. In various embodiments, the wager server 162 is operatively connected to a ticket-in-ticket-out (TITO) controller 166 or other type of credit controller. The wager server 162 communicates with the TITO controller 166 to obtain amounts of credits used for wagering. In operation, the wager server 162 uses a bill validator/ticket scanner 168 to scan a TITO ticket having indicia of credit account data of a credit account of the TITO controller 166. The wager server 162 communicates the credit account data to the TITO controller 166. The TITO controller 166 uses the credit account data to determine an amount of credits to transfer to the wager server 162. The TITO controller 166 communicates the amount of credits to the wager server 162. The wager server 162 credits the one or more credit meters with the amount of credits so that the credits can be used when a user makes wagers using the dynamic endpoint resolution interleaved wagering system 156. In addition, the wager server 162 can use the TITO controller 166 along with a ticket printer 170 to generate a TITO ticket for a user. In operation, the wager server 162 communicates an amount of credits for a credit account on the TITO controller 166. The TITO controller 166 receives the amount of credits and creates the credit account and credits the credit account with the amount of credits. The TITO controller 166 generates credit account data for the credit account and communicates the credit account data to the wager server 162. The wager server 162 uses the ticket printer 170 to print indicia of the credit account data onto a TITO ticket.

FIG. 1C is a diagram of another land-based configuration of a dynamic endpoint resolution interleaved wagering system in accordance with various embodiments of the invention. A land-based configuration of a dynamic endpoint resolution interleaved wagering system 172 includes an interactive processing device 172, a process controller 174 and a wager server 176 housed in a common enclosure. The process controller 174 is operatively connected to an external session/management controller 178. The wager server 176 is operatively connected to a ticket-in-ticket-out (TITO) controller 180 or other type of credit controller. The wager server 176 communicates with the TITO controller 180 to obtain amounts of credits used for wagering. In operation, the wager server 176 uses a bill validator/ticket scanner 182 to scan a TITO ticket having indicia of credit account data of a credit account of the TITO controller 180. The wager server 176 communicates the credit account data to the TITO controller 180. The TITO controller 180 uses the credit account data to determine an amount of credits to transfer to the wager server 176. The TITO controller 180 communicates the amount of credits to the wager server 176. The wager server 176 receives the amount of credits and credits the one or more credit meters with the amount of credits so that the credits can be used when a user makes wagers using the dynamic endpoint resolution interleaved wagering system 172. In addition, the wager server 176 can use the TITO controller 180 along with a ticket printer 184 to generate a TITO ticket for a user. In operation, the wager server 176 communicates an amount of credits for a credit account on the TITO controller 180. The TITO controller 180 receives the amount of credits and creates the credit account and credits the credit account with the amount of credits. The TITO controller 180 generates credit account data for the credit account and communicates the credit account data to the wager server 176. The wager server 176 uses the ticket printer 184 to print indicia of the credit account data onto a TITO ticket.

The wager server 176 is operatively connected to a central determination controller 186. In operation, when the wager server 176 needs to determine a wager outcome, the wager server communicates a request to the central determination controller 186 for the wager outcome. The central determination controller 186 receives the wager outcome request and generates a wager outcome in response to the wager request. The central determination controller 186 communicates the wager outcome to the wager server 176. The wager server 176 receives the wager outcome and utilizes the wager outcome as described herein. In some embodiments, the wager outcome is drawn from a pool of pre-determined wager outcomes. In some embodiments, the wager outcome is a pseudo random result or random result that is utilized by the wager server along with paytables to determine a wager outcome as described herein.

FIG. 1D is a diagram of an interactive configuration of a dynamic endpoint resolution interleaved wagering system in accordance with various embodiments of the invention. An interactive configuration of a dynamic endpoint resolution interleaved wagering system is useful for deployment over a wide area network such as an internet. An interactive configuration of a dynamic endpoint resolution interleaved wagering system 188 includes an interactive processing device 189 operatively connected by a network 190 to a process controller 191, and a wager server 192. The process controller 191 is operatively connected to a session/management controller 193.

FIG. 1E is a diagram of a mobile configuration of a dynamic endpoint resolution interleaved wagering system in accordance with various embodiments of the invention. A mobile configuration of a dynamic endpoint resolution interleaved wagering system is useful for deployment over wireless communication network, such as a wireless local area network or a wireless telecommunications network. An interactive configuration of a dynamic endpoint resolution interleaved wagering system 194 includes an interactive processing device 195 operatively connected by a wireless network 196 to a process controller 197, and a wager server 198. The process controller 197 is also operatively connected to a session/management controller 199.

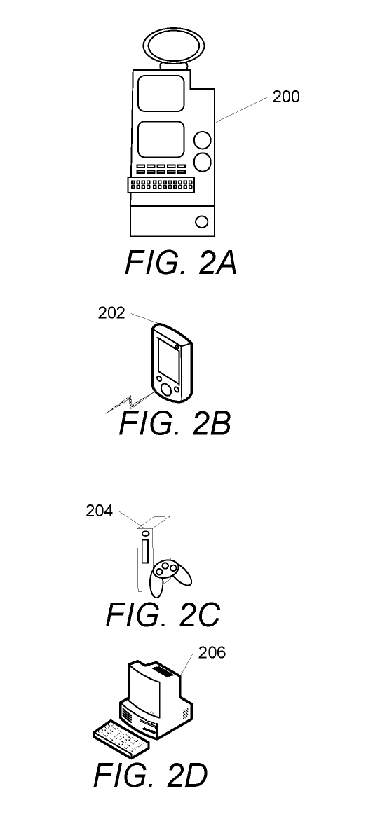

FIGS. 2A, 2B, 2C, and 2D are illustrations of interactive processing devices of a dynamic endpoint resolution interleaved wagering system in accordance with various embodiments of the invention. An interactive processing device, such as interactive processing device 120 of FIG. 1A, may be constructed from or configured using one or more processing devices configured to perform the operations of the interactive processing device. An interactive processing device in a dynamic endpoint resolution interleaved wagering system may be constructed from or configured using any processing device having sufficient processing and communication capabilities that may be configured to perform the processes of an interactive processing device in accordance with various embodiments of the invention. In some embodiments, the construction or configuration of the interactive processing device may be achieved through the use of an application control interface, such as application control interface 131 of FIG. 1A, and/or through the use of an interactive application, such as interactive application 143 of FIG. 1A.

In some embodiments, an interactive processing device may be constructed from or configured using an electronic gaming machine 200 as shown in FIG. 2A. The electronic gaming machine 200 may be physically located in various types of gaming establishments.

In many embodiments, an interactive processing device may be constructed from or configured using a portable device 202 as shown in FIG. 2B. The portable device 202 is a device that may wirelessly connect to a network. Examples of portable devices include, but are not limited to, a tablet computer, a personal digital assistant, and a smartphone.

In some embodiments, an interactive processing device may be constructed from or configured using a gaming console 204 as shown in FIG. 2C.

In various embodiments, an interactive processing device may be constructed from or configured using a personal computer 206 as shown in FIG. 2D.

In some embodiments, a device, such as the devices of FIGS. 2A, 2B, 2C, and 2D, may be used to construct a complete dynamic endpoint resolution interleaved wagering system and may be operatively connected using a communication link to a session and/or management controller, such as session and/or management controller 150 of FIG. 1A.

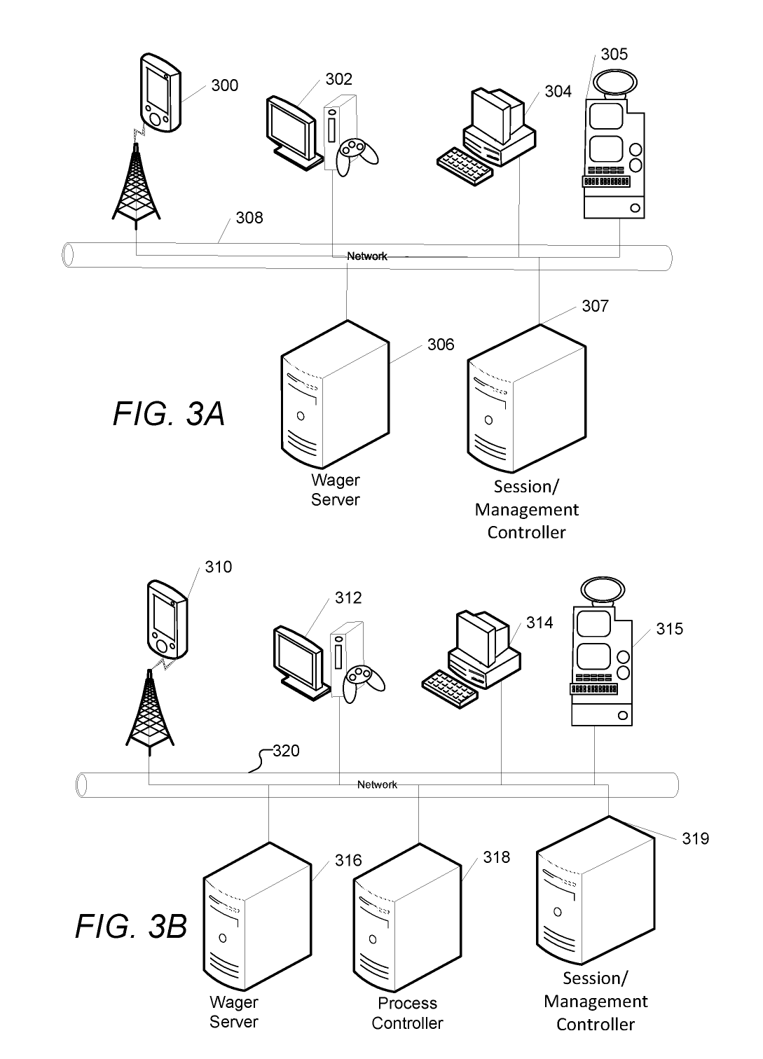

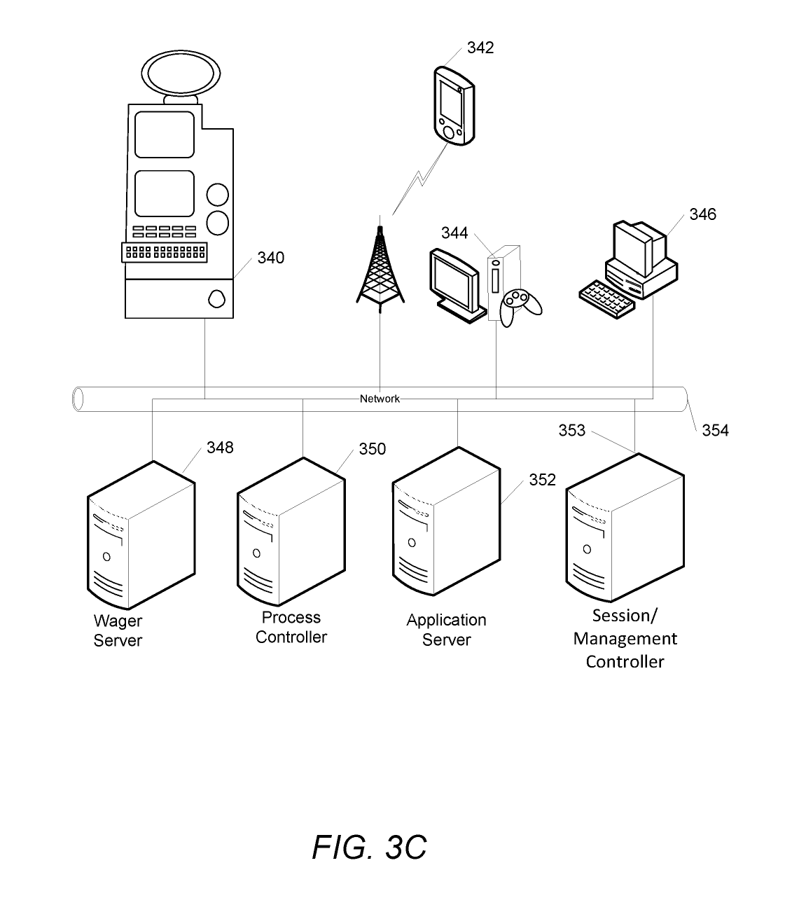

Some dynamic endpoint resolution interleaved wagering systems in accordance with many embodiments of the invention can be distributed across a plurality of devices in various configurations. FIGS. 3A, 3B and 3C are diagrams of distributed dynamic endpoint resolution interleaved wagering systems in accordance with various embodiments of the invention. Turning now to FIG. 3A, one or more interactive processing devices of a distributed dynamic endpoint resolution interleaved wagering system, such as but not limited to, a mobile or wireless device 300, a gaming console 302, a personal computer 304, and an electronic gaming machine 305, are operatively connected with a wager server 306 of a distributed dynamic endpoint resolution interleaved wagering system using a communication link 308. Communication link 308 is a communications link that allows processing systems to communicate with each other and to share data. Examples of the communication link 308 can include, but are not limited to: a wired or wireless interdevice communication link, a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive processing device and a process controller as described herein are executed on the individual interactive processing devices 300, 302, 304 and 305 while one or more processes of a wager server as described herein can be executed by the wager server 306.

In many embodiments, a distributed dynamic endpoint resolution interleaved wagering system and may be operatively connected using a communication link to a session and/or management controller 307, that performs the processes of a session and/or management controller as described herein.

A distributed dynamic endpoint resolution interleaved wagering system in accordance with another embodiment of the invention is illustrated in FIG. 3B. As illustrated, one or more interactive processing devices of a distributed dynamic endpoint resolution interleaved wagering system, such as but not limited to, a mobile or wireless device 310, a gaming console 312, a personal computer 314, and an electronic gaming machine 315, are operatively connected with a wager server server 316 and a process controller 318 over a communication link 320. Communication link 320 is a communication link that allows processing systems to communicate and share data. Examples of the communication link 320 can include, but are not limited to: a wired or wireless interdevice communication link, a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, the processes of an interactive processing device as described herein are executed on the individual interactive processing devices 310, 312, 314 and 315. One or more processes of a wager server as described herein are executed by the wager server 316, and one or more processes of a process controller as described herein are executed by the process controller 318.

In many embodiments, a distributed dynamic endpoint resolution interleaved wagering system and may be operatively connected using a communication link to a session and/or management controller 319, that performs the processes of a session and/or management controller as described herein.

A distributed dynamic endpoint resolution interleaved wagering systems in accordance with still another embodiment of the invention is illustrated in FIG. 3C. As illustrated, one or more interactive processing devices of a distributed dynamic endpoint resolution interleaved wagering system, such as but not limited to, a mobile device 342, a gaming console 344, a personal computer 346, and an electronic gaming machine 340 are operatively connected with a wager server 348 and a process controller 350, and an interactive application server 352 using a communication link 354. Communication link 354 is a communications link that allows processing systems to communicate and to share data. Examples of the communication link 354 can include, but are not limited to: a wired or wireless interdevice communication link, a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of a display and user interface of an interactive processing device as described herein are executed on the individual interactive processing devices 340, 342, 344 and 346. One or more processes of a wager server as described herein can be executed by the wager server server 348. One or more processes of a process controller as described herein can be executed by the process controller server 350 and one or more processes of an interactive processing device excluding the display and user interfaces can be executed by the interactive application server 352.

In many embodiments, a distributed dynamic endpoint resolution interleaved wagering system and may be operatively connected using a communication link to a session and/or management controller 353, that performs the processes of a session and/or management controller as described herein.

In various embodiments, a session/management server may be operatively connected to components of a dynamic endpoint resolution interleaved wagering system using a communication link. In other embodiments, a number of other peripheral systems, such as a user management system, a gaming establishment management system, a regulatory system, and/or hosting servers are also operatively connected with the dynamic endpoint resolution interleaved wagering systems using a communication link. Also, other servers can reside outside the bounds of a network within a firewall of the operator to provide additional services for network connected dynamic endpoint resolution interleaved wagering systems.

Although various distributed dynamic endpoint resolution interleaved wagering systems are described herein, dynamic endpoint resolution interleaved wagering systems can be distributed in any configuration as appropriate to the specification of a specific application in accordance with embodiments of the invention. In some embodiments, components of a distributed dynamic endpoint resolution interleaved wagering system, such as a process controller, wager server, interactive processing device, or other servers that perform services for a process controller, wager server and/or interactive processing device, can be distributed in different configurations for a specific distributed dynamic endpoint resolution interleaved wagering system application.

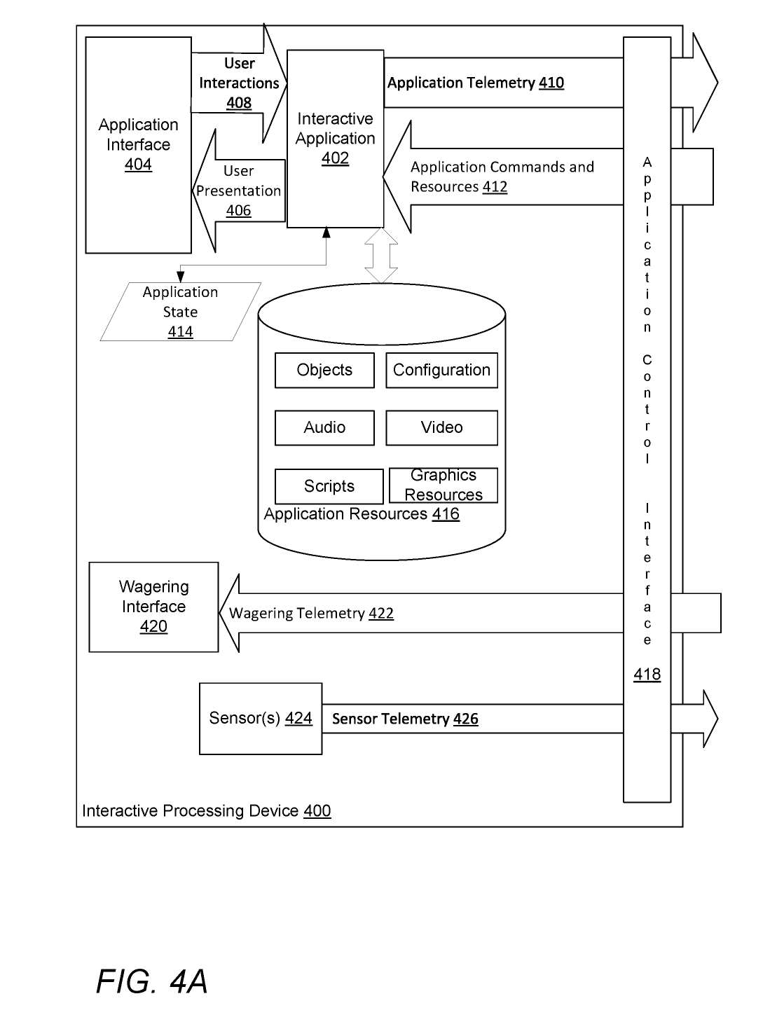

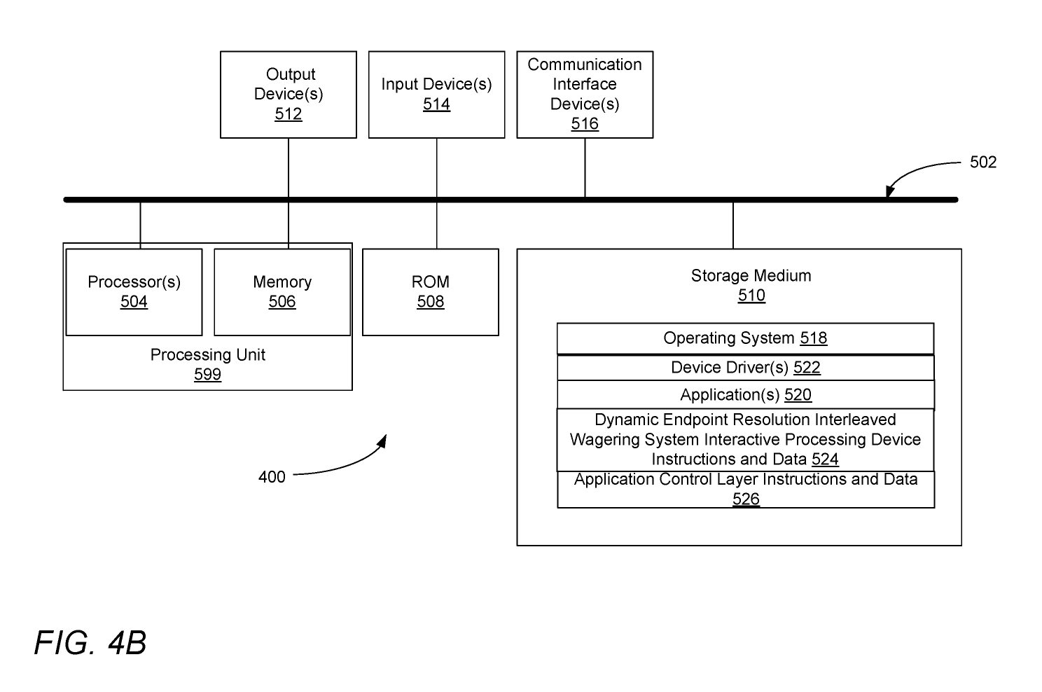

FIGS. 4A and 4B are diagrams of a structure of an interactive processing device of a dynamic endpoint resolution interleaved wagering system in accordance with various embodiments of the invention. An interactive processing device may be constructed from or configured using one or more processing devices configured to perform the operations of the interactive processing device. In many embodiments, an interactive processing device can be constructed from or configured using various types of processing devices including, but not limited to, a mobile device such as a smartphone or the like, a personal digital assistant, a wireless device such as a tablet computer or the like, an electronic gaming machine, a personal computer, a gaming console, a set-top box, a computing device, a controller, or the like.

Referring now to FIG. 4A, an interactive processing device 400, suitable for use as interactive processing device 120 of FIG. 1A, provides an execution environment for an interactive application 402 of a dynamic endpoint resolution interleaved wagering system. In several embodiments, an interactive processing device 400 of a dynamic endpoint resolution interleaved wagering system provides an interactive application 402 that generates an applicaiton interface 404 for interaction with by a user. The interactive application 402 generates a user presentation 406 that is presented to the user through the applicaiton interface 404. The user presentation 406 may include audio features, visual features or tactile features, or any combination of these features. The applicaiton interface 404 further includes one or more human input devices (HIDs) interfaces that communicate with one or more HIDs (e.g., the input devices 514 of FIG. 4b) that the user can use to interact with the dynamic endpoint resolution interleaved wagering system. The user's interactions 408 are included by the interactive application 402 in application telemetry data 410 that is communicated by interactive processing device 400 to various other components of a dynamic endpoint resolution interleaved wagering system as described herein. The interactive application 402 receives application commands and resources 412 communicated from various other components of a dynamic endpoint resolution interleaved wagering system as described herein.

In some embodiments, various components of the interactive application 402 can read data from an application state 414 in order to provide one or more features of the interactive application. In various embodiments, components of the interactive application 402 can include, but are not limited to, a physics engine, a rules engine, and/or a graphics engine. The physics engine is used to simulate physical interactions between virtual objects in the interactive application 402. The rules engine implements the rules of the interactive application and a P/RNG that may be used for influencing or determining certain variables and/or outcomes to provide a randomizing influence on the operations of the interactive application. The graphics engine is used to generate a visual representation of the interactive application state to the user. Furthermore, the components may also include an audio engine to generate audio outputs for the user interface.

During operation, the interactive application reads and writes application resources 416 stored on a data store of the interactive processing device host. The application resources 416 may include objects having graphics and/or control logic used to provide application environment objects of the interactive application. In various embodiments, the resources may also include, but are not limited to, video files that are used to generate a portion of the user presentation 406; audio files used to generate music, sound effects, etc. within the interactive application; configuration files used to configure the features of the interactive application; scripts or other types of control code used to provide various features of the interactive application; and graphics resources such as textures, objects, etc. that are used by a graphics engine to render objects displayed in an interactive application.

In operation, components of the interactive application 402 read portions of the application state 414 and generate the user presentation 406 for the user that is presented to the user using the user interface 404. The user perceives the user presentation and provides user interactions 408 using the HIDs. The corresponding user interactions are received as user actions or inputs by various components of the interactive application 402. The interactive application 402 translates the user actions into interactions with the virtual objects of the application environment stored in the application state 414. Components of the interactive application use the user interactions with the virtual objects of the interactive application and the interactive application state 414 to update the application state 414 and update the user presentation 406 presented to the user. The process loops continuously while the user interacts with the interactive application of the dynamic endpoint resolution interleaved wagering system.

The interactive processing device 400 provides one or more interfaces 418 between the interactive processing device 400 and other components of a dynamic endpoint resolution interleaved wagering system, such as, but not limited to, a process controller and a session/management server. The interactive processing device 400 and the other dynamic endpoint resolution interleaved wagering system components communicate with each other using the interfaces. The interface may be used to pass various types of data, and to communicate and receive messages, status data, commands and the like. In certain embodiments, the interactive processing device 400 and a process controller communicate application commands and environment resources 412 and application telemetry data 410. In some embodiments, the communications include requests by the process controller that the interactive processing device 400 update the application state 414 using data provided by the process controller.

In many embodiments, a communication by a process controller includes a request that the interactive processing device 400 update one or more resources 416 using data provided by the process controller. In a number of embodiments, the interactive processing device 400 provides all or a portion of the application state to the process controller. In some embodiments, the interactive processing device 400 may also provide data about one or more of the application resources 416 to the process controller. In some embodiments, the communication includes user interactions that the interactive processing device 400 communicates to the process controller. The user interactions may be low level user interactions with the user interface 404, such as manipulation of a HID, or may be high level interactions with game objects as determined by the interactive application. The user interactions may also include resultant actions such as modifications to the application state 414 or game resources 416 resulting from the user's interactions taken in the dynamic endpoint resolution interleaved wagering system interactive application. In some embodiments, user interactions include, but are not limited to, actions taken by entities such as non-user characters (NPC) of the interactive application that act on behalf of or under the control of the user.

In some embodiments, the interactive processing device 400 includes a wagering interface 420 used to communicate dynamic endpoint resolution interleaved wagering system telemetry data 422 to and from the user. The dynamic endpoint resolution interleaved wagering system telemetry data 422 from the dynamic endpoint resolution interleaved wagering system include, but are not limited to, data used by the user to configure Cr, AC and interactive element wagers, and data about the wagering proposition Cr, AC and interactive element wagers such as, but not limited to, Cr, AC and interactive element balances and Cr, AC and interactive element amounts wagered.

In some embodiments, the interactive processing device includes one or more sensors 424. Such sensors may include, but are not limited to, physiological sensors that monitor the physiology of the user, environmental sensors that monitor the physical environment of the interactive processing device, accelerometers that monitor changes in motion of the interactive processing device, and location sensors that monitor the location of the interactive processing device such as global positioning sensors (GPSs). The interactive processing device 400 communicates sensor telemetry data 426 to one or more components of the dynamic endpoint resolution interleaved wagering system.

Referring now to FIG. 4B, interactive processing device 400 includes a bus 502 that provides an interface for one or more processors 504, random access memory (RAM) 506, read only memory (ROM) 508, machine-readable storage medium 510, one or more user output devices 512, one or more user input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive processing device processing unit 599. In some embodiments, the interactive processing device processing unit includes one or more processors operatively connected to one or more of a RAM, ROM, and machine-readable storage medium; the one or more processors of the interactive processing device processing unit receive instructions stored by the one or more of a RAM, ROM, and machine-readable storage medium via a bus; and the one or more processors execute the received instructions. In some embodiments, the interactive processing device processing unit is an ASIC (Application-Specific Integrated Circuit). In some embodiments, the interactive processing device processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of user input devices 514 include, but are not limited to: tactile devices including but not limited to, keyboards, keypads, foot pads, touch screens, and/or trackballs; non-contact devices such as audio input devices; motion sensors and motion capture devices that the interactive processing device can use to receive inputs from a user when the user interacts with the interactive processing device; physiological sensors that monitor the physiology of the user; environmental sensors that monitor the physical environment of the interactive processing device; accelerometers that monitor changes in motion of the interactive processing device; and location sensors that monitor the location of the interactive processing device such as global positioning sensors.

The one or more communication interface devices 516 provide one or more wired or wireless interfaces for communicating data and commands between the interactive processing device 400 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive processing device, such as but not limited to: an operating system 518; one or more device drivers 522; one or more application programs 520 including but not limited to an interactive application; and dynamic endpoint resolution interleaved wagering system interactive processing device instructions and data 524 for use by the one or more processors 504 to provide the features of an interactive processing device as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive processing device 400 to provide the features of a dynamic endpoint resolution interleaved wagering system interactive processing device as described herein

Although the interactive processing device is described herein as being constructed from or configured using one or more processors and instructions stored and executed by hardware components, the interactive processing device can be constructed from or configured using only hardware components in accordance with other embodiments. In addition, although the storage medium 510 is described as being operatively connected to the one or more processors through a bus, those skilled in the art of interactive processing devices will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive processing device 400 can be distributed across a plurality of different devices. In many such embodiments, an interactive processing device of a dynamic endpoint resolution interleaved wagering system includes an interactive application server operatively connected to an interactive client using a communication link. The interactive application server and interactive application client cooperate to provide the features of an interactive processing device as described herein.

In various embodiments, the interactive processing device 400 may be used to construct other components of a dynamic endpoint resolution interleaved wagering system as described herein.

In some embodiments, components of an interactive processing device and a process controller of a dynamic endpoint resolution interleaved wagering system may be constructed from or configured using a single device using processes that communicate using an interprocess communication protocol. In other such embodiments, the components of an interactive processing device and a process controller of a dynamic endpoint resolution interleaved wagering system may communicate by passing messages, parameters or the like.

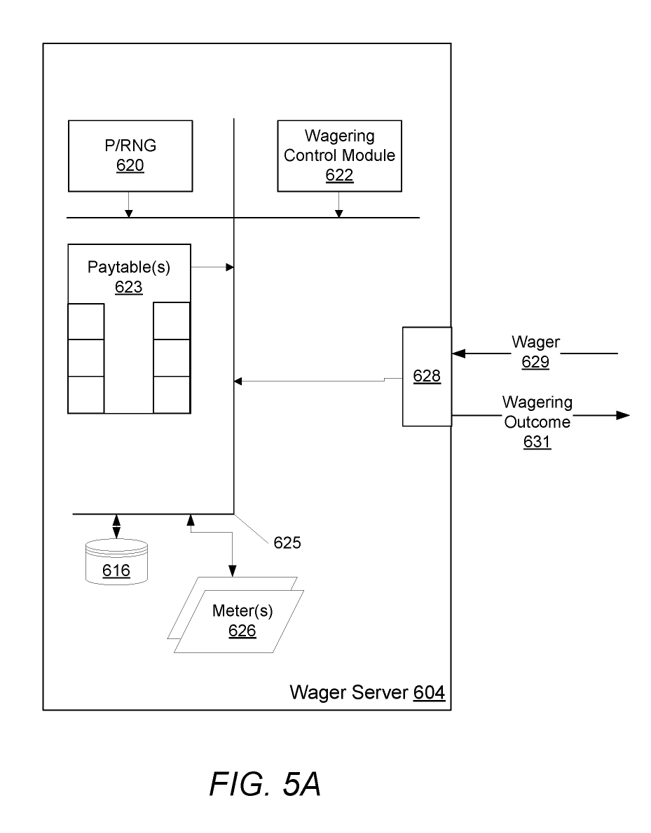

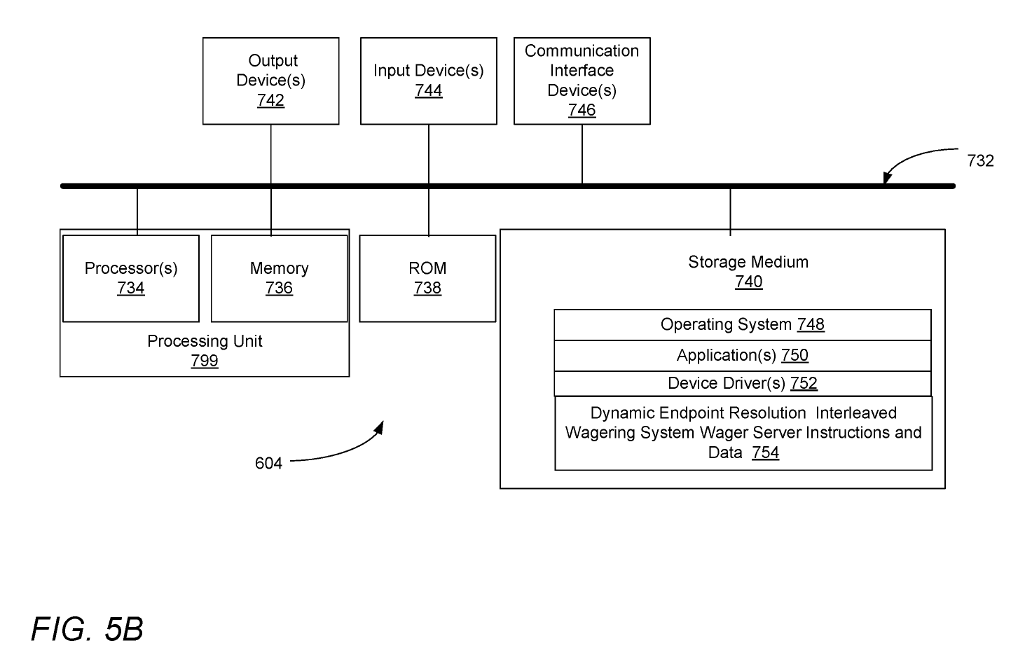

FIGS. 5A and 5B are diagrams of a structure of a wager server of a dynamic endpoint resolution interleaved wagering system in accordance with various embodiments of the invention. A wager server may be constructed from or configured using one or more processing devices configured to perform the operations of the wager server. In many embodiments, a wager server can be constructed from or configured using various types of processing devices including, but not limited to, a mobile device such as a smartphone or the like, a personal digital assistant, a wireless device such as a tablet computer or the like, an electronic gaming machine, a personal computer, a gaming console, a set-top box, a computing device, a controller, or the like.

Referring now to FIG. 5A, in various embodiments, a wager server 604, suitable for use as wager server 102 of FIG. 1A, includes a pseudorandom or random number generator (P/RNG) 620 to produce random results or pseudo random results; one or more paytables 623 which includes a plurality of factors indexed by the random result to be multiplied with an amount of Cr, AC, interactive elements, or objects committed in a wager; and a wagering control module 622 whose processes may include, but are not limited to, generating random results, looking up factors in the paytables, multiplying the factors by an amount of Cr, AC, interactive elements, or objects wagered, and administering one or more Cr, AC, interactive element, or object meters 626. The various wager server components can interface with each other via an internal bus 625 and/or other appropriate communication mechanism.

An interface 628 allows the wager server 604 to operatively connect to an external device, such as one or more process controllers as described herein. The interface 628 provides for communication of wager execution commands 629 from the external device that is used to specify wager parameters and/or trigger execution of a wager by the wager server 604 as described herein. The interface 628 may also provide for communicating wager outcome data 631 to an external device as described herein. In numerous embodiments, the interface between the wager server 604 and other systems/devices may be a wide area network (WAN) such as the Internet. However, other methods of communication may be used including, but not limited to, a local area network (LAN), a universal serial bus (USB) interface, and/or some other method by which two electronic devices could communicate with each other.

In various embodiments, a wager server 604 may use a P/RNG provided by an external system. The external system may be connected to the wager server 604 by a suitable communication network such as a local area network (LAN) or a wide area network (WAN). In some embodiments, the external P/RNG is a central deterministic system that provides random or pseudo random results to one or more connected wager servers.

During operation of the wager server, the external system communicates wager execution commands 629 to the wager server 604. The wager server 604 receives the wager execution commands and uses the wager execution commands to trigger execution of a wager in accordance with a wagering proposition. The wager server 604 executes the wager and determines a wager outcome for the wager. The wager server communicates wager outcome data 631 of the wager outcome to the external system.

In some embodiments, the wager server uses the wager execution commands to select a paytable 628 to use and/or an amount of Cr, AC, interactive elements, or objects to wager.

In some embodiments, the wager outcome data may include, but is not limited to, an amount of Cr, AC, interactive elements, or objects won in the wager.

In various embodiments, the wager outcome data may include, but is not limited to, an amount of Cr, AC, interactive elements, or objects in the one or more meters 626.

In some embodiments, the wager outcome data includes state data for the wagering proposition of the executed wager. The state data may correspond to one or more game states of a wagering proposition that is associated with the wagering proposition. Examples of state data include, but are not limited to, reel strips in an operation state or a final state for a reel-based wagering proposition, one or more dice positions for a dice-based wagering proposition, positions of a roulette wheel and roulette ball, position of a wheel of fortune, or the like.

In various embodiments, the wagering control module 622 determines an amount of a wager and a paytable to use from the one or more paytables 623. In such embodiments, in response to the wager execution commands triggering execution of the wager, the wager control module 622 executes the wager by requesting a P/RNG result from the P/RNG 620; retrieving a paytable from the one or more paytables 623; adjusting the one or more credit meters 626 for an amount of the wager; applying the P/RNG result to the retrieved paytable; multiplying the resultant factor from the paytable by an amount wagered to determine a wager outcome; updating the one or more meters 626 based on the wager outcome; and communicating the wager outcome to the external device.

In various embodiments, an external system communicates a request for a P/RNG result from the wager server 604. In response, the wager server 604 returns a P/RNG result as a function of an internal P/RNG or a P/RNG external to the external system to which the wager server 604 is operatively connected.

In some embodiments, a communication exchange between the wager server 604 and an external system relate to the external system support for coupling a P/RNG result to a particular paytable contained in the wager server 604. In such an exchange, the external system communicates to the wager server 604 as to which of the one or more paytables 623 to use, and requests a result whereby the P/RNG result would be associated with the requested paytable 623. The result of the coupling is returned to the external system. In such an exchange, no actual Cr, AC, interactive element, or object wager is conducted, but might be useful in coupling certain non-value wagering interactive application behaviors and propositions to the same final resultant wagering return which is understood for the dynamic endpoint resolution interleaved wagering system to conduct wagering.

In some embodiments, the wager server 604 may also include storage for statuses, wagers, wager outcomes, meters and other historical events in a storage device 616.

In some embodiments, an authorization access module provides a process to permit access and command exchange with the wager server 604 and access to the one or more credit meters 626 for the amount of Cr, AC, interactive elements, or objects being wagered by the user in the dynamic endpoint resolution interleaved wagering system.

In numerous embodiments, communication occurs between various types of a wager server and an external system 630, such as process controller. In some of these embodiments, the purpose of the wager server is to allocate wagers to pools, detect occurrences of one or more events upon which the wagers were made, and determine the wager outcomes for each individual wager based on the number of winning wagers and the amount paid into the pool.

In some embodiments, the wager server manages accounts for individual users wherein the users make deposits into the accounts, amounts are deducted from the accounts, and amounts are credited to the users' accounts based on the wager outcomes.

In some embodiments a wager server is a pari-mutuel wagering system such as used for wagering on an events such as horse races, greyhound races, sporting events and the like. In a pari-mutuel wagering system, user's wagers on the outcome of an event are allocated to a pool. When the event occurs, wager outcomes are calculated by sharing the pool among all winning wagers.

In various embodiments, a wager server is a central determination system, such as but not limited to a central determination system for a Class II wagering system or a wagering system in support of a “scratch off” style lottery. In such a wagering system, a user plays against other users and competes for a common prize. In a given set of wager outcomes, there are a certain number of wins and losses. Once a certain wager outcome has been determined, the same wager outcome cannot occur again until a new set of wager outcomes is generated.

In numerous embodiments, communication occurs between various components of a wager server 604 and an external system, such as a process controller. In some of these embodiments, the purpose of the wager server 604 is to manage wagering on wagering events and to provide random (or pseudo random) results from a P/RNG.

Referring now to FIG. 5B, wager server 604 includes a bus 732 that provides an interface for one or more processors 734, random access memory (RAM) 736, read only memory (ROM) 738, machine-readable storage medium 740, one or more user output devices 742, one or more user input devices 744, and one or more communication interface and/or network interface devices 746.

The one or more processors 734 may take many forms, such as, but not limited to, a central processing unit (CPU), a multi-processor unit (MPU), an ARM processor, a controller, a programmable logic device, or the like.

In the example embodiment, the one or more processors 734 and the random access memory (RAM) 736 form a wager server processing unit 799. In some embodiments, the wager server processing unit includes one or more processors operatively connected to one or more of a RAM, ROM, and machine-readable storage medium; the one or more processors of the wager server processing unit receive instructions stored by the one or more of a RAM, ROM, and machine-readable storage medium via a bus; and the one or more processors execute the received instructions. In some embodiments, the wager server processing unit is an ASIC (Application-Specific Integrated Circuit). In some embodiments, the wager server processing unit is a SoC (System-on-Chip).

Examples of output devices 742 include, but are not limited to, display screens, light panels, and/or lighted displays. In accordance with particular embodiments, the one or more processors 734 are operatively connected to audio output devices such as, but not limited to speakers, and/or sound amplifiers. In accordance with many of these embodiments, the one or more processors 734 are operatively connected to tactile output devices like vibrators, and/or manipulators.

Examples of user input devices 734 include, but are not limited to, tactile devices including but not limited to, keyboards, keypads, touch screens, and/or trackballs; non-contact devices such as audio input devices; motion sensors and motion capture devices that the wager server can use to receive inputs from a user when the user interacts with the wager server 604.

The one or more communication interface and/or network interface devices 746 provide one or more wired or wireless interfaces for exchanging data and commands between the wager server 604 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface; a cellular or satellite telephone network interface; and the like.

The machine-readable storage medium 740 stores machine-executable instructions for various components of a wager server, such as but not limited to: an operating system 748; one or more application programs 750; one or more device drivers 752; and dynamic endpoint resolution interleaved wagering system wager server instructions and data 754 for use by the one or more processors 734 to provide the features of a dynamic endpoint resolution interleaved wagering system wager server as described herein.

In various embodiments, the machine-readable storage medium 740 is one of a (or a combination of two or more of) a hard drive, a flash drive, a DVD, a CD, a flash storage, a solid state drive, a ROM, an EIEPROM, and the like.

In operation, the machine-executable instructions are loaded into memory 736 from the machine-readable storage medium 740, the ROM 738 or any other storage location. The respective machine-executable instructions are accessed by the one or more processors 734 via the bus 732, and then executed by the one or more processors 734. Data used by the one or more processors 734 are also stored in memory 736, and the one or more processors 734 access such data during execution of the machine-executable instructions. Execution of the machine-executable instructions causes the one or more processors 734 to control the wager server 604 to provide the features of a dynamic endpoint resolution interleaved wagering system wager server as described herein

Although the wager server 604 is described herein as being constructed from or configured using one or more processors and machine-executable instructions stored and executed by hardware components, the wager server can be composed of only hardware components in accordance with other embodiments. In addition, although the storage medium 740 is described as being operatively connected to the one or more processors through a bus, those skilled in the art of processing devices will understand that the storage medium can include removable media such as, but not limited to, a USB memory device, an optical CD ROM, magnetic media such as tape and disks. In some embodiments, the storage medium 740 can be accessed by the one or more processors 734 through one of the interfaces or using a communication link. Furthermore, any of the user input devices or user output devices can be operatively connected to the one or more processors 734 via one of the interfaces or using a communication link.

In various embodiments, the wager server 604 may be used to construct other components of a dynamic endpoint resolution interleaved wagering system as described herein.

In some embodiments, components of a wager server and a process controller of a dynamic endpoint resolution interleaved wagering system may be constructed from or configured using a single device using processes that communicate using an interprocess communication protocol. In other such embodiments, the components of a wager server and a process controller of a dynamic endpoint resolution interleaved wagering system may communicate by passing messages, parameters or the like.

It should be understood that there may be many embodiments of a wager server 604 which could be possible, including forms where many modules and components of the wager server are located in various servers and locations, so the foregoing is not meant to be exhaustive or all inclusive, but rather provide data on various embodiments of a wager server 604.

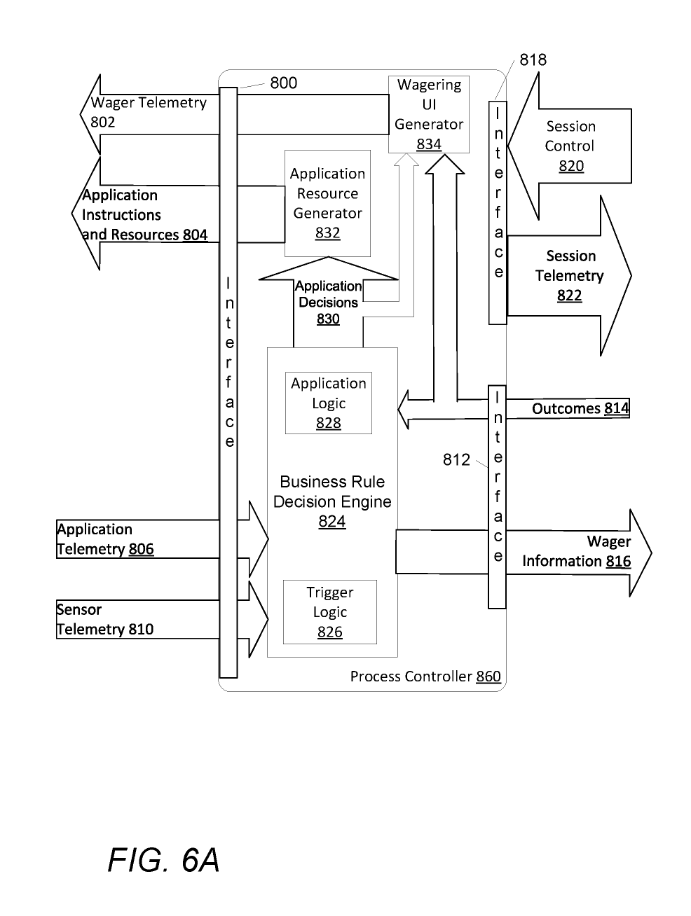

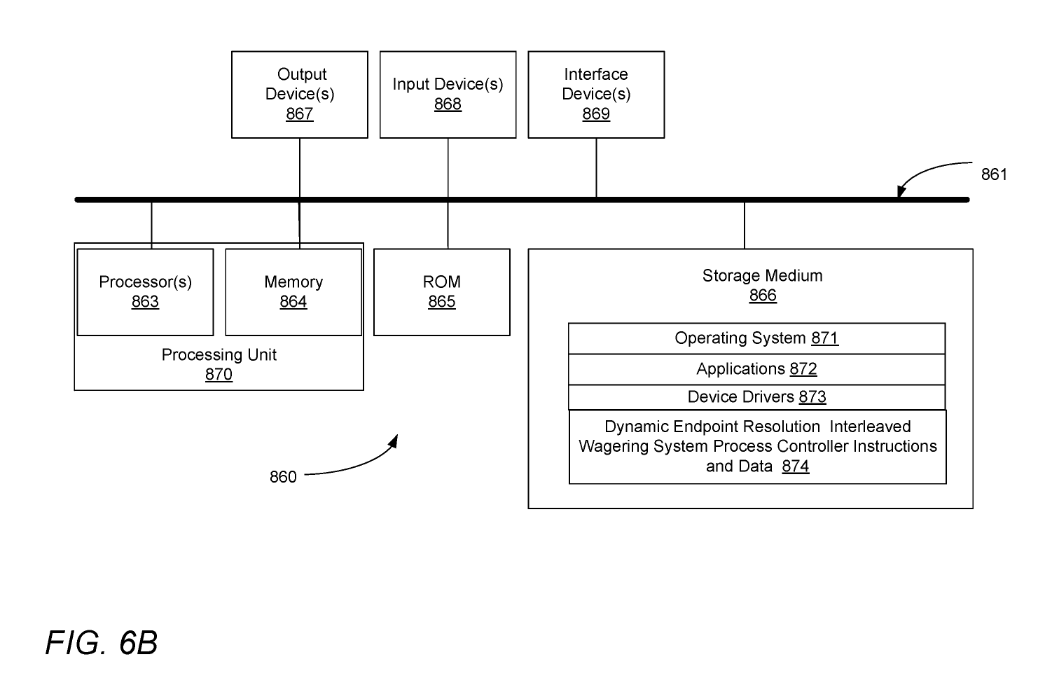

FIGS. 6A and 6B are diagrams of a structure of a process controller of a dynamic endpoint resolution interleaved wagering system in accordance with various embodiments of the invention. A process controller may be constructed from or configured using one or more processing devices configured to perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine, a personal computer, a gaming console, a set-top box, a computing device, a controller, or the like.

Referring now to FIG. 6A, in many embodiments, a process controller 860, suitable for use as process controller 112 of FIG. 1A, manages operation of a dynamic endpoint resolution interleaved wagering system, with a wager server and an interactive processing device being support units to the process controller 860. The process controller 860 provides an interface between the interactive application, provided by an interactive processing device, and a wagering proposition, provided by a wager server.

In some embodiments, the process controller 860 includes an interactive processing device interface 800 to an interactive processing device. The interactive processing device interface 800 provides for communication of data between an interactive processing device and the process controller 860, including but not limited to wager telemetry data 802, application instructions and resources 804, application telemetry data 806, and sensor telemetry data 810 as described herein.

In various embodiments, the process controller 860 includes a wager server interface 812 to a wager server. The wager server interface 812 provides for communication of data between the process controller 860 and a wager server, including but not limited to wager outcomes 814 and wager execution commands 816 as described in.

In some embodiments, the process controller 860 includes a session/management server interface 818 to a session/management server. The session/management server interface 818 provides for communication of data between the process controller 860 and a session/management server, including but not limited to session control data 820 and session telemetry data 822 as described herein.

The process controller 860 includes a rule-based decision engine 824 that receives telemetry data, such as application telemetry data and sensor telemetry data, from an interactive processing device. The rule-based decision engine 824 uses the telemetry data, along with wager logic 826 to generate wager execution commands used to trigger a wager in a wager server.

In some embodiments, the application telemetry data includes, but is not limited to, application environment variables that indicate the state of an interactive application being used by a user, interactive processing device data indicating a state of an interactive processing device, and user actions and interactions between a user and an interactive application provided by an interactive processing device. The wagering and/or wager execution commands may include, but are not limited to, an amount and type of the wager, a trigger of the wager, and a selection of a paytable to be used when executing the wager.

In some embodiments, the rule-based decision engine 824 also receives wager outcome data from a wager server. The decision engine 824 uses the wager outcome data, in conjunction with telemetry data and application logic 828 to generate application decisions 830 communicated to an application resource generator 832. The application resource generator 832 receives the application decisions and uses the application decisions to generate application commands and application resources to be communicated to an interactive application.

In many embodiments, the process controller 860 includes a pseudo random or random result generator used to generate random results that are communicated to the application resource generator 832. The application resource generator uses the random results to generate application commands and application resources to be communicated to an interactive processing device for use by an interactive application.

In various embodiments, the rule-based decision engine 824 also determines an amount of AC to award to a user based at least in part on the user's use of an interactive application of the dynamic endpoint resolution interleaved wagering system as determined from application telemetry data. In some embodiments, wager outcome data may also be used to determine the amount of AC that should be awarded to the user.

In numerous embodiments, an interactive application is a skill-based interactive application and the AC is awarded to the user for the user's skillful play of the skill-based interactive application.

In some embodiments, the application decisions and wager outcome data are communicated to a wagering interface generator 834. The wagering interface generator 834 receives the application decisions and wager outcome data and generates wager telemetry data describing the state of wagering and credit accumulation and loss for the dynamic endpoint resolution interleaved wagering system. In some embodiments, the wager telemetry data 146 may include, but is not limited to, amounts of AC and interactive elements earned, lost or accumulated by the user through use of the interactive application as determined from the application decisions, and Cr amounts won, lost or accumulated as determined from the wager outcome data and the one or more credit meters.

In some embodiments, the wager outcome data 814 also includes data about one or more game states of a wagering proposition executed in accordance with a wagering proposition by a wager server. In various such embodiments, the wagering interface generator 834 generates a wagering proposition process display and/or wagering proposition state display using the one or more game states of the wagering proposition. The wagering proposition process display and/or wagering proposition state display is included in wager telemetry data that is communicated to an interactive processing device. The wagering proposition process display and/or a wagering proposition state display is displayed by a wagering interface of the interactive processing device to a user. In other such embodiments, the one or more game states of the wagering proposition are communicated to an interactive processing device and a wagering interface of the interactive processing device generates a wagering proposition process display and/or wagering proposition state display using the one or more game states of the wagering proposition for display to a user.

The process controller 860 can further operatively connect to a wager server to determine an amount of credit or interactive elements available and other wagering metrics of a wagering proposition. Thus, the process controller 860 may potentially affect an amount of Cr in play for participation in the wagering events of a wagering proposition provided by the wager server. The process controller 860 may additionally include various audit logs and activity meters. In some embodiments, the process controller 860 can also couple to a centralized server for exchanging various data related to the user and the activities of the user during game play of a dynamic endpoint resolution interleaved wagering system.

In some embodiments, the operation of the process controller 860 does not affect the provision of a wagering proposition by a wager server except for user choice parameters that are allowable in accordance with the wagering proposition. Examples of user choice parameters include, but are not limited to: wager terms such as but not limited to a wager amount; speed of game play (for example, by pressing a button or pulling a handle of a slot machine); and/or agreement to wager into a bonus round.

In a number of embodiments, communication of wager execution commands between a wager server and the process controller 860 can further be used to communicate various wagering control factors that the wager server uses as input. Examples of wagering control factors include, but are not limited to, an amount of Cr, AC, interactive elements, or objects consumed per wagering event, and/or the user's election to enter a jackpot round.

In some embodiments, the process controller 860 utilizes a wagering interface to communicate certain interactive application data to the user, including but not limited to, club points, user status, control of the selection of user choices, and messages which a user can find useful in order to adjust the interactive application experience or understand the wagering status of the user in accordance with the wagering proposition in the wager server.

In some embodiments, the process controller 860 utilizes a wagering interface to communicate aspects of a wagering proposition to the user including, but not limited to, odds of certain wager outcomes, amount of Cr, AC, interactive elements, or objects in play, and amounts of Cr, AC, interactive elements, or objects available.

In a number of embodiments, a wager server can accept wager proposition factors including, but not limited to, modifications in the amount of Cr, AC, interactive elements, or objects wagered on each individual wagering event, a number of wagering events per minute the wager server can resolve, entrance into a bonus round, and other factors. In several embodiments, the process controller 860 can communicate a number of factors back and forth to the wager server, such that an increase/decrease in a wagered amount can be related to the change in user profile of the user in the interactive application. In this manner, a user can control a wager amount per wagering event in accordance with the wagering proposition with the change mapping to a parameter or component that is applicable to the interactive application experience.

Referring now to FIG. 6B, process controller 860 includes a bus 861 providing an interface for one or more processors 863, random access memory (RAM) 864, read only memory (ROM) 865, machine-readable storage medium 866, one or more user output devices 867, one or more user input devices 868, and one or more communication interface and/or network interface devices 869.

The one or more processors 863 may take many forms, such as, but not limited to: a central processing unit (CPU); a multi-processor unit (MPU); an ARM processor; a programmable logic device; or the like.

Examples of output devices 867 include, include, but are not limited to: display screens; light panels; and/or lighted displays. In accordance with particular embodiments, the one or more processors 863 are operatively connected to audio output devices such as, but not limited to: speakers; and/or sound amplifiers. In accordance with many of these embodiments, the one or more processors 863 are operatively connected to tactile output devices like vibrators, and/or manipulators.

In the example embodiment, the one or more processors 863 and the random access memory (RAM) 864 form a process controller processing unit 870. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

Examples of user input devices 868 include, but are not limited to: tactile devices including but not limited to, keyboards, keypads, foot pads, touch screens, and/or trackballs; non-contact devices such as audio input devices; motion sensors and motion capture devices that the process controller can use to receive inputs from a user when the user interacts with the process controller 860.

The one or more communication interface and/or network interface devices 869 provide one or more wired or wireless interfaces for exchanging data and commands between the process controller 860 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 866 stores machine-executable instructions for various components of the process controller 860 such as, but not limited to: an operating system 871; one or more applications 872; one or more device drivers 873; and dynamic endpoint resolution interleaved wagering system process controller instructions and data 874 for use by the one or more processors 863 to provide the features of a process controller as described herein.

In various embodiments, the machine-readable storage medium 870 is one of a (or a combination of two or more of) a hard drive, a flash drive, a DVD, a CD, a flash storage, a solid state drive, a ROM, an EIEPROM, and the like.

In operation, the machine-executable instructions are loaded into memory 864 from the machine-readable storage medium 866, the ROM 865 or any other storage location. The respective machine-executable instructions are accessed by the one or more processors 863 via the bus 861, and then executed by the one or more processors 863. Data used by the one or more processors 863 are also stored in memory 864, and the one or more processors 863 access such data during execution of the machine-executable instructions. Execution of the machine-executable instructions causes the one or more processors 863 to control the process controller 860 to provide the features of a dynamic endpoint resolution interleaved wagering system process controller as described herein.

Although the process controller 860 is described herein as being constructed from or configured using one or more processors and instructions stored and executed by hardware components, the process controller can be composed of only hardware components in accordance with other embodiments. In addition, although the storage medium 866 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 866 may be accessed by processor 863 through one of the interfaces or using a communication link. Furthermore, any of the user input devices or user output devices may be operatively connected to the one or more processors 863 via one of the interfaces or using a communication link.

In various embodiments, the process controller 860 may be used to construct other components of a dynamic endpoint resolution interleaved wagering system as described herein.

In some embodiments, components of an interactive processing device and a process controller of a dynamic endpoint resolution interleaved wagering system may be constructed from or configured using a single device using processes that communicate using an interprocess communication protocol. In other such embodiments, the components of an interactive processing device and a process controller of a dynamic endpoint resolution interleaved wagering system may communicate by passing messages, parameters or the like.

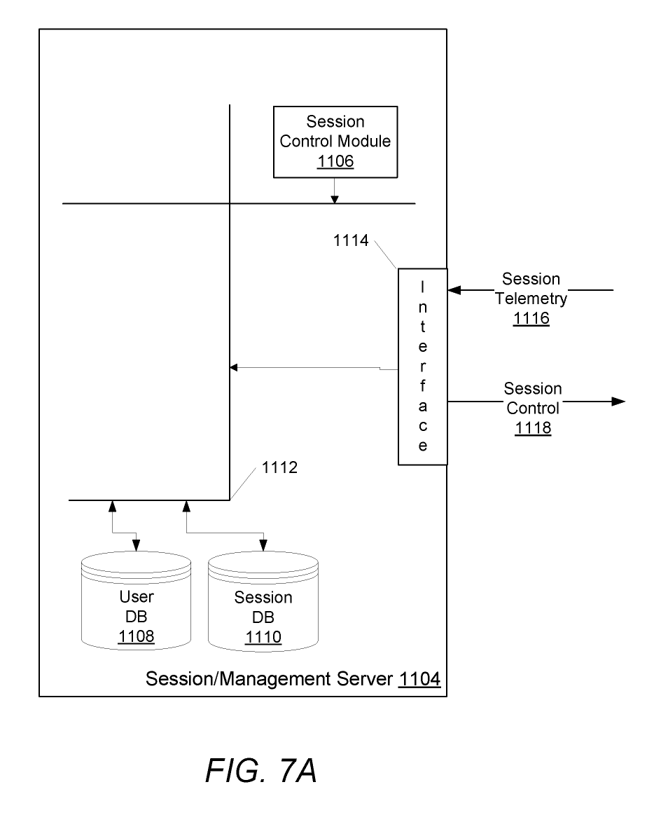

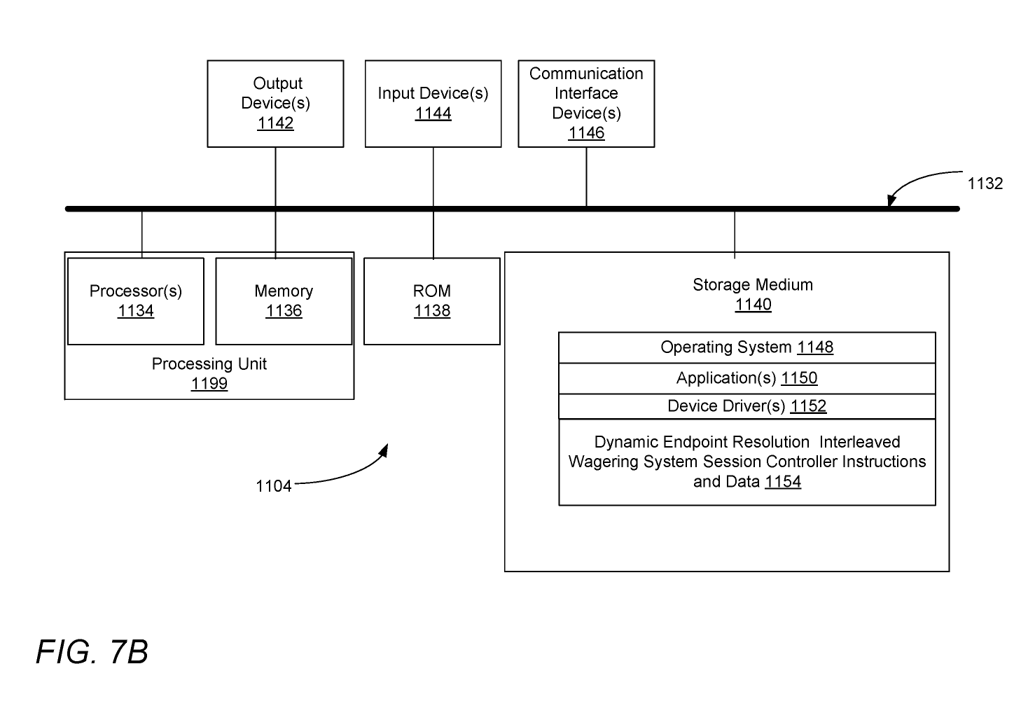

FIGS. 7A and 7B are diagrams of a structure of a session/management server of a dynamic endpoint resolution interleaved wagering system in accordance with various embodiments of the invention. A session/management server may be constructed from or configured using one or more processing devices configured to perform the operations of the session/management server. In many embodiments, a wager session can be constructed from or configured using various types of processing devices including, but not limited to, a mobile device such as a smartphone or the like, a personal digital assistant, a wireless device such as a tablet computer or the like, an electronic gaming machine, a personal computer, a gaming console, a set-top box, a computing device, a controller, a server, or the like.

Referring now to FIG. 7A, in various embodiments, a session/management server 1104, suitable for use as session/management server 150 of FIG. 1A, includes a user management and session control module 1106 whose processes may include, but are not limited to, registering users of a dynamic endpoint resolution interleaved wagering system, validating users of a dynamic endpoint resolution interleaved wagering system using user registration data, managing various types of sessions for users of the dynamic endpoint resolution interleaved wagering system, and the like.

The session/management server 1104 may further include a datastore 1108 storing user data used to manage user registration and validation. The session/management server 1104 may further include a datastore 1110 storing session data used to manage one or more sessions.

The various session/management server components can interface with each other via an internal bus 1112 and/or other appropriate communication mechanism.

An interface 1114 allows the session/management server 1104 to operatively connect to one or more external devices, such as one or more process controllers, wager servers and/or interactive processing devices as described herein. The interface provides for receiving session telemetry data 1116 from the one more external devices as described herein. The session telemetry data includes, but is not limited to, amounts of AC earned by one or more users, requests for entering into a session as described herein, and telemetry data regarding the progress of one or more users during a session. The interface 1114 may also provide for communicating secession control data 1118 used to manage a session as described herein.

In numerous embodiments, the interface between the session/management server and other systems/devices may be a wide area network (WAN) such as the Internet. However, other methods of communication may be used including, but not limited to, a local area network (LAN), a universal serial bus (USB) interface, and/or some other method by which two electronic devices could communicate with each other.

During operation of the session/management server, the external system communicates session telemetry data to the session/management server. The session/management server receives the session telemetry data and uses the session telemetry data to generate session control data as described herein. The session/management server communicates the session control data to the external system.

Referring now to FIG. 7B, session/management server 1104 includes a bus 1132 that provides an interface for one or more processors 1134, random access memory (RAM) 1136, read only memory (ROM) 1138, machine-readable storage medium 1140, one or more user output devices 1142, one or more user input devices 1144, and one or more communication interface and/or network interface devices 1146.

The one or more processors 1134 may take many forms, such as, but not limited to, a central processing unit (CPU), a multi-processor unit (MPU), an ARM processor, a controller, a programmable logic device, or the like.

In the example embodiment, the one or more processors 1134 and the random access memory (RAM) 1136 form a session/management server processing unit 1199. In some embodiments, the session/management server processing unit includes one or more processors operatively connected to one or more of a RAM, ROM, and machine-readable storage medium; the one or more processors of the session/management server processing unit receive instructions stored by the one or more of a RAM, ROM, and machine-readable storage medium via a bus; and the one or more processors execute the received instructions. In some embodiments, the session/management server processing unit is an ASIC (Application-Specific Integrated Circuit). In some embodiments, the session/management server processing unit is a SoC (System-on-Chip).

Examples of output devices 1142 include, but are not limited to, display screens, light panels, and/or lighted displays. In accordance with particular embodiments, the one or more processors 1134 are operatively connected to audio output devices such as, but not limited to speakers, and/or sound amplifiers. In accordance with many of these embodiments, the one or more processors 1134 are operatively connected to tactile output devices like vibrators, and/or manipulators.

Examples of user input devices 1144 include, but are not limited to, tactile devices including but not limited to, keyboards, keypads, touch screens, and/or trackballs; non-contact devices such as audio input devices; motion sensors and motion capture devices that the session/management server can use to receive inputs from a user when the user interacts with the session/management server 1104.

The one or more communication interface and/or network interface devices 1146 provide one or more wired or wireless interfaces for exchanging data and commands between the session/management server 1104 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface; a cellular or satellite telephone network interface; and the like.

The machine-readable storage medium 1140 stores machine-executable instructions for various components of a session/management server, such as but not limited to: an operating system 1148; one or more application programs 1150; one or more device drivers 1152; and dynamic endpoint resolution interleaved wagering system session/management server instructions and data 1154 for use by the one or more processors 1134 to provide the features of a dynamic endpoint resolution interleaved wagering system session/management server as described herein.

In various embodiments, the machine-readable storage medium 1140 is one of a (or a combination of two or more of) a hard drive, a flash drive, a DVD, a CD, a flash storage, a solid state drive, a ROM, an EIEPROM, and the like.

In operation, the machine-executable instructions are loaded into memory 736 from the machine-readable storage medium 1140, the ROM 1138 or any other storage location. The respective machine-executable instructions are accessed by the one or more processors 1134 via the bus 1132, and then executed by the one or more processors 1134. Data used by the one or more processors 1134 are also stored in memory 1136, and the one or more processors 1134 access such data during execution of the machine-executable instructions. Execution of the machine-executable instructions causes the one or more processors 1134 to control the session/management server 1104 to provide the features of a dynamic endpoint resolution interleaved wagering system session/management server as described herein

Although the session/management server 1104 is described herein as being constructed from or configured using one or more processors and machine-executable instructions stored and executed by hardware components, the session/management server can be composed of only hardware components in accordance with other embodiments. In addition, although the storage medium 1140 is described as being operatively connected to the one or more processors through a bus, those skilled in the art of processing devices will understand that the storage medium can include removable media such as, but not limited to, a USB memory device, an optical CD ROM, magnetic media such as tape and disks. In some embodiments, the storage medium 1140 can be accessed by the one or more processors 1134 through one of the interfaces or using a communication link. Furthermore, any of the user input devices or user output devices can be operatively connected to the one or more processors 1134 via one of the interfaces or using a communication link.

In various embodiments, the session/management server 1104 may be used to construct other components of a dynamic endpoint resolution interleaved wagering system as described herein.

In some embodiments, components of a session/management server and a process controller of a dynamic endpoint resolution interleaved wagering system may be constructed from or configured using a single device using processes that communicate using an interprocess communication protocol. In other such embodiments, the components of a session/management server and a process controller of a dynamic endpoint resolution interleaved wagering system may communicate by passing messages, parameters or the like.

In some embodiments, components of a session/management server and a wager server of a dynamic endpoint resolution interleaved wagering system may be constructed from or configured using a single device using processes that communicate using an interprocess communication protocol. In other such embodiments, the components of a session/management server and a process controller of a dynamic endpoint resolution interleaved wagering system may communicate by passing messages, parameters or the like.

It should be understood that there may be many embodiments of a session/management server 1104 which could be possible, including forms where many modules and components of the session/management server are located in various servers and locations, so the foregoing is not meant to be exhaustive or all inclusive, but rather provide data on various embodiments of a session/management server 1104.

In numerous embodiments, any of a wager server, a process controller, an interactive processing device, or a session/management server as described herein can be constructed from or configured using multiple processing devices, whether dedicated, shared, or distributed in any combination thereof, or can be constructed from or configured using a single processing device. In addition, while certain aspects and features of dynamic endpoint resolution interleaved wagering system processes described herein have been attributed to a wager server, a process controller, an interactive processing device, or a session/management server, these aspects and features can be provided in a distributed form where any of the features or aspects can be provided by any of a session/management server, a wager server, a process controller, and/or an interactive processing device within a dynamic endpoint resolution interleaved wagering system without deviating from the spirit of the invention.

Although various components of dynamic endpoint resolution interleaved wagering systems are discussed herein, dynamic endpoint resolution interleaved wagering systems can be configured with any component as appropriate to the specification of a specific application in accordance with embodiments of the invention. In certain embodiments, components of a dynamic endpoint resolution interleaved wagering system, such as a session/management server, a process controller, a wager server, and/or an interactive processing device, can be configured in different ways for a specific dynamic endpoint resolution interleaved wagering system.

In some embodiments, components of a session/management server, an interactive processing device, a process controller, and/or a wager server of a dynamic endpoint resolution interleaved wagering system may be constructed from or configured using a single device using processes that communicate using an interprocess communication protocol. In many embodiments, the components of a session/management server, an interactive processing device, a process controller and a wager server of a dynamic endpoint resolution interleaved wagering system may communicate by passing messages, parameters or the like.

In addition, while certain aspects and features of dynamic endpoint resolution interleaved wagering system processes described herein have been attributed to a session/management server, a wager server, a process controller, or an interactive processing device, these aspects and features can be provided in a distributed form where any of the features or aspects can be provided by any of a session/management server, a wager server, a process controller, and/or an interactive processing device within a dynamic endpoint resolution interleaved wagering system.

### Operation of Dynamic Endpoint Resolution Interleaved Wagering Systems

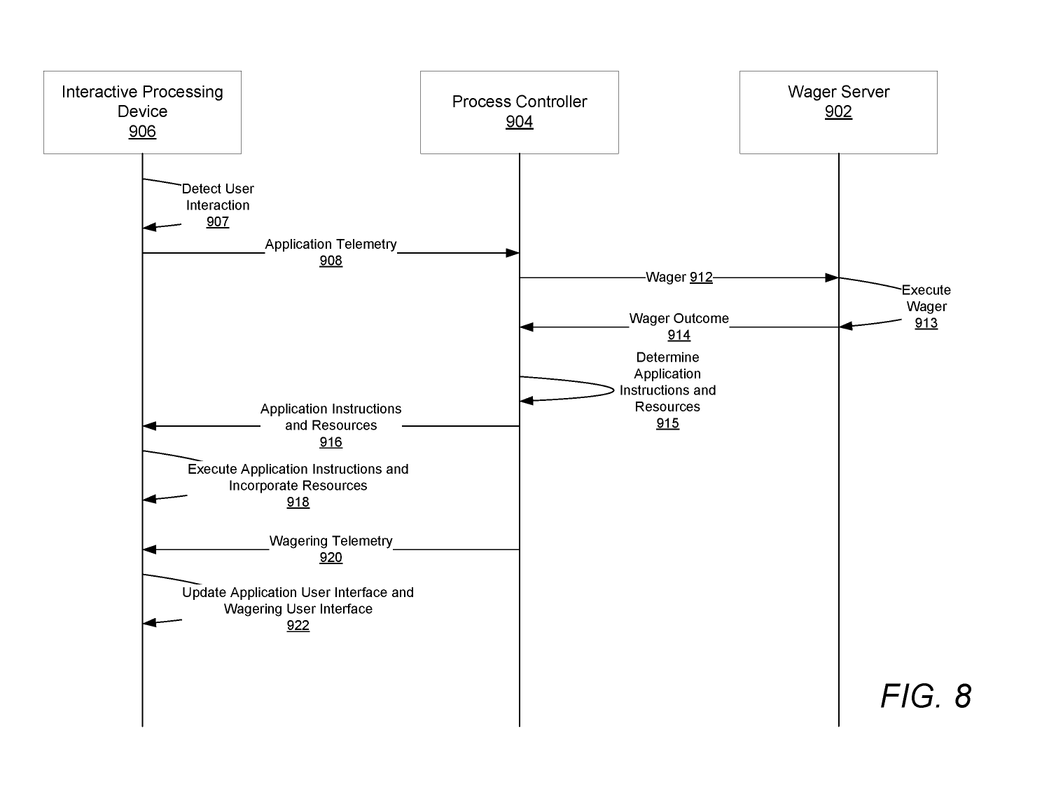

FIG. 8 is a sequence diagram of interactions between components of a dynamic endpoint resolution interleaved wagering system in accordance with various embodiments of the invention. The components of the dynamic endpoint resolution interleaved wagering system include a wager server 902, such as wager server 102 of FIG. 1A, a process controller 904, such as process controller 112 of FIG. 1A, and an interactive processing device 906, such as interactive processing device 120 of FIG. 1A. The process begins with the interactive processing device 906 detecting a user performing a user interaction in an application interface of an interactive application provided by the interactive processing device 906. The interactive processing device 906 communicates application telemetry data 908 to the process controller 904. The application telemetry data includes, but is not limited to, the user interaction detected by the interactive processing device 906.

The process controller 904 receives the application telemetry data 908. Upon determination by the process controller 904 that the user interaction indicates a wagering event, the process controller 904 generates wager execution commands including a wager request 912 that the process controller 904 uses to command the wager server 902 to execute a wager. The request for a wager event may include wager terms associated with a wagering proposition. The process controller 904 communicates the wager execution commands to the wager server 902.

The wager server 902 receives the wager execution commands 912 and uses the wager execution commands to execute (913) a wager in accordance with a wagering proposition. The wager server 902 communicates a wager outcome 914 of the executed wager to the process controller 904.

The process controller 904 receives the wager outcome and generates (915) interactive application instruction and resource data 916 for the interactive application. The process controller 904 uses the interactive application instruction and resource data 916 to command the interactive processing device. The process controller communicates the interactive application instruction and resource data 916 to the interactive processing device 906. The process controller also communicates wagering telemetry data 920 including the wager outcome to the interactive processing device 906.

The interactive processing device 906 receives the interactive application instruction and resource data 916 and wagering telemetry data 918. The interactive processing device 906 incorporates the received interactive application resources and executes the received interactive application commands (918). The interactive processing device updates (922) an applicaiton interface of the interactive application provided by the interactive processing device using the interactive application commands and the resources, and updates (922) a wagering interface using the wagering telemetry data.

In several embodiments, a user can interact with a dynamic endpoint resolution interleaved wagering system by using Cr for wagering in accordance with a wagering proposition along with AC and interactive elements in interactions with an interactive application. Wagering can be executed by a wager server while an interactive application can be executed by an interactive processing device and managed with a process controller.

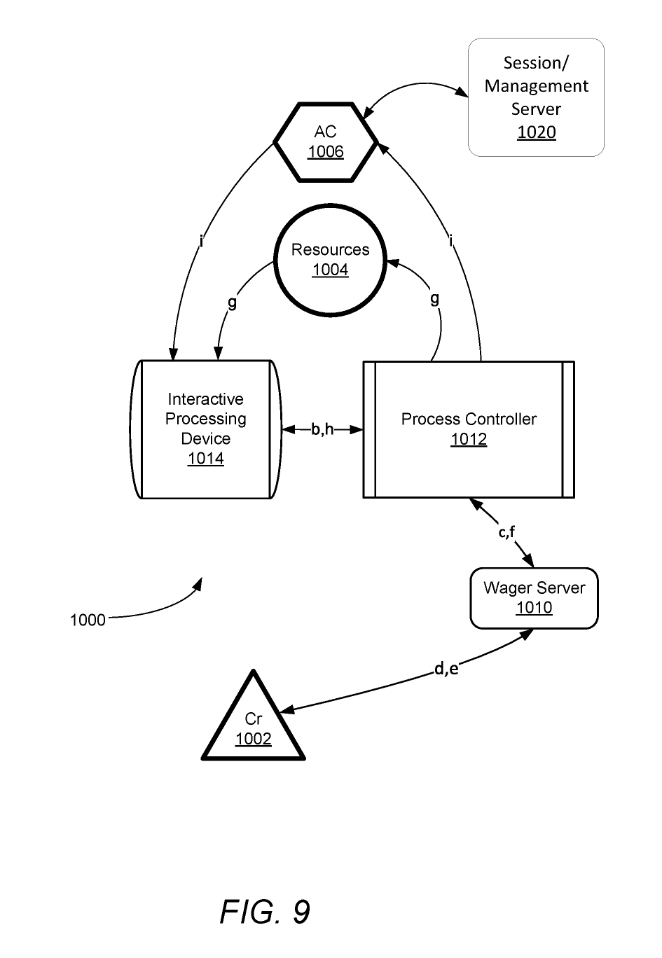

FIG. 9 is a collaboration diagram that illustrates how resources such as AC, Cr, interactive elements, and objects are utilized in a dynamic endpoint resolution interleaved wagering system in accordance with various embodiments of the invention. The collaboration diagram 1000 illustrates that Cr 1002, interactive application resources including interactive elements and objects 1004 and AC 1006 can be utilized by a user 1008 in interactions with a wager server 1010, such as wager server 102 of FIG. 1A, a process controller 1012, such as wager server 112 of FIG. 1, and an interactive processing device 1014, such as interactive processing device 120 of FIG. 1A, of a dynamic endpoint resolution interleaved wagering system. The contribution of interactive elements and objects such as included in resources 1004, can be linked to a user's access to credits, such as Cr 1002 and/or AC 1006. Electronic receipt of these credits can come via a smart card, voucher or other portable media, or as received using a communication link from a server. In some embodiments, these credits can be drawn on demand from a user profile located in a database locally on a dynamic endpoint resolution interleaved wagering system or in a remote server.

A user's actions and/or decisions can affect an interactive application of interactive processing device 1014 that consume and/or accumulate AC 1004 and/or resources 1004 in an interactive application executed by an interactive processing device 1014, a wager server 101 and a process controller 1012. The process controller 1012 can monitor the activities taking place within an interactive application executed by an interactive processing device 1014 for wagering event occurrences. The process controller 1012 can also communicate the wagering event occurrences to the wager server 1010 that triggers a wager of Cr 1002 in accordance with a wagering proposition executed by the wager server 1010.

In several embodiments, the user commences interaction with the dynamic endpoint resolution interleaved wagering system by contributing credit to a dynamic endpoint resolution interleaved wagering system such as, but not limited to, Cr 1002 that may be credit in a real currency or may be credit in a virtual currency that is not fungible with a real currency, AC 1006 that may be application environment credits, and specified types of interactive application interactive elements and/or objects 1004. One or more of these contributions may be provided directly as currency and/or transferred in electronically. Electronic transfer may come via a smart card, voucher or other portable media, or as transferred in using a communication link from a user data server or dynamic endpoint resolution interleaved wagering system session/management server. In many embodiments, contributions may be drawn on demand from user accounts located in servers residing on the network or in the cloud on a real time basis as the credits, interactive elements and/or object are committed or consumed by the dynamic endpoint resolution interleaved wagering system. Generally, Cr is utilized and accounted for by the wager server 1010; and the resources 1004 and AC 1006 are utilized and accounted for by the process controller 1012 and/or the interactive processing device 1014.

The user interacts (a) with an interactive application provided by the interactive processing device 1014 with the interaction representing an action by the user within the context of the interactive application. The interactive processing device 1014 receives the user interaction and communicates (b) the interaction to the process controller 1012. The process controller 1012 receives the interaction and determines from the interaction whether or not a wager should be triggered. If a wager should be triggered, the process controller 1012 commands (c) the wager server 1010 to execute a wager in accordance with a wagering proposition associated with the interaction and thereby triggers a wager. The wager server receives the wager execution commands and executes the wager in accordance with the wagering proposition, and consumes (d) an appropriate amount of Cr 1002 for the wager. The wager server 1010 adjusts (e) the Cr 1002 based upon a wager outcome of the wager and communicates (f) the wager outcome to the process controller 1012 as to the outcome of the wager triggered by the process controller 1012. The process controller 1012 receives the wager outcome. The process controller determines what resources 1004 should be provided to the interactive processing device, generates the resources 1004 and application commands and commands (g) the interactive processing device 1014 using the resources 1004 and application commands. The interactive processing device receives the resources 1004 and application commands from the process controller 1012 and integrates them into the execution of the interactive application provided by the interactive processing device 1014.

In some embodiments, the process controller 1012 communicates (h) data about the wager outcome to the interactive processing device. The interactive processing device receives the wager outcome and displays the wager outcome to the user 1008.

In some embodiments, the process controller 1012 determines what resources and commands to provide to the interactive processing device 1014 for use by the interactive application provided by the interactive processing device 1014 partially on the basis of the wager outcome. In some such embodiments, resources are provided in a case that the wager was a winning wager for the user. In other such embodiments, fewer or no resources are provided in a case of a losing wager.

In some embodiments, the process controller 1012 determines what resources to provide based on internal logic of the process controller 1012. In some such embodiments, the process controller 1012 employs a random result generator, such as a P/RNG, to generate a random result and the random result is used to determine what resources are provided to the interactive processing device 1014.

In several embodiments, the process controller 1012 determines an increment or a decrement of an amount of AC 1006 using the interactions received from the interactive processing device. The increment or decremented amount is communicated (i) to the interactive processing device for display to the user.

In some embodiments, the process controller 1012 executes a wager of Cr as a virtual currency, AC, interactive elements or objects. In some such embodiments, the process controller 1012 employs a random result generator, such as a P/RNG, to generate a random result and the random result is used to determine a wager outcome in Cr as a virtual currency, AC, interactive elements or objects.

The following is description of an embodiment of the described collaboration where an interactive application provided by an interactive processing device of a dynamic endpoint resolution interleaved wagering system is a first person shooter game. The process begins by a user selecting a machine gun to use in the game and then fires a burst of bullets at an opponent. The interactive processing device can communicate to the process controller of the user's choice of weapon, that a burst of bullets was fired, and/or the outcome of the burst. The process controller communicates to the wager server that 3 credits (Cr) are to be wagered on the outcome of a wagering event to match the three bullets consumed. The wager server then performs the wagering event and determines the result of the wager and may determine the winnings from a paytable. The wager server consumes 3 credits of Cr for the wager and executes the specified wager. By way of example, the wager server may determine that the user hit a jackpot of 6 credits and returns the 6 credits to the Cr and communicates to the process controller that 3 net credits were won by the user.

The process controller communicates to the interactive processing device to add 3 bullets to an ammunition clip. The interactive processing device adds 3 bullets back to the ammo clip. The ammunition may be added by directly adding the ammunition to the clip or by allowing the user to find extra ammunition during use. The process controller logs the new user score (AC) in the game (as a function of the successful hit on the opponent) based on the interactive processing device communication, and adds 2 extra points to the user score since a jackpot has been won. The process controller then adds 10 points to the user score (AC) given the success of the hit which in this example is worth 8 points, plus the 2 extra point. Note that this example is only intended to provide an illustration of how credits flow in a dynamic endpoint resolution interleaved wagering system, but is not intended to be exhaustive and only lists only one of numerous possibilities of how a dynamic endpoint resolution interleaved wagering system may be configured to manage its fundamental credits.

In many embodiments, session/management server 1020, such as user account controller 150 of FIG. 1A, of a dynamic endpoint resolution interleaved wagering system is used to store AC for use of the user. In such an embodiment, AC is generated by the process controller based on the user's use of the dynamic endpoint resolution interleaved wagering system and an amount of the AC is communicated to the session/management server 1020. The session/management server stores the amount of AC between sessions. In some embodiments, the session/management server communicates an amount of AC to the process controller at the start of a session for use by the user during a session.

### User Registration and User Profiles

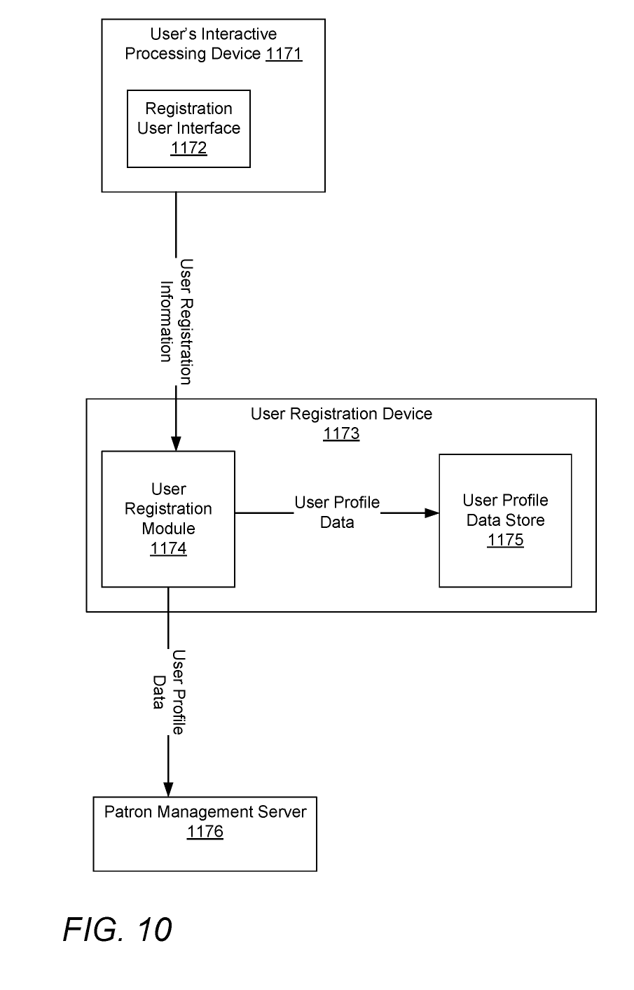

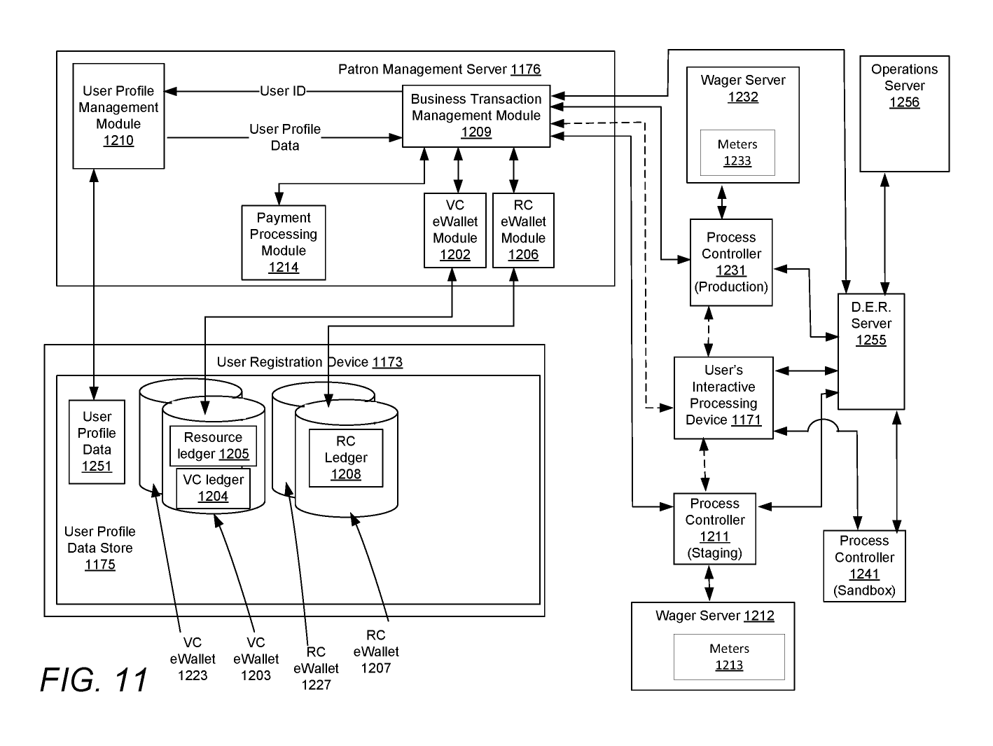

FIG. 10 illustrates user registration and user profiles in accordance with an example embodiment. A user's interactive processing device 1171 provides a registration user interface 1172 for receiving user registration information (e.g., interactive application user registration information, real money wagering user registration information, or any combination of interactive application user registration information and real money wagering user registration information). The user's interactive processing device 1171 provides user registration information received via the registration user interface 1172 to a user registration device 1173. A user registration module 1174 of the user registration device 1173 generates user profile data based on the user registration information received from the user's interactive processing device 1171. The user registration module 1174 stores the generated user profile data in a user profile data store 1175. The user registration module 1174 also registers the generated user profile data with a patron management server 1176. In some embodiments, the user registration device 1173 includes one or more of a process controller and a wager server. In some embodiments, a patron management server (e.g., 1176 of FIG. 11) stores the generated user profile data in a user profile data store 1175.

### Dynamic Endpoint Resolution System Overview

FIG. 11 illustrates a Dynamic Endpoint Resolution System. As shown in FIG. 11, the Dynamic Endpoint Resolution System includes the patron management server 1176, the user registration device 1173, an operations server 1256, a Dynamic Endpoint Resolution (DER) Server 1255, the interactive processing device 1171, process controllers 1211, 1231 and 1241, and wager servers 1212 and 1232.

The patron management server 1176 includes a business transaction management module 1209, a virtual credit (VC) eWallet module 1202, a real credit (RC) eWallet module 1206, a user profile management module 1210, and a payment processing module 1214.

As illustrated in FIG. 11, the patron management server 1176 is communicatively coupled to the staging process controller 1211, the production process controller 1231, the sandbox process controller 1241, the user registration device 1173, and the Dynamic Endpoint Resolution Server (DERS) 1255.

The user profile data store 1175 includes user profile data 1251, two VC eWallets and two RC eWallets. The VC eWallet 1203 and RC eWallet 1207 are for a first user having a first user ID, and the VC eWallet 1223 and, RC eWallet 1227 are for a second user having a second user ID. During operation, as additional users are registered by the user registration device 1173, additional VC eWallets and RC eWallets are added to the user profile data store 1175.

The virtual credit (VC) eWallet module 1202 manages each Virtual Credit eWallet (e.g., 1203 and 1223 of FIG. 11). The Virtual Credit eWallet for each user is stored in a processor-readable format, and each Virtual Credit eWallet includes a virtual credit ledger (e.g., VC ledger 1204 of FIG. 11). The virtual credit ledger (e.g., 1204) records at least virtual credit (VC) debit transactions, VC credit transactions, and a VC balance for a respective user. The VC eWallet module 1202 includes processor-executable instructions that when executed, control the patron management server 1176 to record VC debit transactions for a user in the VC ledger of the user, record VC credit transactions for the user in the VC ledger of the user, update the VC balance of the VC ledger for the user, and provide the VC balance of the VC ledger for the user.

In the example embodiment, each Virtual Credit eWallet (e.g., 1203, 1223) includes a resource ledger (e.g., 1205). The resource ledger records at least one of resource purchase transactions, resource sale transactions, resource exchange transactions, resource consumption transactions, and an inventory of resources (e.g., items owned, amount of a particular resource owned) for a respective user. The VC eWallet module 1202 includes processor-executable instructions that when executed, control the patron management server 1176 to record resource purchase transactions for a user, record resource sale transactions for the user, record resource exchange transactions for the user, record resource consumption transactions for the user, update an inventory of the user's resources (e.g., items owned, amount of a particular resource owned), and provide the inventory of the user's resources.

The real credit eWallet module 1206 manages each Real Credit (RC) eWallet (e.g., 1207 and 1227 of FIG. 11). The Real Credit eWallet for each user is stored in a processor-readable format, and each Real Credit eWallet includes a real credit ledger (e.g., 1208 of FIG. 11). The real credit ledger records at least real credit (RC) debit transactions, RC credit transactions, and a RC balance for a respective user. The RC eWallet module 1206 includes processor-executable instructions that when executed, control the patron management server 1176 to record RC debit transactions for a user in the RC ledger of the user, record RC credit transactions for the user in the RC ledger of the user, update the RC balance of the RC ledger for the user, and provide the RC balance of the RC ledger for the user.

In the example embodiment, the user's interactive processing device 1171 is similar to the interactive processing device 120 of FIG. 1A and 400 of FIGS. 4A and 4B. In the example embodiment, the staging process controller 1211, the production process controller 1231, and the sandbox process controller 1241 are each similar to the process controller 112 of FIG. 1A and 860 of FIGS. 6A and 6B. In the example embodiment, the staging wager server 1212 and the production wager server 1232 are each similar to the wager server 102 of FIG. 1 and 604 of FIGS. 5A and 5B. In accordance with an exemplary embodiment, the sandbox process controller 1241 emulates a wager server that is similar to the wager server 102 of FIG. 1, 604 of FIGS. 5A and 5B.

In some embodiments, the staging process controller 1211, the production process controller 1231, the sandbox process controller 1241, the staging wager server 1212 and the production wager server 1232 are modules hosted by one or more processing devices.

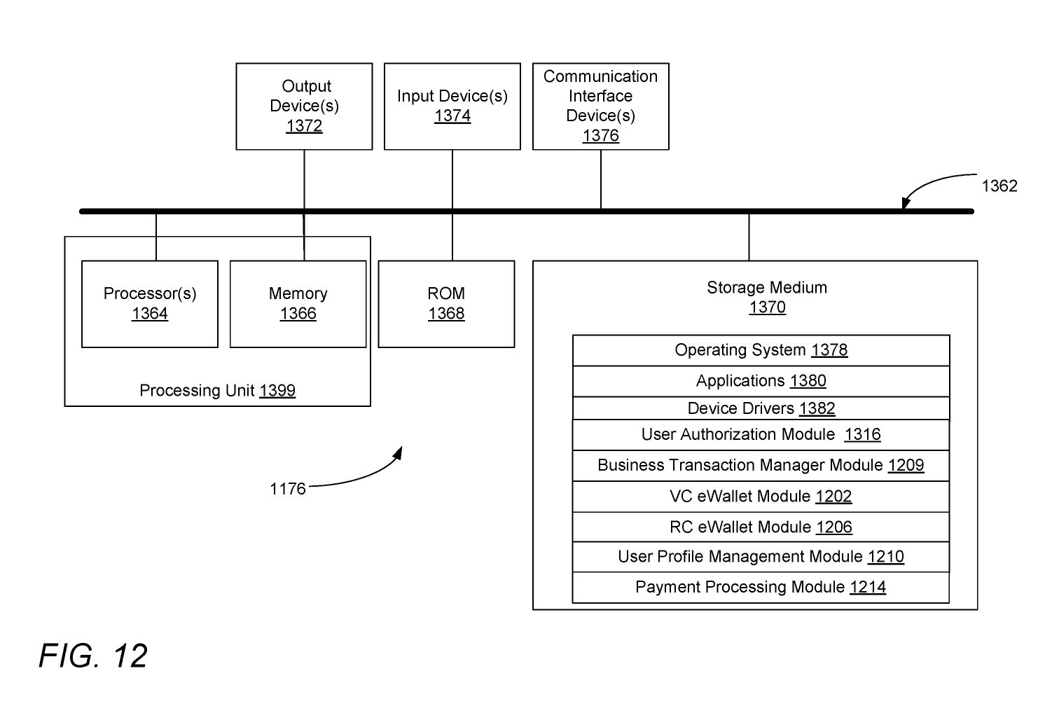

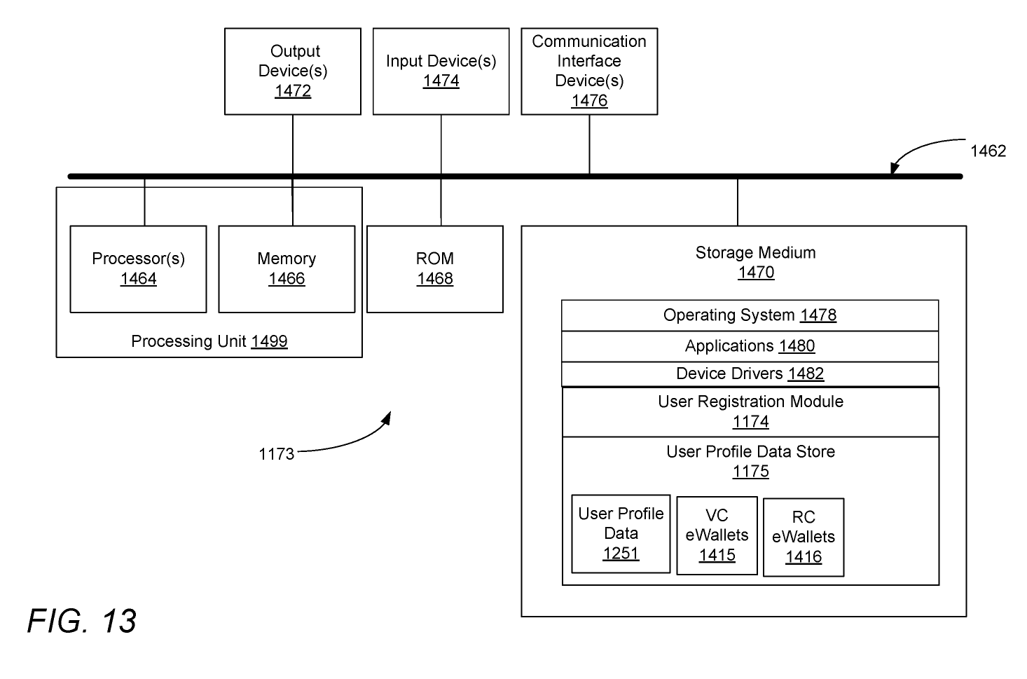

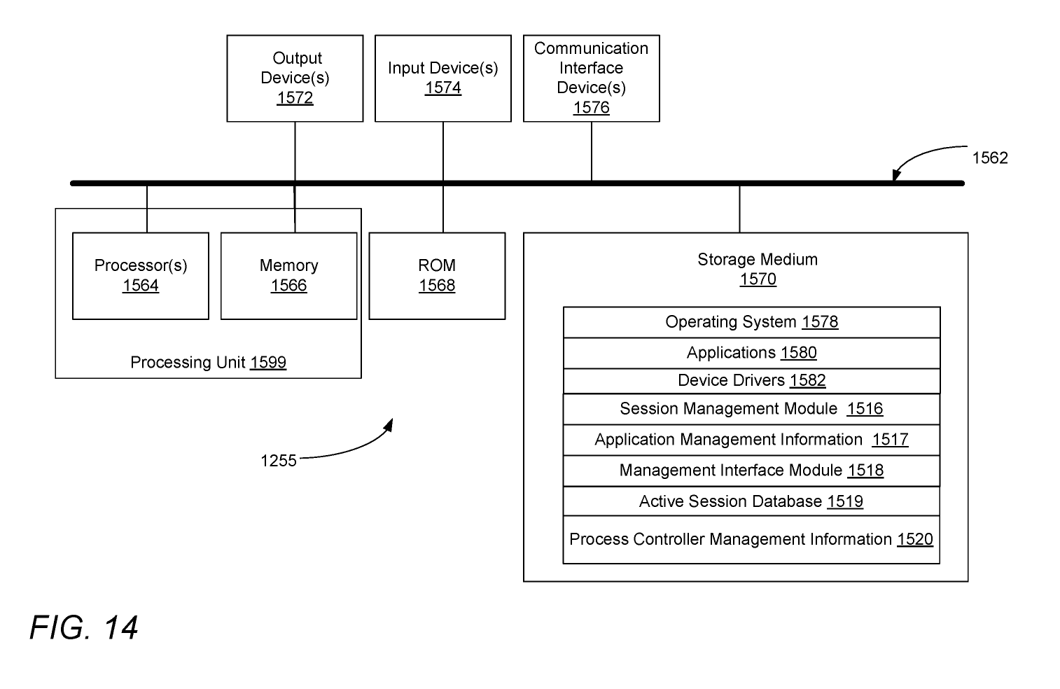

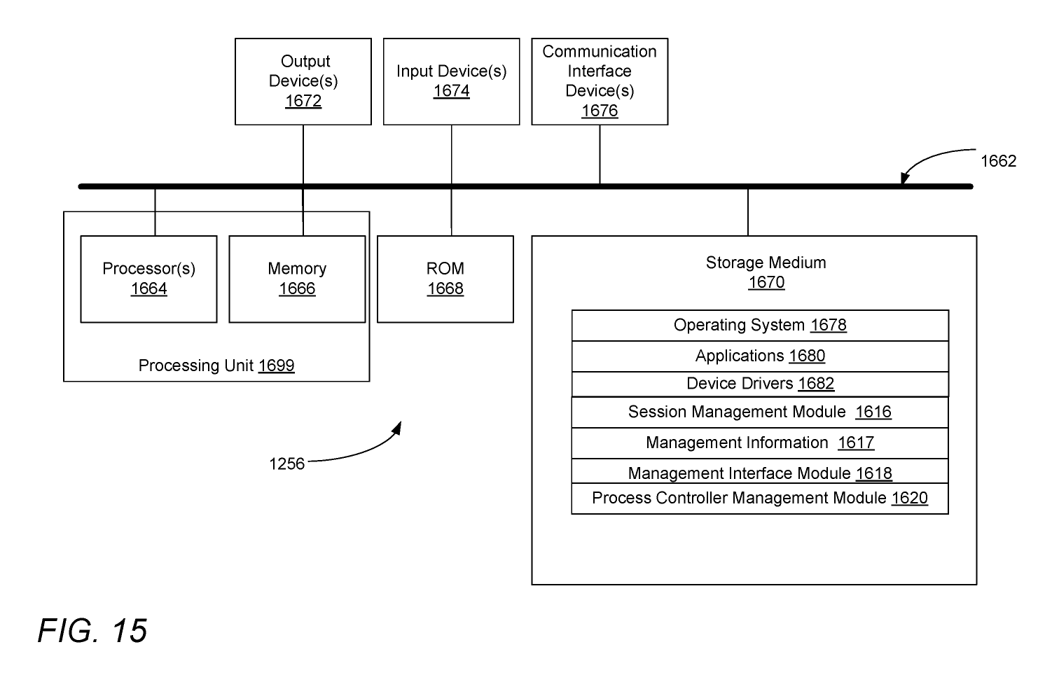

The architecture of the patron management server 1176 is described herein with respect to FIG. 12. The architecture of the user registration device 1173 is described herein with respect to FIG. 13. The architecture of the DER server 1255 is described below with respect to FIG. 14. The architecture of the operations server 1256 is described below with respect to FIG. 15.

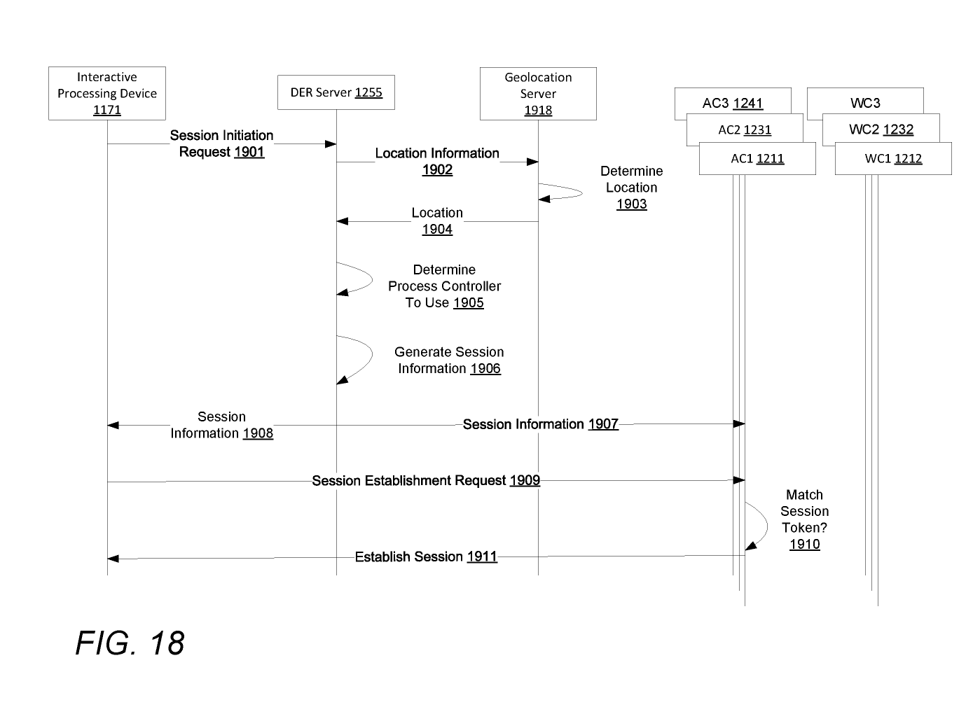

As will be described in more detail herein with respect to FIG. 18, the user's interactive processing device 1171 uses the DER Server 1255 to initiate a dynamic endpoint resolution interleaved wagering system session with a process controller (e.g., one of the process controllers 1211, 1231 and 1241).

The staging process controller 1211 is communicatively coupled to a staging wager server 1212 having one or more credit meters 1213.

The production process controller 1231 is communicatively coupled to a production wager server 1232 having one or more credit meters 1233.

As shown in FIG. 11, an interactive application of the dynamic endpoint resolution interleaved wagering system is deployed in a sandbox environment, and the user's interactive processing device 1171 is communicatively coupled to the sandbox process controller 1241, as represented by the solid line. In the example embodiment, in a case where the interactive application of the dynamic endpoint resolution interleaved wagering system is deployed in a sandbox environment, the user's interactive processing device 1171 is not communicatively coupled to the patron management server 1176.

In operation, in a case where the interactive application of the dynamic endpoint resolution interleaved wagering system is deployed in a staging environment, the user's interactive processing device 1171 can communicatively couple with the staging process controller 1211 and the patron management server 1176. In operation, in a case where the interactive application of the dynamic endpoint resolution interleaved wagering system is deployed in a production environment, the user's interactive processing device 1171 can communicatively couple with the production process controller 1231 and the patron management server 1176.

### Patron Management Server

FIG. 12 is a diagram of a structure of a data processing device for constructing the patron management server 1176 of the dynamic endpoint resolution interleaved wagering system. In some embodiments, the patron management server 1176 may be constructed from one or more processing devices configured to perform the operations of the patron management server 1176. In some embodiments, the patron management sever 1176 can be constructed from various types of processing devices including, but not limited to, an electronic gaming machine, a personal computer, a gaming console, a set-top box, a server, a computing device, a controller, and the like.

In the illustrated embodiment, the patron management server 1176 includes a bus 1362 that provides an interface for one or more processors 1364, random access memory (RAM) 1366, read only memory (ROM) 1368, machine-readable storage medium 1370, one or more user output devices 1372, one or more user input devices 1374, and one or more network interface devices 1376.

The one or more processors 1364 may take many forms, such as, but not limited to: a central processing unit (CPU); a multi-processor unit (MPU); an ARM processor; or the like.

In the example embodiment, the one or more processors 1364 and the random access memory (RAM) 1366 form a patron management server processing unit 1399. In some embodiments, the patron management server processing unit includes one or more processors operatively connected to one or more of a RAM, ROM, and machine-readable storage medium; the one or more processors of the patron management server processing unit receive instructions stored by the one or more of a RAM, ROM, and machine-readable storage medium via a bus; and the one or more processors execute the received instructions. In some embodiments, the patron management server processing unit is an ASIC (Application-Specific Integrated Circuit). In some embodiments, the patron management server processing unit is a SoC (System-on-Chip).

Examples of output devices 1372 include, include, but are not limited to: display screens; light panels; and/or lighted displays. In accordance with particular embodiments, the one or more processors 1364 are operatively connected to audio output devices such as, but not limited to: speakers; and/or sound amplifiers. In accordance with many of these embodiments, the one or more processors 1364 are operatively connected to tactile output devices like vibrators, and/or manipulators.

Examples of user input devices 1374 include, but are not limited to: tactile devices including but not limited to, keyboards, keypads, foot pads, touch screens, and/or trackballs; non-contact devices such as audio input devices; motion sensors and motion capture devices that the patron management server 1176 can use to receive inputs from a user when the user interacts with the patron management server 1176.

The one or more network interface devices 1376 provide one or more wired or wireless interfaces for exchanging data and commands between the patron management server 1176 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a POTS, cellular or satellite telephone network; and the like.

The machine-readable storage medium 1370 stores machine-executable instructions for various components of the patron management server 1176 such as, but not limited to: an operating system 1378; one or more applications 1380; one or more device drivers 1382; the business transaction manager module 1209, the VC eWallet module 1202, the RC eWallet module 1206, the user profile management module 1210, the payment processing module 1214, and a user authorization module 1316.

In the example embodiment of FIG. 12, the user profile management module 1210 includes machine-executable instructions for receiving a user ID from the business transaction management module 1209, controlling the one or more processors 1364 to control the patron management server 1176 to receive user profile data corresponding to the user ID from a user registration device (e.g., user registration device 1173), and providing the received user profile data (corresponding to the user ID) to the business transaction management module 1209. In the example embodiment, the received user profile data corresponding to the user ID includes information for accessing the VC eWallet and the RC eWallet corresponding to the user ID, by using the VC eWallet Module 1202 and the RC eWallet module 1206, respectively.

In various embodiments, the machine-readable storage medium 1370 is one of a (or a combination of two or more of) a hard drive, a flash drive, a DVD, a CD, a flash storage, a solid state drive, a ROM, an EEPROM, and the like.

In operation, the machine-executable instructions (e.g., the instructions 1378, 1380, 1382, 1316, 1209, 1202, 1206, 1210 and 1214) are loaded into the memory 1366 from the machine-readable storage medium 1370, the ROM 1368 or any other storage location. The respective machine-executable instructions are accessed by the one or more processors 1364 via the bus 1362, and then executed by the one or more processors 1364. Data used by the one or more processors 1364 are also stored in the memory 1366, and the one or more processors 1364 access such data during execution of the machine-executable instructions. Execution of the machine-executable instructions causes the one or more processors 1364 to control the patron management server 1176 to provide the features of the patron management server 1176 as described herein.

Although the patron management server 1176 is described herein as being constructed from one or more processors and instructions stored and executed by hardware components, the patron management server 1176 can be composed of only hardware components in accordance with other embodiments. In addition, although the storage medium 1370 is described as being operatively connected to the one or more processors through a bus, those skilled in the art of processing devices will understand that the storage medium can include removable media such as, but not limited to, a USB memory device, an optical CD ROM, magnetic media such as tape and disks. Also, the storage medium 1370 can be accessed by processor 1364 through one of the interfaces or over a network. Furthermore, any of the user input devices or user output devices can be operatively connected to the one or more processors 1364 via one of the interfaces or over a network.

In various embodiments, the patron management server 1176 may be used to construct other components of a dynamic endpoint resolution interleaved wagering system, as described herein. In some embodiments, components of a patron management server and one or more of a user registration device, a process controller, a wager server, a DER SERVER, an operations server, and an interactive processing device of a dynamic endpoint resolution interleaved wagering system may be constructed using a single device 1360 using processes that communicate using an interprocess communication protocol. In other such embodiments, components of a patron management server and one or more of a user registration device, a process controller, a wager server, a DER SERVER, an operations server, and an interactive processing device of a dynamic endpoint resolution interleaved wagering system may communicate by passing messages, parameters or the like.

### User Registration Device

FIG. 13 is a diagram of a structure of a data processing device for constructing the user registration device 1173 of the dynamic endpoint resolution interleaved wagering system. In some embodiments, the user registration device 1173 may be constructed from one or more processing devices configured to perform the operations of the user registration device 1173. In some embodiments, the user registration device 1173 can be constructed from various types of processing devices including, but not limited to, an electronic gaming machine, a personal computer, a gaming console, a set-top box, a server, a computing device, a controller, and the like.

In the illustrated embodiment, the user registration device 1173 includes a bus 1462 that provides an interface for one or more processors 1464, random access memory (RAM) 1466, read only memory (ROM) 1468, machine-readable storage medium 1470, one or more user output devices 1472, one or more user input devices 1474, and one or more network interface devices 1476.

The one or more processors 1464 may take many forms, such as, but not limited to: a central processing unit (CPU); a multi-processor unit (MPU); an ARM processor; or the like.

In the example embodiment, the one or more processors 1464 and the random access memory (RAM) 1466 form a registration device processing unit 1499. In some embodiments, the registration device processing unit 1499 includes one or more processors operatively connected to one or more of a RAM, ROM, and machine-readable storage medium; the one or more processors of the registration device processing unit receive instructions stored by the one or more of a RAM, ROM, and machine-readable storage medium via a bus; and the one or more processors execute the received instructions. In some embodiments, the registration device processing unit is an ASIC (Application-Specific Integrated Circuit). In some embodiments, the registration device processing unit is a SoC (System-on-Chip).

Examples of output devices 1472 include, include, but are not limited to: display screens; light panels; and/or lighted displays. In accordance with particular embodiments, the one or more processors 1464 are operatively connected to audio output devices such as, but not limited to: speakers; and/or sound amplifiers. In accordance with many of these embodiments, the one or more processors 1464 are operatively connected to tactile output devices like vibrators, and/or manipulators.

Examples of user input devices 1474 include, but are not limited to: tactile devices including but not limited to, keyboards, keypads, foot pads, touch screens, and/or trackballs; non-contact devices such as audio input devices; motion sensors and motion capture devices that the user registration device 1173 can use to receive inputs from a user when the user interacts with the user registration device 1173.

The one or more network interface devices 1476 provide one or more wired or wireless interfaces for exchanging data and commands between the user registration device 1173 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a POTS, cellular or satellite telephone network; and the like.

The machine-readable storage medium 1470 stores machine-executable instructions for various components of the user registration device 1173 such as, but not limited to: an operating system 1478; one or more applications 1480; one or more device drivers 1482; the user registration module 1174, and the user profile data store 1175. The user profile data store 1175 includes the user profile data 1251, VC eWallets 1415 and RC eWallets 1416. VC eWallets 1415 include VC eWallets 1203 and 1223 of FIG. 11. RC eWallets 1416 include RC eWallets 1207 and 1227 of FIG. 11. The user registration module 1174 includes machine-executable instructions for controlling the one or more processors 1464 to control the user registration device 1173 to generate user profile data and register the user profile data with the patron management server 1176, as described herein.

In various embodiments, the machine-readable storage medium 1470 is one of a (or a combination of two or more of) a hard drive, a flash drive, a DVD, a CD, a flash storage, a solid state drive, a ROM, an EEPROM, and the like.

In operation, the machine-executable instructions are loaded into the memory 1466 from the machine-readable storage medium 1470, the ROM 1468 or any other storage location. The respective machine-executable instructions are accessed by the one or more processors 1464 via the bus 1462, and then executed by the one or more processors 1464. Data used by the one or more processors 1464 are also stored in the memory 1466, and the one or more processors 1464 access such data during execution of the machine-executable instructions. Execution of the machine-executable instructions causes the one or more processors 1464 to control the user registration device 1173 to provide the features of the user registration device 1173 as described herein.

Although the user registration device 1173 is described herein as being constructed from one or more processors and instructions stored and executed by hardware components, the user registration device 1173 can be composed of only hardware components in accordance with other embodiments. In addition, although the storage medium 1470 is described as being operatively connected to the one or more processors through a bus, those skilled in the art of processing devices will understand that the storage medium can include removable media such as, but not limited to, a USB memory device, an optical CD ROM, magnetic media such as tape and disks. Also, the storage medium 1470 can be accessed by processor 1464 through one of the interfaces or over a network. Furthermore, any of the user input devices or user output devices can be operatively connected to the one or more processors 1464 via one of the interfaces or over a network.

In various embodiments, the user registration device 1173 may be used to construct other components of a dynamic endpoint resolution interleaved wagering system as described herein. In some embodiments, components of user registration device and one or more of a patron management server, a process controller, a wager server, a DER server, an operations server, and an interactive processing device of a dynamic endpoint resolution interleaved wagering system may be constructed using a single device 1460 using processes that communicate using an interprocess communication protocol. In other such embodiments, components of a user registration device and one or more of a patron management server, a process controller, a wager server, a DER server, an operations server, and an interactive processing device of a dynamic endpoint resolution interleaved wagering system may communicate by passing messages, parameters or the like.

### Dynamic Endpoint Resolution Server

FIG. 14 is a diagram of a structure of a data processing device for constructing the Dynamic Endpoint Resolution (DER) server 1255 of the dynamic endpoint resolution interleaved wagering system. In some embodiments, the Dynamic Endpoint Resolution (DER) server 1255 may be constructed from one or more processing devices configured to perform the operations of the Dynamic Endpoint Resolution (DER) server 1255. In some embodiments, the Dynamic Endpoint Resolution (DER) server 1255 can be constructed from various types of processing devices including, but not limited to, an electronic gaming machine, a personal computer, a gaming console, a set-top box, a server, a computing device, a controller, and the like.

In the illustrated embodiment, the Dynamic Endpoint Resolution (DER) server 1255 includes a bus 1562 that provides an interface for one or more processors 1564, random access memory (RAM) 1566, read only memory (ROM) 1568, machine-readable storage medium 1570, one or more user output devices 1572, one or more user input devices 1574, and one or more network interface devices 1576.

The one or more processors 1564 may take many forms, such as, but not limited to: a central processing unit (CPU); a multi-processor unit (MPU); an ARM processor; or the like.

In the example embodiment, the one or more processors 1564 and the random access memory (RAM) 1566 form a DER server processing unit 1599. In some embodiments, the DER server processing unit includes one or more processors operatively connected to one or more of a RAM, ROM, and machine-readable storage medium; the one or more processors of the DER server processing unit receive instructions stored by the one or more of a RAM, ROM, and machine-readable storage medium via a bus; and the one or more processors execute the received instructions. In some embodiments, the DER server processing unit is an ASIC (Application-Specific Integrated Circuit). In some embodiments, the DER server processing unit is a SoC (System-on-Chip).

Examples of output devices 1572 include, include, but are not limited to: display screens; light panels; and/or lighted displays. In accordance with particular embodiments, the one or more processors 1564 are operatively connected to audio output devices such as, but not limited to: speakers; and/or sound amplifiers. In accordance with many of these embodiments, the one or more processors 1564 are operatively connected to tactile output devices like vibrators, and/or manipulators.

Examples of user input devices 1574 include, but are not limited to: tactile devices including but not limited to, keyboards, keypads, foot pads, touch screens, and/or trackballs; non-contact devices such as audio input devices; motion sensors and motion capture devices that the Dynamic Endpoint Resolution (DER) server 1255 can use to receive inputs from a user when the user interacts with the Dynamic Endpoint Resolution (DER) server 1255.

The one or more network interface devices 1576 provide one or more wired or wireless interfaces for exchanging data and commands between the Dynamic Endpoint Resolution (DER) server 1255 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a POTS, cellular or satellite telephone network; and the like.

The machine-readable storage medium 1570 stores machine-executable instructions for various components of the Dynamic Endpoint Resolution (DER) server 1255 such as, but not limited to: an operating system 1578; one or more applications 1580; one or more device drivers 1582; a session management module 1516; application management information 1517; a management interface module 1518; an active session database 1519; and process controller management information 1520.

In various embodiments, the machine-readable storage medium 1570 is one of a (or a combination of two or more of) a hard drive, a flash drive, a DVD, a CD, a flash storage, a solid state drive, a ROM, an EEPROM, and the like.

In operation, the machine-executable instructions (e.g., the instructions 1578, 1580, 1582, 1516 and 1518) are loaded into the memory 1566 from the machine-readable storage medium 1570, the ROM 1568 or any other storage location. The respective machine-executable instructions are accessed by the one or more processors 1564 via the bus 1562, and then executed by the one or more processors 1564. Data used by the one or more processors 1564 are also stored in the memory 1566, and the one or more processors 1564 access such data during execution of the machine-executable instructions. Execution of the machine-executable instructions causes the one or more processors 1564 to control the Dynamic Endpoint Resolution (DER) server 1255 to provide the features of the Dynamic Endpoint Resolution (DER) server 1255 as described herein.

Although the Dynamic Endpoint Resolution (DER) server 1255 is described herein as being constructed from one or more processors and instructions stored and executed by hardware components, the Dynamic Endpoint Resolution (DER) server 1255 can be composed of only hardware components in accordance with other embodiments. In addition, although the storage medium 1570 is described as being operatively connected to the one or more processors through a bus, those skilled in the art of processing devices will understand that the storage medium can include removable media such as, but not limited to, a USB memory device, an optical CD ROM, magnetic media such as tape and disks. Also, the storage medium 1570 can be accessed by processor 1564 through one of the interfaces or over a network. Furthermore, any of the user input devices or user output devices can be operatively connected to the one or more processors 1564 via one of the interfaces or over a network.

In various embodiments, the Dynamic Endpoint Resolution (DER) server 1255 may be used to construct other components of a dynamic endpoint resolution interleaved wagering system as described herein. In some embodiments, components of a Dynamic Endpoint Resolution (DER) server 1255 and one or more of a user registration server, a patron management server, a process controller, a wager server, an operations server, and an interactive processing device of a dynamic endpoint resolution interleaved wagering system may be constructed using a single device 1560 using processes that communicate using an interprocess communication protocol. In other such embodiments, components of a Dynamic Endpoint Resolution (DER) server 1255 and one or more of a user registration server, a patron management server, a process controller, a wager server, an operations server, and an interactive processing device of a dynamic endpoint resolution interleaved wagering system may communicate by passing messages, parameters or the like.

### Operations Server

FIG. 15 is a diagram of a structure of a data processing device for constructing the operations server 1256 of the dynamic endpoint resolution interleaved wagering system. In some embodiments, the operations server 1256 may be constructed from one or more processing devices configured to perform the operations of the operations server 1256. In some embodiments, the operations server 1256 can be constructed from various types of processing devices including, but not limited to, an electronic gaming machine, a personal computer, a gaming console, a set-top box, a server, a computing device, a controller, and the like.

In the illustrated embodiment, the operations server 1256 includes a bus 1662 that provides an interface for one or more processors 1664, random access memory (RAM) 1666, read only memory (ROM) 1668, machine-readable storage medium 1670, one or more user output devices 1672, one or more user input devices 1674, and one or more network interface devices 1676.

The one or more processors 1664 may take many forms, such as, but not limited to: a central processing unit (CPU); a multi-processor unit (MPU); an ARM processor; or the like.

In the example embodiment, the one or more processors 1664 and the random access memory (RAM) 1666 form an operations server processing unit 1699. In some embodiments, the operations server processing unit includes one or more processors operatively connected to one or more of a RAM, ROM, and machine-readable storage medium; the one or more processors of the operations server processing unit receive instructions stored by the one or more of a RAM, ROM, and machine-readable storage medium via a bus; and the one or more processors execute the received instructions. In some embodiments, the operations server processing unit is an ASIC (Application-Specific Integrated Circuit). In some embodiments, the operations server processing unit is a SoC (System-on-Chip).

Examples of output devices 1672 include, include, but are not limited to: display screens; light panels; and/or lighted displays. In accordance with particular embodiments, the one or more processors 1664 are operatively connected to audio output devices such as, but not limited to: speakers; and/or sound amplifiers. In accordance with many of these embodiments, the one or more processors 1664 are operatively connected to tactile output devices like vibrators, and/or manipulators.

Examples of user input devices 1674 include, but are not limited to: tactile devices including but not limited to, keyboards, keypads, foot pads, touch screens, and/or trackballs; non-contact devices such as audio input devices; motion sensors and motion capture devices that the operations server 1256 can use to receive inputs from a user when the user interacts with the operations server 1256.

The one or more network interface devices 1676 provide one or more wired or wireless interfaces for exchanging data and commands between the operations server 1256 and other devices that may be included in a dynamic endpoint resolution interleaved wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a POTS, cellular or satellite telephone network; and the like.

The machine-readable storage medium 1670 stores machine-executable instructions for various components of the operations server 1256 such as, but not limited to: an operating system 1678; one or more applications 1680; one or more device drivers 1682; a session management module 1616; management information 1617; a management interface module 1618; and a process controller management module 1620.

In various embodiments, the machine-readable storage medium 1670 is one of a (or a combination of two or more of) a hard drive, a flash drive, a DVD, a CD, a flash storage, a solid state drive, a ROM, an EEPROM, and the like.

In operation, the machine-executable instructions (e.g., the instructions 1678, 1680, 1682, 1616, 1618, and 1620) are loaded into the memory 1666 from the machine-readable storage medium 1670, the ROM 1668 or any other storage location. The respective machine-executable instructions are accessed by the one or more processors 1664 via the bus 1662, and then executed by the one or more processors 1664. Data used by the one or more processors 1664 are also stored in the memory 1666, and the one or more processors 1664 access such data during execution of the machine-executable instructions. Execution of the machine-executable instructions causes the one or more processors 1664 to control the operations server 1256 to provide the features of the operations server 1256 as described herein.

Although the operations server 1256 is described herein as being constructed from one or more processors and instructions stored and executed by hardware components, the operations server 1256 can be composed of only hardware components in accordance with other embodiments. In addition, although the storage medium 1670 is described as being operatively connected to the one or more processors through a bus, those skilled in the art of processing devices will understand that the storage medium can include removable media such as, but not limited to, a USB memory device, an optical CD ROM, magnetic media such as tape and disks. Also, the storage medium 1670 can be accessed by processor 1664 through one of the interfaces or over a network. Furthermore, any of the user input devices or user output devices can be operatively connected to the one or more processors 1664 via one of the interfaces or over a network.

In various embodiments, the operations server 1256 may be used to construct other components of a dynamic endpoint resolution interleaved wagering system as described herein. In some embodiments, components of an operations server and one or more of a DER server, a user registration server, a patron management server, a process controller, a wager server, and an interactive processing device of a dynamic endpoint resolution interleaved wagering system may be constructed using a single device 1256 using processes that communicate using an interprocess communication protocol. In other such embodiments, components of an operations server and one or more of a DER server, a user registration server, a patron management server, a process controller, a wager server, and an interactive processing device of a dynamic endpoint resolution interleaved wagering system may communicate by passing messages, parameters or the like.

### Configuration of the DER Server: Interactive Application Configuration

Referring back to FIG. 11, the DER Server 1255 is used to establish a dynamic endpoint resolution interleaved wagering system session between an interactive processing device (e.g., the interactive processing device 1171) and a process controller (e.g., one of the process controllers 1211, 1231 and 1241) for a specified interactive application (e.g., the interactive application 402 of FIG. 4A). Prior to establishing the interactive session for the specified interactive application, the DER Server 1255 is configured to determine a process controller for the session for the specified interactive application.

In the example embodiment of FIG. 11, the DER Server 1255 is configured by associating a specified process controller with the interactive application or by associating one or more process controller parameters with the interactive application, the process controller parameters being used by the DER Server 1255 to assign a process controller to the interactive application.

In the example embodiment, the operations server 1256 is used to configure the DER Server 1255. More specifically, the operations server 1256 configures the DER Server 1255 by providing management information (e.g., the management information 1617 of FIG. 15) (including one or more of application management information and process controller management information) to the DER Server 1255 via a management interface provided by the management interface module 1618 of FIG. 15.

In the example embodiment, during development of an interactive application by using an application development device (e.g., an application development client device, an application development server device, an application development workstation device, a sandbox process controller, and the like), the application development device requests an interactive application ID from the DER Server 1255.

During deployment of the interactive application from the application development device to one of a sandbox server (e.g., a sandbox process controller), a staging server (e.g., a staging process controller) or a production server (e.g., a production process controller), the application development device for the interactive application uses the operations server 1256 to provide management information to the DER Server 1255 to configure the DER Server 1255 for deployment of the interactive application in one of a sandbox environment (e.g. a sandbox environment that includes a sandbox process controller) a staging environment (e.g. a staging environment that includes a staging process controller) and a production environment (e.g. a production environment that includes production process controller).

More specifically, in an example embodiment, to deploy the interactive application, the session management module 1616 of the operations server 1256 configures the DER Server 1255 for association of at least one process controller with the interactive application by providing the DER Server 1255 with management information. In a case where the operations server 1256 configures the DER Server 1255 for association of a specified process controller with the interactive application, the operations server 1256 provides the DER Server 1255 with management information that specifies an interactive application ID for the specified interactive application, connection information for the specified process controller, a deployment state (e.g., one of a staging deployment state, a sandbox deployment state, and a production deployment state), and a parameter indicating whether RC wagering is enabled for sessions of the interactive application.

In the example embodiment, a sandbox environment is an isolated development environment in which the user's interactive processing device 1171 is not communicatively coupled to the patron management server 1176. An application can be removed from service by being moved to a sandbox environment. A staging environment is a testing environment that simulates an actual production environment.

In some embodiments, management information for associating a specified process controller with a specified interactive application does not specify a deployment state. In some embodiments, management information for associating a specified process controller with a specified interactive application does not specify a parameter indicating whether RC wagering is enabled for sessions of the interactive application.

In the example embodiment, in a case where the operations server 1256 configures the DER Server 1255 for association of one or more process controllers with the interactive application based on process controller parameters, the session management module 1616 of the operations server 1256 provides the DER Server 1255 with management information that specifies an interactive application ID for the specified interactive application and specifies one or more process controller parameters that are used by the DER Server 1255 to determine a process controller to use for the session, from a pool of candidate process controllers. In the example embodiment, the process controller parameters include one or more of: a deployment parameter (e.g., sandbox deployment, staging deployment, production deployment), and a parameter indicating whether RC wagering is enabled for sessions of the interactive application.

In the example embodiment, the process controller parameters can also include one or more of a user attribute, a location attribute and an operator attribute. In the example embodiment, the user attribute includes one of a user wildcard value that matches any user ID (e.g., “*”), a User ID, and a NULL value that indicates that a User ID has not been provided to the DER Server 1255 (e.g., “NULL”). In the example embodiment, the location attribute includes one of a location wildcard value that matches any Location ID (e.g., “*”), a Location ID, and a NULL value that indicates that a location ID has not been provided to the DER Server 1255 (e.g., “NULL”). In the example embodiment, the operator attribute includes one of an operator wildcard value that matches any operator ID (e.g., “*”), an operator ID, and a NULL value that indicates that an operator ID has not been provided to the DER Server 1255 (e.g., “NULL”).

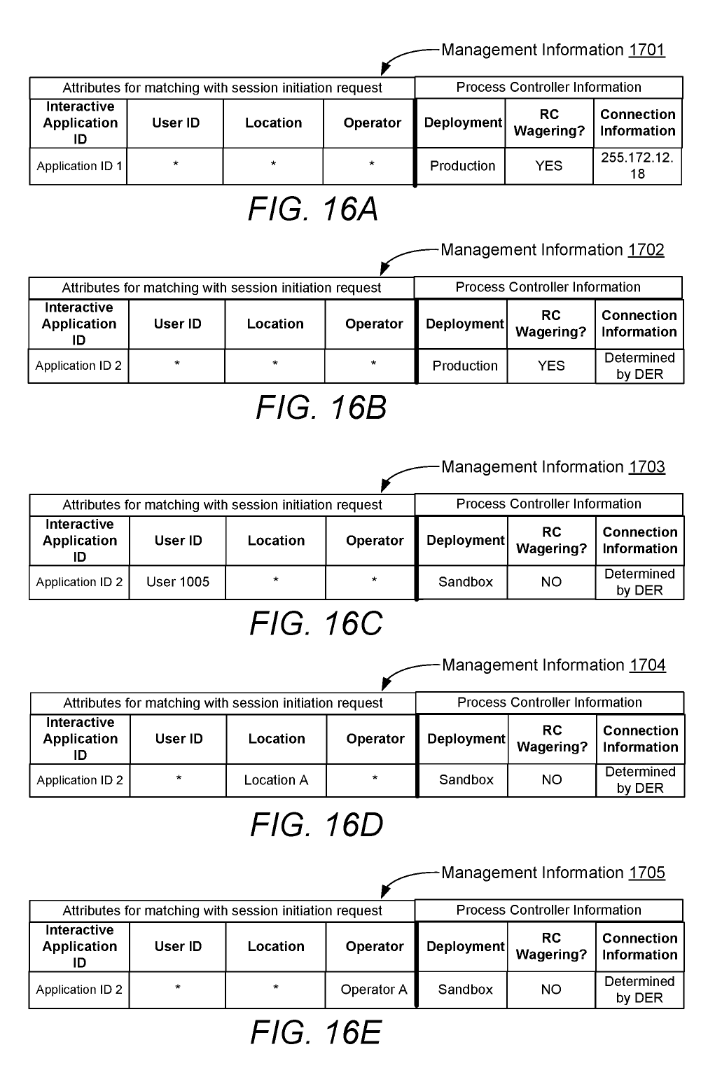

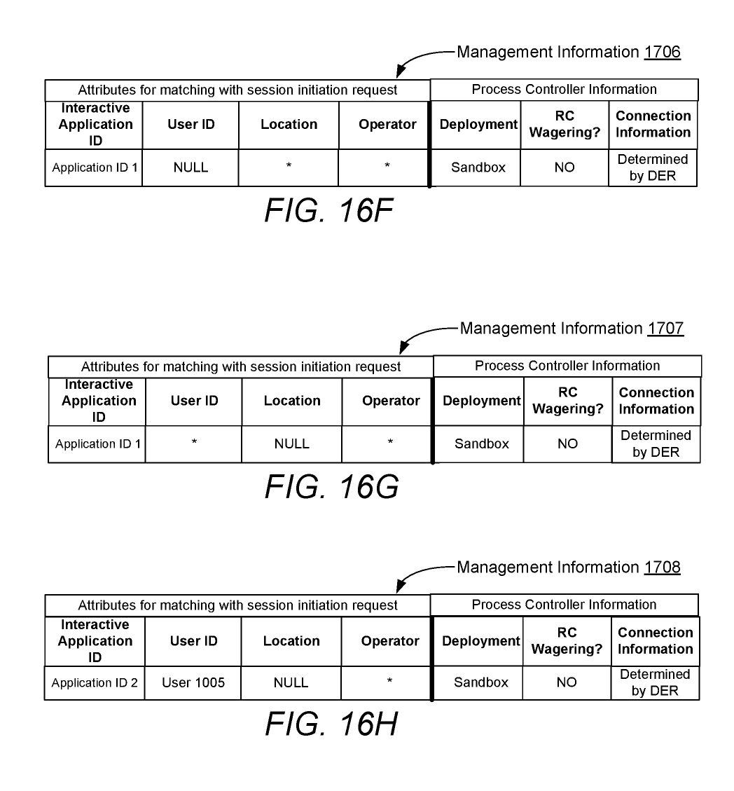

FIGS. 16A-H depict exemplary management information, namely application management information.

The DER Server 1255 stores each management information received from the operations server 1256 via the management interface provided by the management interface modules 1518 (of FIG. 14) and 1618 (of FIG. 15) as a management information entry in the storage medium 1570. More specifically, DER Server 1255 stores application management information entries in application management information 1517, and stores process controller management information entries in process controller management information 1520.

### Configuration of the DER Server: Process Controller Configuration

In the example embodiment, in connection with configuration of the DER Server 1255 for determination of a process controller to use for an interactive application session based on one or more process controller parameters, the operations server 1256 configures a pool of candidate process controllers from which the DER Server 1255 determines a process controller to use. In more detail, the process controller management module 1620 of the operations server 1256 provides the DER Server 1255 with management information to register one or more process controllers as part of the pool of candidate process controllers from which the DER Server 1255 determines a process controller to use. In the example embodiment, the management information for configuration of process controllers includes one or more process controller management information entries, and each process controller management information entry specifies at least: an interactive application ID; a deployment attribute (e.g., sandbox, staging, production); wagering support attribute which indicates whether the process controller is constructed to provide one or more of RC wagering and VC wagering for the interactive application identified by the interactive application ID; a location attribute; an operator attribute; and a process controller ID.

In the example embodiment, the location attribute includes one of a location wildcard value that matches any location ID (e.g., “*”), a Location ID, and a NULL value that indicates that a location ID has not been provided to the DER Server 1255 (e.g., “NULL”). In the example embodiment, the operator attribute includes one of an operator wildcard value that matches any operator ID (e.g., “*”), an operator ID, and a NULL value that indicates that an operator ID has not been provided to the DER Server 1255 (e.g., “NULL”).

In some embodiments, the process controller management information entries do not specify one or more of a location attribute, an operator attribute and a process controller ID.

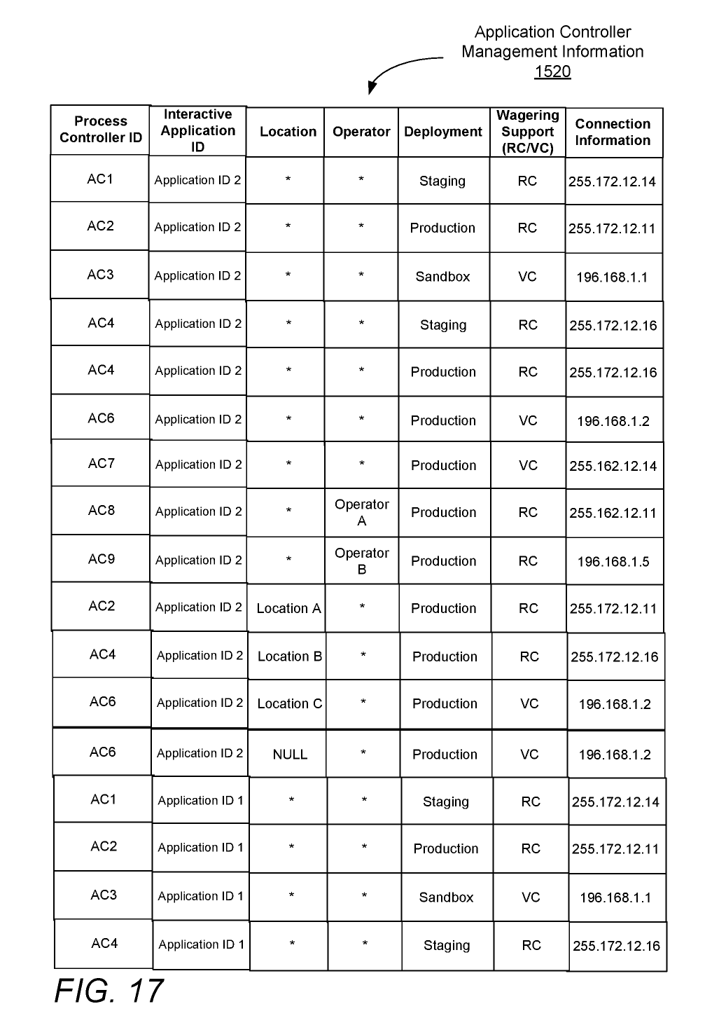

FIG. 17 depicts exemplary process controller management information 1520 for configuration of process controllers that includes seventeen (17) process controller configuration entries. As shown in FIG. 17, process controllers AC1, AC2, AC3, AC4, AC6, AC7, AC8 and AC9 are configured for use in a puzzle game interactive application session (Application ID 2) and process controllers AC1, AC2, AC3 and AC4 are configured for use in a shooter game interactive application session (Application ID 1). Accordingly, the process controllers AC1, AC2, AC3, and AC4 are considered to be “enabled” for use in Application 1 and Application 2 interactive application sessions, and the process controllers AC6, AC7, AC8 and AC9 are considered to be “enabled” for use in Application 2 interactive application sessions.

A process controller identified by the process controller ID AC5 (not shown) is not configured for use in any interactive application sessions. In the example embodiment, the process controller AC5 is considered “disabled” because the process controller management information 1520 does not include a process controller management information entry for the process controller AC5.

### Establishing a Session: Operation

As described herein, the DER Server 1255 is used to establish a dynamic endpoint resolution interleaved wagering system session between an interactive processing device (e.g., the interactive processing device 1171) and a process controller (e.g., one of the process controllers 1211, 1231 and 1241) for a specified interactive application (e.g., the interactive application 402 of FIG. 4A).

In the example embodiment, the interactive processing device 1171 provides a session initiation request to the DER Server 1255, and responsive to the session initiation request, a session management module (e.g., the session management module 1516 of FIG. 14) of the DER Server 1255 determines a process controller (e.g., one of the process controllers 1211, 1231 and 1241) to use for the session.

In the example embodiment, the DER Server 1255 determines the process controller based on management information (e.g., one or more of the application management information 1517 and the process controller management information 1520 of FIG. 14). In the example embodiment, the DER Server 1255 receives the management information from the operations server 1256 via a management interface (e.g., a management interface provided by the management interface module 1518 of FIG. 14). The DER server 1255 generates session information that identifies the determined process controller. The DER Server 1255 provides the generated session information to the interactive processing device 1171 and the determined process controller. In the example embodiment, the session information includes at least a session token and a process controller identifier that identifies the process controller. In the example embodiment, the process controller identifier includes one or more of a network address (e.g., an Internet Protocol address) and a Universal Resource Locator (URL). The interactive processing device 1001 uses the Universal Resource Locator (or network address) to establish communication with the process controller (identified by the process controller identifier included in the session information) and provides the process controller with a session establishment request to establish the session with the process controller. The session establishment request includes the session token. Responsive to a determination by the process controller that the session token received from the interactive processing device 1171 matches a session token received from the DER Server 1255, the process controller establishes a session with the interactive processing device 1171.

In the example embodiment, the DER Server 1255 also determines a patron management server (e.g., the patron management server 1176 of FIG. 11) for use in connection with the interactive application session, and provides connection information for establishment of communication with the patron management server to both of the interactive processing device 1171 and the determined process controller. By using the connection information for the patron management server, the interactive processing device 1171 and the determined process controller can each establish communication with the patron management server for the interactive application session.

FIG. 18 is a sequence diagram for a process of establishing a dynamic endpoint resolution interleaved wagering system session in accordance with embodiments of the invention. In some embodiments, the system includes an interactive processing device 1171, a DER server 1255, and a geolocation server 1918.

In various embodiments, communication of outgoing data between a controller and another controller is achieved by the controller encoding data to be communicated into a signal and transmitting the signal to the another controller. Communication of incoming data is achieved by the controller receiving from the another controller signals encoding the incoming data. The controller decodes the signals to obtain the incoming data.

In some such embodiments, two or more controllers implement a controller-to-controller communication protocol as an interdevice communication protocol so that the two or more controllers may be implemented on different processing devices. The interdevice communication protocol may utilize a wired communication bus or wireless connection as a physical layer. In yet other such embodiments, the controller-to-controller communication protocol is implemented as a networking protocol so that the two or more controllers may be implemented on different devices operatively connected by a network. The networking protocol may utilize a wired communication bus or wireless connection as a physical layer. In many such embodiments, the network includes a cellular telephone network or the like and one or more of the controllers is a mobile device such as a smartphone or other device capable of using the cellular telephone network.

In some embodiments, communication is achieved by two or more of the controllers implementing a controller-to-controller communication protocol as an interprocess communication protocol so that the two or more controllers may be implemented on the same device.

The interactive processing device 1171 communicates, to the DER server 1255, session initiation request data (1901). In some embodiments, an application control layer (e.g., the application control layer 418 of FIG. 4A) of the interactive processing device 1171 communicates the session initiation request to the DER Server 1255 to request initiation of a dynamic endpoint resolution interleaved wagering system session with a process controller.

In the example embodiment, the application control layer of the interactive processing device 1171 includes the following information in the session initiation request data: an interactive application ID of the interactive application (e.g., the interactive application 402 of FIG. 4A) of the interactive processing device 1171; a user ID of a user of the interactive processing device 1171; location information of the interactive processing device 1171; and an operator ID of an operator of the interactive application.

In the example embodiment, the application control layer of the interactive processing device 1171 obtains one or more of information provided by a global positioning system (GPS) device (e.g., a GPS receiver, a GPS sensor, and the like) of the interactive processing device 1171, network data (e.g., wireless access point data) provided by a network device that is communicatively coupled to a communication interface device (e.g., the communication interface device 516 of FIG. 4B) of the interactive processing device 1171, and cellular tower location data received via the communication interface device of the interactive processing device 1171. The application control layer includes one of more of the GPS information, the network data and the cellular tower location data as the location information provided with the session initiation request data.

The DER Server 1255 receives, from the interactive processing device 1171, the session initiation request data (1901). The DER server communicates, to the geolocation server 1918, the location information included in the session initiation request data (1902). The geolocation server 1918 receives, from the DER server 1255, the location information (1902). The geolocation server 1918 determines a location ID that corresponds to the location information received from the DER Server 1255 (1903). The geolocation server 1918 communicates, to the DER Server 1255, determined location ID data (1904). The DER server 1255 receives, from the geolocation server 1918, the determined location ID data (1904).

The DER Server 1255 determines a process controller to use for the session requested in the session initiation request (1905). In the example embodiment, the DER Server 1255 determines a process controller to use based on an application management information entry (of the application management information 1517) that matches the information in the session initiation request. In the example embodiment, each application management information entry includes information for matching with information in the session initiation request (e.g., an interactive application ID, a User ID attribute, a location attribute, and an operator attribute), and process controller information for determining a process controller to use for the session requested in the session imitation request (e.g., a deployment attribute, an RC wagering attribute, and a connection information attribute).

In the example embodiment, the DER Server 1255 determines a management information entry (of the application management information 1517) that matches the information in the session initiation request. More specifically, in the example embodiment, the DER Server 1255 determines a management information entry that matches the location ID received from the geolocation server 1918 and the interactive application ID, the user ID, and the operator ID of the session initiation request. FIGS. 16A-H depict exemplary application management information that are stored as application management information entries of the application management information 1517.

In the example embodiment, a wildcard user value (e.g., “*”) of a management information entry matches any user ID, a wildcard location value (e.g., “*”) of a management information entry matches any Location ID, and a wildcard operator value (e.g., “*”) of a management information entry matches any operator ID. A NULL user value (e.g., “NULL”) of a management information entry matches a NULL User ID value in a case where the session initiation request does not provide a value for the user ID. A NULL location value (e.g., “NULL”) of a management information entry matches a NULL location information value in a case where the session initiation request does not provide a value for the location information. A NULL operator value (e.g., “NULL”) of a management information entry matches a NULL operator ID value in a case where the session initiation request does not provide a value for the operator ID.

In the example embodiment, a priority value is assigned to each of the User ID attribute, the Location ID attribute and the Operator ID attribute of the management information entries, and the DER Server 1255 determines a matching application management information entry based on the priority values of attributes.

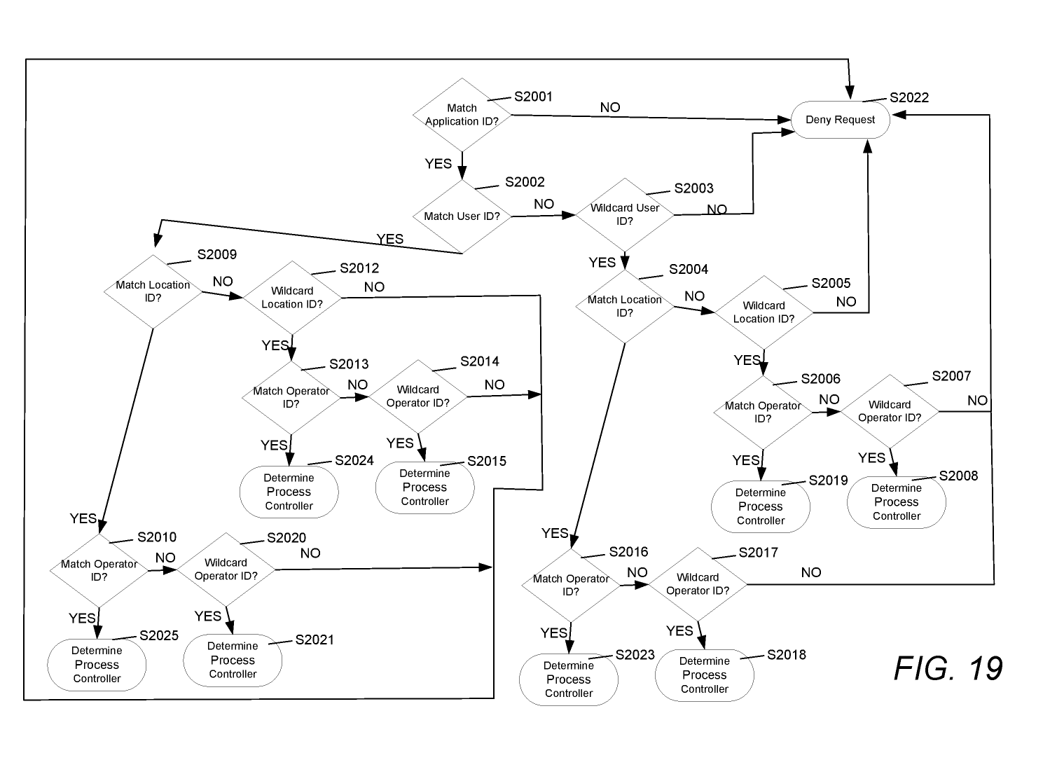

FIG. 19 depicts a flow diagram for a process of using the DER Server 1255 to determine a matching application management information entry in a case where the User ID attribute has the highest priority, the Location ID attribute has the next highest priority, and the operator ID attribute has the lowest priority.

In a case where the DER Server 1255 includes application management information entries corresponding to the application management information of each of FIGS. 16A-H and DER Server 1255 determines a matching application management information entry in accordance with the flow diagram of FIG. 19, Table 1 indicates the application management information (included in an application management information entry) that is used by the DER Server 1255 to determine a process controller to use for given session imitation request information (e.g., Interactive Application ID, User ID, Location, and Operator ID), in accordance with the example embodiment.

TABLE 1

| Information provided in the session initiation | | | | FIG. corresponding |
|---|---|---|---|---|
| request | | | | to application |
| Interactive | | | | management |
| Application | | Location | | information entry |
| ID | User ID | ID | Operator ID | to be used |
| Application | Not | Not | Not provided | FIG. 16F |
| ID 1 | provided | provided | | |
| Application | Any | Any | Any | FIG. 16A |
| ID 1 | User ID | Location | Operator ID | |
| Application | Not | Any | Any | FIG. 16F |
| ID 1 | provided | Location | Operator ID | |
| Application | Any | Not | Any | FIG. 16G |
| ID 1 | User ID | provided | Operator ID | |
| Application | Any | Any | Not provided | FIG. 16A |
| ID 1 | User ID | Location | | |
| Application | Any | Not | Not provided | FIG. 16G |
| ID 1 | User ID | provided | | |
| Application | Not | Not | Any | FIG. 16F |
| ID 1 | provided | provided | Operator ID | |
| Application | Not | Any | Not provided | FIG. 16F |
| ID 1 | provided | Location | | |
| Application | User | Location A | Operator A | FIG. 16C |
| ID 2 | 1005 | | | |
| Application | User | Any | Any | FIG. 16C |
| ID 2 | 1005 | Location | Operator ID | |
| Application | Any | Location A | Any | FIG. 16D |
| ID 2 | User ID | | Operator ID | |
| Application | Any | Any | Operator A | FIG. 16E |
| ID 2 | User ID | Location | | |
| Application | Any | Any | Any | FIG. 16B |
| ID 2 | User ID | Location | Operator ID | |
| Application | User | NULL | Any | FIG. 16H |
| ID 2 | 1005 | | Operator ID | |

Turning to FIG. 19, processing begins at process S2001.

At the process S2001, if the DER server 1255 determines that the application management information 1517 includes one or more application management information entries whose application ID value matches the application ID value provided in the session initiation request (“YES” at S2001), then the DER server 1255 includes all such matching application management information entries in a list of candidate management information entries, and processing proceeds to process S2002. If the DER server 1255 determines at the process S2001 that the application management information 1517 does not include any application management information entries whose application ID value matches the application ID value provided in the session initiation request (“NO” at S2001), then processing proceeds to process S2022.

At the process S2022, the DER server 1255 provides the interactive processing device 1171 with a notification indicating that the request to initiate a session is denied.

At the process S2002, if the DER server 1255 determines that the list of candidate management information entries does not include a management information entry whose User ID value matches the User ID value provided in the session initiation request (“NO” at S2002), then processing proceeds to process S2003. If the DER server 1255 determines at the process S2002 that the list of candidate management information entries does include a management information entry whose User ID value matches the User ID value provided in the session initiation request (“YES” at S2002), then the DER server 1255 retains all such management information entries in the list of candidate management information entries and removes from the list all management information entries that do not have a User ID value that matches the User ID value provided in the session initiation request, and thereafter processing proceeds to process S2009.

At the process S2003, if the DER server 1255 determines that the list of candidate management information entries includes one or more management information entries whose User ID attribute includes a wildcard value (“YES” at S2003), then the DER server 1255 retains all such management information entries in the list of candidate management information entries and removes from the list all management information entries that do not have a User ID wildcard value, and thereafter processing proceeds to process S2004. If the DER server 1255 determines that the list of candidate management information entries does not include any management information entries whose User ID attribute includes a wildcard value (“NO” at S2003), then processing proceeds to process S2022.

At the process S2004, if the DER server 1255 determines that the list of candidate management information entries does not include a management information entry whose Location ID value matches the Location ID value provided in the session initiation request (“NO” at S2004), then processing proceeds to process S2005. If the DER server 1255 determines that the list of candidate management information entries includes one or more management information entries whose Location ID value matches the Location ID value provided in the session initiation request (“YES” at S2004), then the DER server 1255 retains all such management information entries in the list of candidate management information entries and removes from the list all management information entries that do not have a Location ID value that matches the Location ID value provided in the session initiation request, and thereafter processing proceeds to process S2016.

At the process S2005, if the DER server 1255 determines that the list of candidate management information entries includes one or more management information entries whose Location ID attribute includes a wildcard value (“YES” at S2005), then the DER server 1255 retains all such management information entries in the list of candidate management information entries and removes from the list all management information entries that do not have a Location ID wildcard value, and thereafter processing proceeds to process S2006. If the DER server 1255 determines that the list of candidate management information entries does not include any management information entries whose Location ID attribute includes a wildcard value (“NO” at S2005), then processing proceeds to S2022.

At the process S2006, if the DER server 1255 determines that the list of candidate management information entries does not include a management information entry whose Operator ID value matches the Operator ID value provided in the session initiation request (“NO” at S2006), then processing proceeds to process S2007. If the DER server 1255 determines that the list of candidate management information entries does include a management information entry whose Operator ID value matches the Operator ID value provided in the session initiation request (“YES” at S2006), then processing proceeds to process S2019.

In the example embodiment, the DER server 1255 is configured to include application management information 1517 such that the process of determining an application management information entry that matches information provided in the session initiation request results in the determination of one management information entry.

Accordingly, at the process S2007, the DER server 1255 determines at most one matching management entry. If the DER server 1255 determines at the process S2007 that the list of candidate management information entries includes a management information entry whose Operator ID attribute includes a wildcard value (“YES” at S2007), then processing proceeds to process S2008. If the DER server 1255 determines at the process S2007 that the list of candidate management information entries does not include a management information entry whose Operator ID attribute includes a wildcard value (“NO” at S2007), then processing proceeds to process S2022.

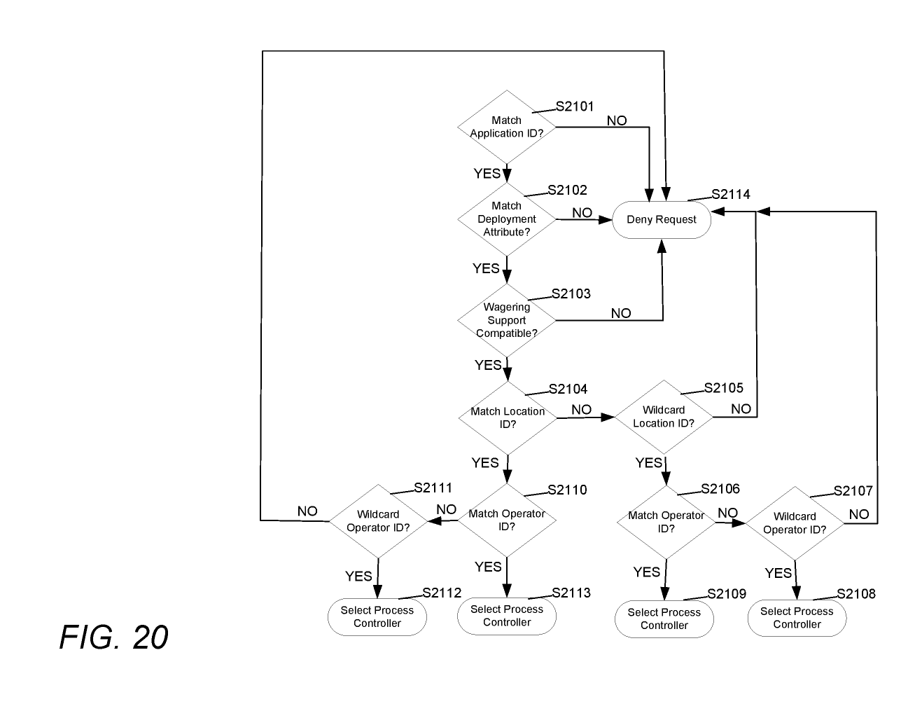

At the process S2008, the DER Server 1255 uses the application management information entry whose Operator ID attribute includes the wildcard value to determine a process controller, in accordance with the process described herein with respect to FIG. 20.

At the process S2008, the DER server 1255 has determined an application management information entry whose application ID value matches the application ID value provided in the session initiation request, and whose User ID, Location ID and Operator ID attributes include wildcard values (e.g., a management information entry corresponding to one of FIGS. 16A and 16B).

At the process S2019, the DER Server 1255 uses the application management information entry whose Operator ID value matches the Operator ID value provided in the session initiation request to determine a process controller, in accordance with the process described herein with respect to FIG. 20. As described herein, in the example embodiment, the DER server 1255 is configured to include application management information 1517 such that the process of determining an application management information entry that matches information provided in the session initiation request results in the determination of one management information entry. Accordingly, in the example embodiment, at the process S2019, the list of candidate management information entries includes one application management information entry, namely the entry whose Operator ID value matches the Operator ID value provided in the session initiation request.

At the process S2019, the DER server 1255 has determined an application management information entry whose application ID value and Operator ID value match the application ID value and the Operator ID value (respectively) provided in the session initiation request, and whose User ID and Location ID attributes include wildcard values (e.g., a management information entry corresponding to FIG. 16E).

At the process S2016, if the DER server 1255 determines that the list of candidate management information entries does not include a management information entry whose Operator ID value matches the Operator ID value provided in the session initiation request (“NO” at S2016), then processing proceeds to process S2017. If the DER server 1255 determines that the list of candidate management information entries does include a management information entry whose Operator ID value matches the Operator ID value provided in the session initiation request (“YES” at S2016), then processing proceeds to process S2023.

At the process S2017, the DER server 1255 determines at most one matching management entry. If the DER server 1255 determines at the process S2017 that the list of candidate management information entries includes a management information entry whose Operator ID attribute includes a wildcard value (“YES” at S2017), then processing proceeds to process S2018. If the DER server 1255 determines at the process S2017 that the list of candidate management information entries does not include a management information entry whose Operator ID attribute includes a wildcard value (“NO” at S2017), then processing proceeds to process S2022.

At the process S2018, the DER Server 1255 uses the application management information entry whose Operator ID attribute includes the wildcard value to determine a process controller, in accordance with the process described below with respect to FIG. 20. At the process S2018, the DER server 1255 has determined an application management information entry whose application ID value and Location ID value match the application ID value and location information (respectively) provided in the session initiation request, and whose User ID and Operator ID attributes include wildcard values (e.g., a management information entry corresponding to FIG. 16D).

At the process S2023, the DER Server 1255 uses the application management information entry whose Operator ID value matches the Operator ID value provided in the session initiation request to determine a process controller, in accordance with the process described below with respect to FIG. 20. At the process S2023, the DER server 1255 has determined an application management information entry whose application ID value, Location ID value and Operator ID value match the application ID value, location information, and the Operator ID value (respectively) provided in the session initiation request, and whose User ID attribute includes a wildcard value.

Process S2009 is similar to the process S2004, process S2012 is similar to the process S2005, process S2013 is similar to the process S2006, process S2014 is similar to the process S2007. Process S2010 is similar to the process S2016 and process S2020 is similar to the process S2017.

At process S2015, the DER server 1255 has determined an application management information entry whose application ID value and User ID value match the application ID value and User ID value (respectively) provided in the session initiation request, and whose Location ID and Operator ID attributes include wildcard values (e.g., a management information entry corresponding FIG. 16C).

At process S2024, the DER server 1255 has determined an application management information entry whose application ID value, User ID value and Operator ID value match the application ID value, User ID value and the Operator ID value (respectively) provided in the session initiation request, and whose Location ID attribute includes a wildcard value.

At process S2021, the DER server 1255 has determined an application management information entry whose application ID value, User ID value and Location ID value match the application ID value, User ID value and location information (respectively) provided in the session initiation request, and whose Operator ID attribute includes a wildcard value (e.g., a management information entry corresponding to FIG. 16H).

At process S2025, the DER server 1255 has determined an application management information entry whose application ID value, User ID value, Location ID value and Operator ID value match the application ID value, User ID value, location information, and the Operator ID value (respectively) provided in the session initiation request.

Reverting back to FIG. 18, after determining an application management information entry (of the application management information 1517) that matches the information in the session initiation request, the DER Server 1255 determines a process controller to use for the session requested in the session initiation request by using the determined application management information entry (1905). More specifically, the DER Server 1255 determines a process controller to use for the session requested in the session initiation request by using the process controller information included in the determined management information entry (e.g., a deployment attribute, an RC wagering attribute, and a connection information attribute).

In a case where the process controller information of the application management information entry being used specifies connection information (e.g., one or more of a network address and a Universal Resource Locator) for a process controller (e.g., a management information entry corresponding to the management information of FIG. 16A), the DER Server 1255 selects the process controller corresponding to the specified connection information for use in connection with the session requested in the session initiation request.

In a case where the process controller information of the management information entry being used does not specify connection information for a process controller (e.g., a management information entry corresponding to the management information of any of FIGS. 16B-H), the DER Server 1255 determines a process controller management information entry (included in the process controller management information 1520) that matches the application management information entry being used.

In the example embodiment, in determining a process controller management information entry (included in the process controller management information 1520) that matches the application management information entry being used, a priority value is assigned to each of the Application ID attribute, the deployment attribute, the RC wagering attribute, the Location ID attribute and the Operator ID attribute of the application management information entries, and the DER Server 1255 determines a matching process controller management information entry based on the priority values of the attributes.

FIG. 20 depicts a flow diagram for determining a matching process controller management information entry based on the priority values of the attributes in a case where the Application ID attribute has the highest priority, the deployment attribute has the second highest priority, the RC wagering attribute has the third highest priority, the Location ID attribute has the fourth highest priority, and the operator ID attribute has the lowest priority.

More specifically, in the example embodiment, the DER Server 1255 determines a process controller management information entry that matches the interactive application ID, the location ID, the operator ID, the deployment attribute, and the RC wagering attribute of the management information entry being used. FIG. 17 depicts exemplary process controller management information 1520 that includes a plurality of process controller management information entries of process controller management information 1520.

In the example embodiment, the DER server 1255 can be configured to include application management information 1517 and process controller management information 1520 such that the process of determining a process controller management information entry that matches the application management information entry being used results in the determination of more than one matching process controller management information entry. In the example embodiment, in a case where there is more than one process controller management information entry that matches the application management information entry being used, the DER Server 1255 selects one of the process controller management information entries based on resource usage of the process controllers corresponding to the process controller management information entries. In the example embodiment, the DER Server 1255 acquires resource usage information for the process controllers corresponding to the process controller management information entries from the operations server 1256. In the example embodiment, the resource usage information includes one or more of network traffic information, processor usage information, memory usage information, and storage usage information. In the example embodiment, the DER Server 1255 selects one of the process controller management information entries in accordance with a load balancing process based on network traffic information.

Turning to FIG. 20, processing begins at process S2101. At the process S2101, if the DER server 1255 determines that the process controller management information 1520 includes one or more process controller management information entries whose application ID value matches the application ID value of the application management information entry being used (e.g., the application management information entry selected at one of the processes S2008, S2019, S2018, S2023, S2015, S2024, S2021, S2025 of FIG. 19) (“YES” at S2101), then the DER server 1255 includes all such matching process controller management information entries in a list of candidate process controller management information entries, and processing proceeds to process S2102. If the DER server 1255 determines at the process S2001 that the application management information 1517 does not include any process controller management information entries whose application ID value matches the application ID value of the application management information entry being used (“NO” at S2101), then processing proceeds to process S2114.

At the process S2114, the DER server 1255 provides the interactive processing device 1171 with a notification indicating that the request to initiate a session is denied.

At process S2102, if the DER server 1255 determines that the list of candidate process controller management information entries does not include a process controller management information entry whose Deployment attribute matches the Deployment attribute specified in the application management information entry being used (“NO” at S2102), then processing proceeds to process S2114. If the DER server 1255 determines that the list of candidate process controller management information entries includes one or more process controller management information entries whose Deployment attribute matches the Deployment attribute specified in the application management information entry being used (“YES” at S2102), then the DER server 1255 retains all such process controller management information entries in the list of candidate process controller management information entries and removes from the list all process controller management information entries that do not have a Deployment attribute that matches the Deployment attribute specified in the application management information entry being used, and thereafter processing proceeds to process S2103.

At the process S2103, DER server 1255 determines whether the list of candidate process controller management information entries includes one or more process controller management information entries whose wagering support (e.g., one or more of RC and VC wagering support) is compatible with the RC wagering attribute specified in the application management information entry being used. In the example embodiment, a Virtual Credit (VC) wagering support value is compatible with an RC wagering attribute that specifies that RC wagering is not allowed (e.g., a “NO” value), and a Real Credit (VC) wagering support value is compatible with an RC wagering attribute that specifies that RC wagering is allowed (e.g., a “YES” value).

In some embodiments, a VC wagering support value and a Real Credit (RC) wagering support value are both compatible with an RC wagering attribute that specifies that RC wagering is allowed (e.g., a “YES” value).

If the DER server 1255 determines that the list of candidate process controller management information entries includes one or more process controller management information entries whose wagering support is compatible with the RC wagering attribute specified in the application management information entry being used (“YES” at S2103), then the DER server 1255 retains all such process controller management information entries in the list of candidate process controller management information entries and removes from the list all process controller management information entries that do not have compatible wagering support values, and thereafter processing proceeds to process S2104. If the DER server 1255 determines that the list of candidate process controller management information entries does not include any process controller management information entries whose wagering support is compatible (“NO” at S2103), then processing proceeds to process S2114.

At the process S2104, if the DER server 1255 determines that the list of candidate process controller management information entries does not include a process controller management information entry whose Location ID value matches the Location ID value specified in the application management information entry being used (“NO” at S2104), then processing proceeds to process S2105. If the DER server 1255 determines that the list of candidate process controller management information entries includes one or more process controller management information entries whose Location ID value matches the Location ID value specified in the application management information entry being used (“YES” at S2104), then the DER server 1255 retains all such process controller management information entries in the list of candidate process controller management information entries and removes from the list all process controller management information entries that do not have a Location ID value that matches the Location ID value specified in the application management information entry being used, and thereafter processing proceeds to process S2110.

At the process S2105, if the DER server 1255 determines that the list of candidate process controller management information entries includes one or more process controller management information entries whose Location ID attribute includes a wildcard value (“YES” at S2105), then the DER server 1255 retains all such process controller management information entries in the list of candidate process controller management information entries and removes from the list all process controller management information entries that do not have a Location ID wildcard value, and thereafter processing proceeds to process S2106. If the DER server 1255 determines that the list of candidate process controller management information entries does not include any process controller management information entries whose Location ID attribute includes a wildcard value (“NO” at S2105), then processing proceeds to S2114.

At the process S2106, if the DER server 1255 determines that the list of candidate process controller management information entries does not include a process controller management information entry whose Operator ID value matches the Operator ID value specified in the application management information entry being used (“NO” at S2106), then processing proceeds to process S2107. If the DER server 1255 determines that the list of candidate process controller management information entries does include a process controller management information entry whose Operator ID value matches the Operator ID value specified in the application management information entry being used (“YES” at S2106), then processing proceeds to process S2109.

At the process S2107, if the DER server 1255 determines that the list of candidate process controller management information entries includes one or more process controller management information entries whose Operator ID attribute includes a wildcard value (“YES” at S2107), then processing proceeds to process S2108. If the DER server 1255 determines at the process S2107 that the list of candidate process controller management information entries does not include any process controller management information entries whose Operator ID attribute includes a wildcard value (“NO” at S2107), then processing proceeds to process S2114.

At the process S2108, the DER Server 1255 selects one of the process controller management information entries form the list of candidate process controller management information entries, and uses the selected process controller management information entry to select a process controller to use for the requested interactive application session (requested at the process S1901 of FIG. 18). In the example embodiment, the DER Server 1255 selects the process controller associated with the selected process controller management information entry by including the Connection Information specified in the selected process controller management information entry in the session information generated at 1906 of FIG. 18 (which is described below in more detail).

As described herein, in the example embodiment, in a case where the list of candidate process controller management information entries includes more than one entry at the conclusion of the process of FIG. 20 (e.g., at one of the processes S2108, S2109, S2112 and S2113), the DER Server 1255 selects one of the process controller management information entries (from the list of candidate process controller management information entries) based on resource usage of the process controllers corresponding to the process controller management information entries. In the example embodiment, the DER Server 1255 acquires resource usage information for the process controllers corresponding to the process controller management information entries from the operations server 1256. In the example embodiment, the resource usage information includes one or more of network traffic information, processor usage information, memory usage information, and storage usage information. In the example embodiment, the DER Server 1255 selects one of the process controller management information entries in accordance with a load balancing process based on network traffic information.

At the process S2108, the DER server 1255 has selected a process controller management information entry whose application ID value, Deployment attribute value, and wagering support value match the application ID value, Deployment attribute value, and RC wagering value (respectively) specified in the application management information entry being used (e.g., the application management information entry selected at one of the processes S2008, S2019, S2018, S2023, S2015, S2024, S2021, S2025 of FIG. 19), and whose Location ID and Operator ID attributes include wildcard values.

At the process S2109, the DER Server 1255 selects one of the process controller management information entries form the list of candidate process controller management information entries, and uses the selected process controller management information entry to select a process controller to use for the requested interactive application session (requested at 1901 of FIG. 18).

At the process S2019, the DER server 1255 has selected a process controller management information entry whose application ID value, Deployment attribute value, wagering support value, and Operator ID value match the application ID value, Deployment attribute value, RC wagering value, and Operator ID value (respectively) specified in the application management information entry being used (e.g., the application management information entry selected at one of the processes S2008, S2019, S2018, S2023, S2015, S2024, S2021, S2025 of FIG. 19), and whose Location ID attribute includes a wildcard value.

The process S2110 is similar to the process S2106, and process S2111 is similar to the process S2107.

At the process S2112, the DER Server 1255 selects one of the process controller management information entries form the list of candidate process controller management information entries, and uses the selected process controller management information entry to select a process controller to use for the requested interactive application session (requested at 1901 of FIG. 18).

At the process S2112, the DER server 1255 has selected a process controller management information entry whose application ID value, Deployment attribute value, wagering support value, and Location ID value match the application ID value, Deployment attribute value, RC wagering value, and Location ID value (respectively) specified in the application management information entry being used (e.g., the application management information entry selected at one of the processes S2008, S2019, S2018, S2023, S2015, S2024, S2021, S2025 of FIG. 19), and whose Operator ID attribute includes a wildcard value.

At the process S2113, the DER Server 1255 selects one of the process controller management information entries form the list of candidate process controller management information entries, and uses the selected process controller management information entry to select a process controller to use for the requested interactive application session (requested at 1901 of FIG. 18).

At the process S2113, the DER server 1255 has selected a process controller management information entry whose application ID value, Deployment attribute value, wagering support value, Operator ID value, and Location ID value match the application ID value, Deployment attribute value, RC wagering value, Operator ID value, and Location ID value (respectively) specified in the application management information entry being used (e.g., the application management information entry selected at one of the processes S2008, S2019, S2018, S2023, S2015, S2024, S2021, S2025 of FIG. 19).

Reverting to FIG. 18, having determined a process controller to use for the session requested in the session initiation request, the DER Server 1255 uses the session management module 1516 to generate session information (1906).

In the example embodiment, the generated session information includes connection information for the determined process controller, a session token that uniquely identifies the session, and the deployment attribute value and the RC wagering attribute value included in the matching management information entry. In some embodiments, the session information does not include the deployment attribute value and the RC wagering attribute value included in the matching management information entry. In some embodiments, the session information includes one or more of the interactive application ID, User ID attribute, Location attribute, and Operator attribute specified in the session initiation request, the deployment attribute value and the RC wagering attribute value included in the matching management information entry.

In a case where the process controller information of the selected application management information entry (selected at one of the processes S2008, S2019, S2018, S2023, S2015, S2024, S2021, S2025 of FIG. 19) specifies process controller connection information (e.g., an application management information entry corresponding to the application management information of FIG. 16A), the DER Server 1255 includes the process controller connection information in the generated session information.

In a case where the process controller information of the selected application management information entry does not specify connection information for a process controller (e.g., an application management information entry corresponding to the application management information of any of FIGS. 16B-H) and the DER Server determines a process controller based on the process controller management information 1520 of FIG. 17, the DER Server 1255 includes the process controller connection information that is specified in the selected process controller management information entry (e.g., selected at one of processes S2108, S2109, S2112 and S2113 of FIG. 20) in the generated session information.

In the example embodiment, the DER Server 1255 stores the generated session information in the active session database 1519 of the DERS Server 1255 in association with the interactive application ID, User ID attribute, Location information, and Operator attribute specified in the session initiation request. In the example embodiment, the generated session information and the associated information of the session initiation request are stored in the active session database 1519 as an active session entry.

The DER Server 1255 communicates, to the determined process controller (e.g., the process controller 1211), the generated session information, via a DER server interface (e.g., the server interface 165 of FIG. 1A) (1907). In the example embodiment, the process controller stores the session information as a session information entry in a storage medium (e.g., in session information 1116 of the storage medium 1110 of FIG. 7A). The determined process controller receives, from the DER server 1255, the generated session information (1907).

The DER Server 1255 communicates the generated session information to the application control layer (e.g., the application control layer 418 of FIG. 4A) of the interactive processing device (e.g., the interactive processing device 1171) that provided the session initiation request data (1908). In the example embodiment, the application control layer stores the session information as a session information entry in a storage medium. The interactive processing device 1171 receives, from the DER server 1255, the generated session information (1908).

The application control layer (e.g., the application control layer 418 of FIG. 4A) of the 1171 interactive processing device 1171 communicates, to the process controller 1211 identified in the session information, session establishment request data to establish a dynamic endpoint resolution interleaved wagering system session with the process controller (1909). In the example embodiment, the session establishment request includes the session token included in the generated session information. The process controller 1211 receives the session establishment request from the interactive processing device 1171 (1909).

A session establishment module of the process controller 1211 determines whether the session token received from the interactive processing device 1171 matches a session token received by the process controller 1211 from the DER Server 1255 (e.g., the session token included in the session information received by the process controller 1211) (1910). In some embodiments, the process controller 1211 compares the session token received from the interactive processing device 1171 with the session tokens included in session information entries stored by the process controller 1211 to determine a match.

In the example embodiment, in a case where the process controller 1211 determines that the session token received from the interactive processing device 1211 does not match a session token received by the process controller 1211, then the process controller 1211 communicates, to the application control layer (e.g., the application control layer 418 of FIG. 4A) of the interactive processing device 1171, a message (via an interactive processing device interface, e.g., the interface 160 of FIG. 1A) indicating that the request to establish a session is denied.

The process controller 1211 determines that the session token received from the interactive processing device 1211 does match a session token received by the process controller 1211, and the process controller 1211 establishes dynamic endpoint resolution interleaved wagering system session with the interactive processing device 1171 via the application control layer (e.g., the application control layer 418 of FIG. 4A) of the interactive processing device 1171 (1911).

### —Disabling an Interactive Application Session—

In the example embodiment, the operations server 1256 is used to disable an interactive application session for a specified user and a specified interactive application. More specifically, the session management module 1616 of the operations server 1256 provides the DER Server 1255 with a Session Disable command to disable an interactive application session of a specified interactive application for a specified user. The Session Disable command specifies an interactive application ID (that identifies the specified interactive application) and a User ID attribute that identifies a user of the interactive application. Responsive to the Session Disable command, the DER Server 1255 updates the application management information 1517 to include an application management information entry for the specified interactive application (as identified by the Interactive Application ID attribute) such that the User ID attribute is set to the User ID specified in the Session Disable command, and such that the Deployment attribute is set to the sandbox attribute.

In the example embodiment, the DER Server 1255 also disables all active sessions of the specified interactive application for the specified User ID. More specifically, in the example embodiment, the DER Server 1255 queries the active session database 1519 for all active session entries of the specified interactive application for the specified User ID. For each active session entry of the specified interactive application for the specified User ID, the DER Server 1255 identifies the process controller being used for the active session represented by the active session entry, and sends the process controller a session disabled notification via a DER server interface of the process controller (e.g., 165 of FIG. 1A). The session disabled notification specifies the session token for the disabled session and an indication that the session is disabled. In the example embodiment, the DER server interface of each process controller receiving such a session disabled notification sends a session disabled notification to the interactive processing device corresponding to the session token included in the session disabled notification, removes the session token from the stored session information to indicate that the session associated with the session token is disabled, and stores any user state information for the disabled session in a user profile data store (e.g., the user profile data store 1175 of FIG. 11) by using the patron management server 1176.

Responsive to reception of a session disabled notification from a process controller, an interactive processing device sends a session initiation request to the DER Server 1255 to initiate a new session, as described above with respect to FIG. 18. In initiating a new session, the DER Server 1255 uses the updated application management information 1517 resulting from the processing of the Session Disable command received from the operations server 1256.

For example, in a case where an interactive application is in a production deployment state (e.g., configured as shown in FIG. 16B) and the Operations Serer 1256 provides the DER Server 1255 with a Session Disable command to disable the application for User ID 1005, the DER Server 1255 adds a management information entry to the application management information 1517 that specifies the Sudoku application ID in the Interactive Application ID attribute, specifies the User ID 1005 in the User ID attribute, and specifies the sandbox deployment state in the Deployment attribute (e.g., an application management information entry corresponding to FIG. 16C). The DER Server 1255 disables all active sessions of the application for User ID 1005 as described herein, and the application control layer (e.g., the application control layer 418 of FIG. 4A) of any interactive processing device whose application session is disabled provides a session initiation request to the DER Server 1255 initiate a new session, as described herein with respect to FIG. 18. In initiating a new session, the DER Server 1255 uses the updated application management information 1517 resulting from the processing of the Session Disable command received from the operations server 1256 to initiate a new application session for the user identified by User ID 1005 in the sandbox deployment state, thereby effectively disabling a production application session for User ID 1005.

### —Disabling all Sessions of an Interactive Application—

In the example embodiment, the operations server 1256 is used to disable all sessions of a specified interactive application. More specifically, the session management module 1616 of the operations server 1256 provides the DER Server 1255 with an Application Disable command to disable all interactive application sessions of a specified interactive application. The Application Disable command specifies an interactive application ID (that identifies the specified interactive application). Responsive to the Application Disable command, the DER Server 1255 updates the application management information 1517 to include a management information entry for the specified interactive application (as identified by the Interactive Application ID attribute) such that the Deployment attribute is set to the sandbox attribute, and such that the Location ID, Operator ID and User ID attributes each include wildcard values.

In the example embodiment, the DER Server 1255 also disables all active sessions of the specified interactive application. More specifically, in the example embodiment, the DER Server 1255 queries the active session database 1519 for all active session entries of the specified interactive application. For each active session entry of the specified interactive application, the DER Server 1255 identifies the process controller being used for the active session represented by the active session entry and sends the process controller a session disabled notification that specifies the session token for the disabled session and an indication that the session is disabled.

Each process controller receiving such a session disabled notification sends a session disabled notification to the interactive processing device corresponding to the session token included in the session disabled notification, removes the session token from the stored session information to indicate that the session associated with the session token is disabled, and stores any user state information for the disabled session in a user profile data store (e.g., the user profile data store 1175 of FIG. 11) by using the patron management server 1176.

Responsive to reception of a session disabled notification from a process controller, an interactive processing device sends a session initiation request to the DER Server 1255 initiate a new session, as described above with respect to FIG. 18. In initiating a new session, the DER Server 1255 uses the updated application management information 1517 resulting from the processing of the Application Disable command received from the operations server 1256.

For example, in a case where an application is in a production deployment state (e.g., configured as shown in FIG. 16B) and the operations server 1256 provides the DER Server 1255 with an Application Disable command to disable the application, the DER Server 1255 adds a management information entry to the application management information 1517 that specifies the application ID in the Interactive Application ID attribute, specifies a wildcard user ID value in the User ID attribute, specifies a wildcard Location ID value in the Location attribute, specifies a wildcard operator value in the Operator attribute, and specifies the sandbox deployment state in the Deployment attribute. The DER Server 1255 disables all active sessions of the application as described herein, and the application control layer (e.g., the application control layer 418 of FIG. 4A) of any interactive processing device whose application session is disabled provides a session initiation request to the DER Server 1255 initiate a new session, as described above with respect to FIG. 18. In initiating a new session, the DER Server 1255 uses the updated application management information 1517 resulting from the processing of the Application Disable command received from the operations server 1256 to initiate a new application session in the sandbox deployment state, thereby effectively disabling a production application session for any user.

### —Changing Deployment State of an Interactive Application—

In the example embodiment, the operations server 1256 is used to change a deployment state of an interactive application. More specifically, the session management module 1616 of the operations server 1256 provides the DER Server 1255 with a deployment update command to update a deployment state of a specified interactive application. The deployment update command specifies an interactive application ID (that identifies the specified interactive application) and a deployment attribute that indicates the updated deployment state of the interactive application (e.g., sandbox, staging, production). Responsive to the deployment update command, the DER Server 1255 updates the Deployment attribute in all application management information entries (in the application management information 1517) for the specified interactive application (as identified by the Interactive Application ID attribute) such that the Deployment attribute is set to the deployment attribute specified in the deployment update command. In the example embodiment, the DER Server 1255 also disables all active sessions for the specified interactive application. More specifically, in the example embodiment, the DER Server 1255 queries the active session database 1519 for all active session entries for the specified interactive application. For each active session entry for the specified interactive application, the DER Server 1255 identifies the process controller being used for the active session represented by the active session entry and sends the process controller a session disabled notification that specifies the session token for the disabled session and an indication that the session is disabled.

Each process controller receiving such a session disabled notification sends a session disabled notification to the interactive processing device corresponding to the session token included in the session disabled notification, removes the session token from the stored session information to indicate that the session associated with the session token is disabled, and stores any user state information for the disabled session in a user profile data store (e.g., the user profile data store 1175 of FIG. 11) by using the patron management server 1176.

Responsive to reception of a session disabled notification from a process controller, an interactive processing device sends a session initiation request to the DER Server 1255 initiate a new session, as described above with respect to FIG. 18. In initiating a new session, the DER Server 1255 uses the updated application management information 1517 resulting from the processing of the deployment update command received from the operations server 1256.

For example, in a case where an application is in a production deployment state (e.g., configured as shown in FIG. 16B) and the Operations Server 1256 provides the DER Server 1255 with a deployment update command to change the deployment state of the application to a sandbox deployment state, the DER Server 1255 updates the Deployment attribute of the application management information entry (e.g., application the management information entry corresponding to FIG. 16B) to indicate the sandbox deployment state. The DER Server 1255 disables all active sessions for the application as described herein, and the application control layer (e.g., the application control layer 418 of FIG. 4A) of any interactive processing device whose application session is disabled provides a session initiation request to the DER Server 1255 initiate a new session, as described above with respect to FIG. 18. In initiating a new session, the DER Server 1255 uses the updated application management information 1517 resulting from the processing of the deployment update command received from the operations server 1256 to initiate a new application session in the sandbox deployment state.

Similarly, in a case where the application is in the sandbox deployment state and the Operations Serer 1256 provides the DER Server 1255 with a deployment update command to change the deployment state of the application to a staging deployment state, the DER Server 1255 updates the Deployment attribute of the application management information entry to indicate the staging deployment state. The DER Server 1255 disables all active sessions for the application as described above, and the application control layer (e.g., the application control layer 418 of FIG. 4A) of any interactive processing device whose application session is disabled provides a session initiation request to the DER Server 1255 initiate a new session, as described above with respect to FIG. 18. In initiating a new session, the DER Server 1255 uses the updated application management information 1517 resulting from the processing of the deployment update command received from the operations server 1256 to initiate a new application session in the staging deployment state.

In a case where the application is in the staging deployment state and the Operations Serer 1256 provides the DER Server 1255 with a deployment update command to change the deployment state of the application to a production deployment state, the DER Server 1255 updates the Deployment attribute of the application management information entry to indicate the production deployment state. The DER Server 1255 disables all active sessions for the application as described above, and the application control layer (e.g., the application control layer 418 of FIG. 4A) of any interactive processing device whose application session is disabled provides a session initiation request to the DER Server 1255 initiate a new session, as described above with respect to FIG. 18. In initiating a new session, the DER Server 1255 uses the updated application management information 1517 resulting from the processing of the deployment update command received from the operations server 1256 to initiate a new application session in the production deployment state.

### —Disable a Process Controller—

In the example embodiment, the operations server 1256 is used to disable a process controller. More specifically, the process controller management module 1620 of the operations server 1256 provides the DER Server 1255 with a process controller disable command to disable a specified process controller. In the example embodiment, the process controller disable command specifies connection information for a process controller to be disabled. Responsive to the process controller disable command, the DER Server 1255 updates the process controller management information 1520 to remove all process controller management information entries for the specified process controller (as identified by the connection information attribute).

In the example embodiment, the DER Server 1255 also disables all active sessions of the specified process controller. More specifically, in the example embodiment, the DER Server 1255 sends the process controller a process controller disabled notification that indicates that the process controller is disabled. Responsive to the process controller disabled notification, the process controller sends a session disabled notification to each interactive processing device of an interactive application session that uses the process controller. The process controller stores any user state information for disabled sessions in a user profile data store (e.g., the user profile data store 1175 of FIG. 11) by using the patron management server 1176.

Responsive to reception of a session disabled notification from a process controller, an interactive processing device sends a session initiation request to the DER Server 1255 initiate a new session, as described above with respect to FIG. 18. In initiating a new session, the DER Server 1255 uses the updated process controller management information 1520 resulting from the processing of the process controller disable command received from the operations server 1256.

### —Segregate Interactive Application Based on Operator—

In the example embodiment, the operations server 1256 is used to segregate interactive applications based on operator. For example, a given interactive application may be exclusively provided by one operator. In the example embodiment, to segregate an interactive application, the process controller management module 1620 of the operations server 1256 provides the DER Server 1255 with a process controller Configuration command to remove all process controller management information entries (from the process controller management information 1520) whose interactive application ID matches an interactive application ID specified in the process controller configuration command, and to add one or more process controller management information entries that specify connection information for a process controller of the operator that is to provide the interactive application.

In the example embodiment, the DER Server 1255 also disables all active sessions of the specified interactive application, as described above.

### —New Session Information Based on Change of Location of an Interactive Processing Device—

In the example embodiment, the application control layer (e.g., the application control layer 418 of FIG. 4A) of the interactive processing device 1171 continuously sends the location information of the interactive processing device 1171 to the process controller being used in the session. As described above, in the example embodiment, the location information includes information provided by a global positioning system (GPS) device (e.g., a GPS receiver, a GPS sensor, and the like) of the interactive processing device 1171, network data (e.g., wireless access point data) provided by a network device that is communicatively coupled to a communication interface device (e.g., the communication interface device 516 of FIG. 4B) of the interactive processing device 1171, and cellular tower location data received via the communication interface device of the interactive processing device 1171.

In some embodiments, the application control layer of the interactive processing device 1171 sends the location information of the interactive processing device 1171 to the process controller periodically. In some embodiments, the application control layer of the interactive processing device 1171 sends the location information of the interactive processing device 1171 to the process controller in a case where the application control layer of the interactive processing device 1171 determines that the location of interactive processing device 1171 has moved a predetermined distance.

In the example embodiment, the process controller receives the location information of the interactive processing device 1171 and uses the received location information to determine whether the interactive processing device 1171 has moved into a new jurisdiction. In an embodiment, the process controller determines the change of jurisdiction by using the geolocation server 1918 (of FIG. 18).

In a case where the process controller determines (based on the location information received from the interactive processing device 1171) that the interactive processing device 1171 has moved into a new jurisdiction, the process controller disables the session with the interactive processing device 1171 by sending a session disabled notification to the interactive processing device 1171 and removing the session token from the stored session information to indicate that the session associated with the session token is disabled. The process controller stores any user state information for the disabled session in a user profile data store (e.g., the user profile data store 1175 of FIG. 11) by using the patron management server 1176.

Responsive to reception of a session disabled notification from the process controller, the interactive processing device 1171 sends a session initiation request with the updated location information of the interactive processing device 1171 to the DER Server 1255 to initiate a new session, as described above with respect to FIG. 18. In initiating a new session, the DER Server 1255 uses the updated location information of the interactive processing device 1171.

### —Load Balancing—

In the example embodiment, the DER Server 1255 is used to monitor network load by interactive application ID (by using the operations server 1256), and update process controller management information entries (from the process controller management information 1520) to balance the network load of the interactive applications across multiple process controllers.

In the example embodiment, the DER Server 1255 acquires network load information for each interactive application ID and resource usage information for the process controllers corresponding to each of the process controller management information entries from the operations server 1256 (via the management interface provided by the management interface module 1518). The resource usage information includes one or more of network traffic information, processor usage information, memory usage information, and storage usage information. In the example embodiment, the DER Server 1255 determines whether to update the process controller management information 1520 to redistribute the network load of each interactive application across the process controllers identified in the process controller management information 1520.

For example, in a case where the an application identified in the process controller management information 1520 (of FIG. 17) has an increased network load, the DER Server 1255 increases the number of process controllers included in the pool of candidate process controllers for the application by adding additional process controller management information entries each identifying the application and including connection information for a process controller that has been added to the pool of candidate process controllers for the application.

In the example embodiment, the DER Server 1255 also disables all active sessions of each interactive application that has been affected by the load balancing configuration changes.

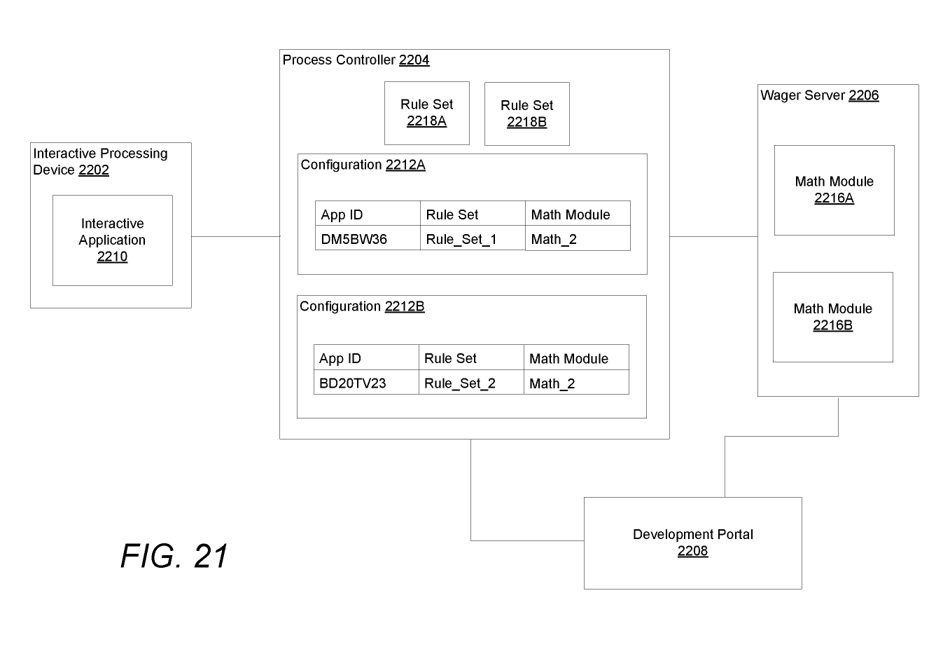

FIG. 21 illustrates a diagram of an exemplary system in accordance with various embodiments of the invention. The system includes an interactive processing device 2202, an interactive application 2210 to be executed by the interactive processing device 2202, a process controller 2204, a wager server 2206, and a development portal 2208. Each of the components may be accessible to each other over a network.

The interactive application 2210 may receive feedback from other components of the system. In an example embodiment, the interactive application 2210 may receive error information from a component of the system describing an error encountered by the component. A developer may use the error information received by the interactive processing device 2202 in making adjustments to the interactive application 2210. In another example embodiment, the interactive processing device 2202 may receive metadata describing the outcome of a process executed by a particular component. By receiving this metadata describing the outcome of the process, the interactive processing device 2202 does not have to analyze the outcome in order to generate the information contained in the metadata. In this way, computing system resources may be conserved and latency may be reduced. Feedback from components of the system may be used not only during operation of the application, but also during development of the interactive application 2210.

In some embodiments, a developer creating an interactive application 2210 to be executed by an interactive processing device 2202 may use the development portal 2208 during development of the interactive application 2210 to access the wager server 2206 in order to determine which math module the developer would like to use for their interactive application 2210. One or more math modules may be included in the wager server 2206 and each math module may be configured to output different wagering results. In some cases, a particular math module may be better suited for an application than another math module is, based on the output of the particular math module. In an example embodiment, a first math module may output a series of numbers and a second math module may output a series of symbols arranged in a particular manner. The developer may choose to use the first math module based on the requirements of the application being developed.

Each math module may also output wager telemetry in addition to wager results. In some embodiments, the wager telemetry corresponding to a wager outcome describes the wager outcome. In an example embodiment, the wager telemetry may indicate whether the wager outcome is a winning outcome. Further, the wager telemetry may provide information associated with the winning outcome. In an example embodiment, if the winning outcome is a result of achieving a particular pattern of symbols, the wager telemetry may include the shape of the pattern associated with the winning outcome.

In another example embodiment, the wager telemetry may indicate whether the wager outcome is a losing outcome, but was close to a win. Whether a losing outcome was close to a win may be determined by comparing the losing results to a winning result and determining whether the losing result was within a predetermined threshold of the winning result. In an example embodiment, if a losing wager result returns the numbers 4, 8, 15, 16, 23, 30 and the winning result is 4, 8, 15, 16, 23, 42, and the threshold for determining a close loss is coming within at least 12 of a winning result, then the wagering telemetry may indicate that the result was a loss, but was close to a win. The type of wager telemetry provided by the math module may vary from one math module to another, and the developer may choose a particular math module based on the particular math module's wager telemetry.

The developer, through the development portal 2208, may request from the wager server 2206, identification of the math modules 2216A, 2216B included in the wager server 2206. The wager server 2206 may send a list of math modules, and the developer may request information associated with each math module, such as telemetry data of a particular math module. The telemetry data of a particular math module may indicate the type of telemetry that can be obtained from the math module as well as the format of the telemetry. Alternatively, upon receiving a request for math module information from the development portal 2208, the wager server 2206 may send the list of math modules along with information associated with each math module.

A developer creating an application to be executed by an interactive processing device 2202 may also use the development portal 2208 during development of the application to access the process controller 2204 in order to determine which rule set 2218A, 2218B the developer would like to use for their application. The process controller 2204 may include more than one rule set. Each rule set may be configured to determine when a wager is triggered and may be configured to generate application resources based on the wager result.

In an example embodiment, a first rule set may trigger a wager when it receives a particular application telemetry, but a second rule set may not trigger a wager when it receives the same particular application telemetry. In another example, a first rule set may generate 100 units of application resources upon receiving a particular winning wager outcome from the wager server 2206, but a second rule set may generate a different number of units of application resources upon receiving the particular winning wager outcome.

Once a rule set and a math module are chosen for an application, a configuration is stored indicating an application identification associated with the application and an indication of the chosen rule set and math module. The application identification indicates the identity of the application executed by the interactive processing device 2202. In some embodiments, the application identification is a series of numbers, letters, symbols, or any combination thereof. In some embodiments, the application identification is a globally unique identification across all applications. In some embodiments, the application identification is a unique identification within a system. The application identification may be generated by the interactive processing device 2202, by the process controller 2204, or by a remote server accessible over a network.

The configurations 2212A, 2212B displayed in FIG. 21 are exemplary application configurations. Each of the configurations stores an application identification and an associated rule set and math module. If a particular application has an application identification of DM5BW36, the process controller 2204 uses Rule_Set_1 and Math_2 as the rule set and math module, respectively. That is, determination of whether a wager is triggered will be determined by Rule_Set_1, wagers are sent to Math_2 for wager outcomes and generation of application resources is accomplished by Rule_Set_1.

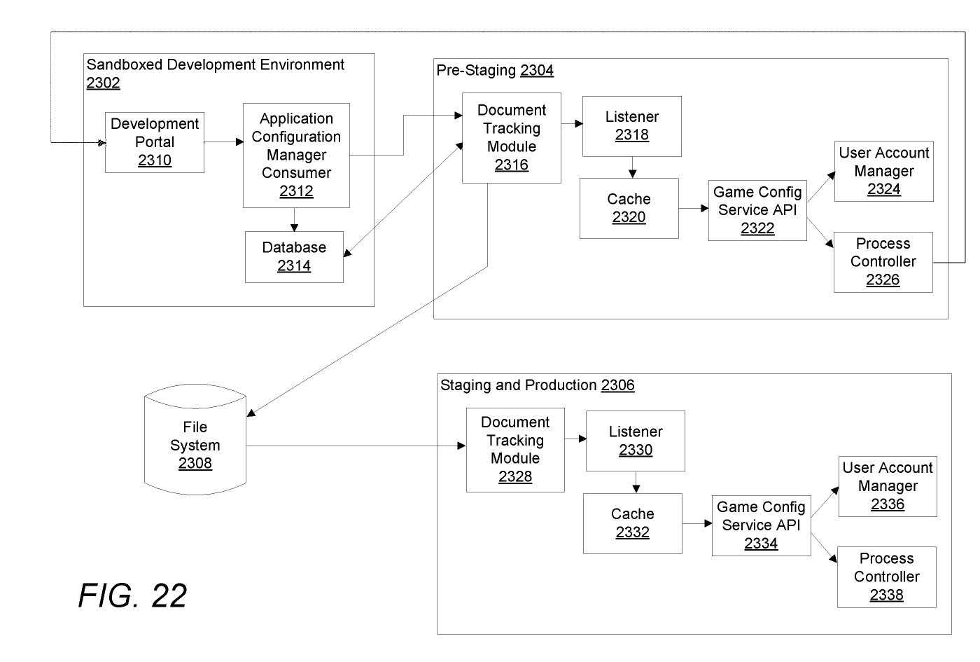

FIG. 22 illustrates a diagram of an exemplary system according to various embodiments of the invention. An application developer may develop an application within a sandboxed development environment 2302. The application developer may utilize a development portal 2310 to access components of the exemplary system in a pre-staging environment. An application configuration manager consumer 2312 accesses a configuration database 2314 local to the sandboxed development environment 2302. Within the sandboxed development environment 2302, the developer of the application may configure settings associated with the application and store the settings in the sandboxed configuration database 2314. Settings associated with the application include, for example, the name of the application, the process controller rule set the application uses, and the wager server math module the application uses.

The application configuration manager consumer communicates application configuration data to a document tracking module 2316 of a pre-staging environment 2304. In some embodiments, the application configuration data is communicated over a network. The sandboxed configuration database 2314 may update the document tracking module 2316, and the document tracking module 2316 may also update the sandboxed configuration database 2302. In some embodiments, the updating may occur in predetermined intervals. In some embodiments, the document tracking module 2316 includes configuration data for multiple applications, including the application being developed. The pre-staging environment 2304 may be utilized by the developer to observe the results of applying particular configuration settings.

The pre-staging document tracking module 2316 receives application configuration settings and notifies a listener 2318. The document tracking module 2316 also communicates the received configuration settings to the listener 2318. Upon receiving a notification from the document tracking module 2316, the listener 2318 passes the received configuration settings to a cache 2320. The developer may use the game configuration service API 2322, process controller 2326, and user account manager 2324 to test the application using the received configuration settings.

After testing the application under the configuration settings, the developer may change some of the configuration settings. If the developer changes some or all of the configuration settings, the changes are reflected in the sandboxed database 2314 and the document tracking module 2316.

When the configuration settings are finalized, the document tracking module 2316 in the pre-staging environment 2304 communicates the application configuration to the file system 2308. The file system 2308 stores configuration data associated with an application identifier. In some embodiments, the file system 2308 stores configuration data for multiple applications. A document tracking module 2328 within a staging and production environment 2306 may access the file system 2308 and retrieve configuration data associated with an application identifier. Once the configuration data is retrieved, the application may be executed.

The configuration data may be examined and subject to approval by a third party. When the third party approves the configuration data, a checksum function may be applied to the configuration data and the resulting checksum may be stored. The third party may later perform the same checksum on configuration data accessed in the staging and production environment and verify that the same configuration data is being used by comparing the presently generated checksum with the stored checksum. In this way, implementing the file system as a remote database accessible by a network allows for more convenient review by a third party.

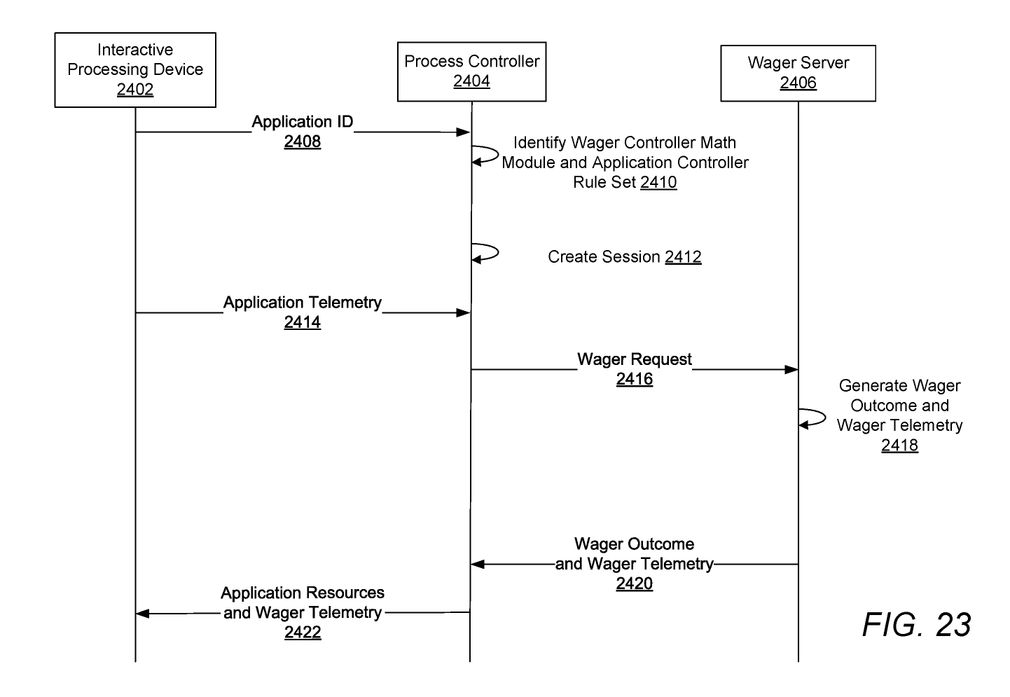

FIG. 23 illustrates an exemplary process for application feedback in a dynamic endpoint resolution interleaved wagering system based on wagering outcome, according to various embodiments of the invention.

In various embodiments, communication of outgoing data between a controller and another controller is achieved by the controller encoding data to be communicated into a signal and transmitting the signal to the another controller. Communication of incoming data is achieved by the controller receiving from the another controller signals encoding the incoming data. The controller decodes the signals to obtain the incoming data.

In some such embodiments, two or more controllers implement a controller-to-controller communication protocol as an interdevice communication protocol so that the two or more controllers may be implemented on different processing devices. The interdevice communication protocol may utilize a wired communication bus or wireless connection as a physical layer. In yet other such embodiments, the controller-to-controller communication protocol is implemented as a networking protocol so that the two or more controllers may be implemented on different devices operatively connected by a network. The networking protocol may utilize a wired communication bus or wireless connection as a physical layer. In many such embodiments, the network includes a cellular telephone network or the like and one or more of the controllers is a mobile device such as a smartphone or other device capable of using the cellular telephone network.

In some embodiments, communication is achieved by two or more of the controllers implementing a controller-to-controller communication protocol as an interprocess communication protocol so that the two or more controllers may be implemented on the same device.

The system includes an interactive processing device 2402, a process controller 2404, and a wager server 2406. In some embodiments, the interactive processing device 2402 provides an interactive application. In some embodiments, the interactive application is an interactive game. In some embodiments, the interactive game is a skill-based game. In some embodiments, the interactive game is a chance-based game.

In some embodiments, the interactive processing device 2402, the process controller 2404, and the wager server 2406 are separated into different components in order to distribute computing responsibilities to provide improved latency results. In some embodiments, the interactive processing device 2402 dedicates its resources toward providing the interactive application, and may be unable to perform the additional processing performed by the process controller 2404 without sacrificing latency.

During operation, in various embodiments, the interactive processing device 2402 is constructed to provide an interactive application display associated with an interactive application provided by the interactive processing device 2402.

The interactive processing device 2402 communicates, to a process controller 2404, application identification data (2408). As described herein, the application identification data indicates the identity of an application executed by the interactive processing device 2402.

The process controller 2404 receives, from the interactive processing device 2402, the application identification (2408) and identifies a wager server math module and process controller rule set based on the application identification (2410). In some embodiments, the association between the application identification and the wager server math module and process controller rule set is stored in a lookup table, indexed by application identification. The lookup table may be stored locally or stored remotely on a server (not shown) and accessed via a network.

The process controller 2404 creates a session based on the identified wager server math module and the identified process controller rule set (2412). Whether the application telemetry received from the interactive processing device 2402 triggers a wager request is based on the process controller rule set. In an example embodiment, the rule set may contain a table of events that may be received from the interactive processing device 2402 that will trigger an indication being communicated to the wager server 2406 to execute a wager. As described herein, the math module outputs a wager outcome based on a wager request.

The interactive processing device 2402 communicates, to the process controller 2404, application telemetry data (2414). In some embodiments, the application telemetry data includes, but is not limited to, interactions and events that occur in the interactive application as executed by the interactive processing device 2402. In some embodiments, the interactive processing device 2402 is constructed to continuously generate and communicate the application telemetry data associated with the interactive application.

In some embodiments, the application telemetry data follows an application telemetry data protocol. In some embodiments, the application telemetry data protocol comprises an account identification. In some embodiments, the application telemetry protocol includes an identification of the interactive application. In some embodiments, the application telemetry data protocol includes an action or event occurring in the interactive application. In some embodiments, the application telemetry data protocol includes application telemetry data encoded as a string. In some embodiments, the application telemetry data protocol includes application telemetry data encoded as an array of the elements making up the application telemetry data. In some embodiments, the application telemetry protocol includes application telemetry data formatted as a concatenation of data of elements making up the application telemetry data.

The process controller 2404 receives, from the interactive processing device 2402, the application telemetry data (2414). In some embodiments, the process controller 2404 is constructed to continuously monitor the interactive processing device 2402 for the application telemetry data.

The process controller 2404 scans the application telemetry data to determine whether to trigger a wager request. In some embodiments, the process controller 2404 determines whether to trigger wager by parsing the application telemetry data into elements; matching each element to a table of elements that trigger a wager request; and when an element of the application telemetry data is present in the table, determine that a wager request should be triggered.

In some embodiments, whether a received application telemetry triggers a wager request is based on the process controller 2404 rule set. In some embodiments, not all received application telemetry triggers a wager request. In an example embodiment, if the application telemetry includes discovering an item in a game and the process controller rule set indicates that a wager request should be triggered if the item is discovered, a wager request is communicated to the wager server 2406. In another example embodiment, if the application telemetry includes accessing a website on a web browser, and the process controller rule set indicates that a wager request should be triggered if the website is accessed, a wager request is communicated to the wager server 2406.

When a wager request is triggered, the process controller 2404 generates wager request data and commands the wager server 2406 by communicating the wager request data to the wager server 2406 (2416). In some embodiments, the wager request data follows a wager request protocol. In some embodiments, the wager request protocol includes an account identification. In some embodiments, the wager request protocol includes an identification of the interactive application. In some embodiments, the wager request protocol includes a wager amount. In some embodiments, the wager request protocol includes a paytable and/or wagering mechanic. In some embodiments, data encoded in accordance with the wager request protocol is formatted as a string. In some embodiments, data encoded in accordance with the wager request protocol is formatted as an array of the elements making up the wager request data. In some embodiments, data encoded in accordance with the wager request protocol is formatted as a concatenation of the data of elements making up the wager request data.

The wager server 2406 receives, from the process controller 2404, the wager request data (2416). In some embodiments, the wager server 2406 is constructed to continuously monitor the application controller for communication of the wager request data.

The wager server 2406, in response to receiving the wager request data, automatically determines a wager outcome based on the wager request data (2418).

The wager server 2406 communicates the wager outcome data and wager telemetry to the process controller 2404 (2420). The process controller 2404 receives, from the wager server 2406, the wager outcome data and wager telemetry, as described herein (2420). In an example embodiment, the wager outcome may be a losing outcome and the wager telemetry may include how close the wager outcome was to a winning outcome.

In response to receiving the data, the process controller 2404 scans the wager outcome data and also automatically determines application resource data based on the wager outcome data. The process controller 2404 commands the interactive processing device 2402 by communicating wagering telemetry data and the application resource data to the interactive processing device 2402 (2422).

The process controller 2404 uses the identified process controller rule set in order to determine application resources to be generated and communicated to the interactive processing device 2402. In an example embodiment, the process controller 2404 may receive a losing outcome. The process controller 2404 may access the process controller rule set, and based on the process controller rule set, not generate application resources to send to the interactive processing device 2402. In another example embodiment, the process controller 2404 may receive a winning outcome and generate a particular amount of application resources to send to the interactive processing device 2402, based on the rule set. In another example embodiment, the process controller 2404 may receive a losing outcome, but may still generate application resources to send to the interactive processing device 2402 if the process controller 2404 rule set indicates that this particular losing outcome results in generation of application resources.

The interactive processing device 2402 receives, from the process controller 2404, the wagering telemetry data and the application resource data (2422). In response to receiving the wagering telemetry data, the interactive processing device 2402 automatically configures a wagering user interface using the wagering telemetry data as described herein. The interactive processing device 2402 also automatically incorporates the application resource data into the interactive application as described herein, thus affecting the interactive application. In some embodiments, the interactive processing device 2402 receives, from the process controller 2404, an application resource display signal associated with the application resource awarded based on the application telemetry. In some embodiments, the interactive processing device 2402 displays the application resource based on the application resource signal. In some embodiments, the interactive processing device 2402 automatically configures the interactive application display based on the application resource signal.

While the above description may include many specific embodiments of the invention, these should not be construed as limitations on the scope of the invention, but rather as examples of embodiments thereof. It is therefore to be understood that the present invention can be practiced otherwise than specifically described, without departing from the scope and spirit of the present invention. Thus, embodiments of the present invention described herein should be considered in all respects as illustrative and not restrictive.

What is claimed:

1. A dynamic endpoint resolution wagering system, comprising:
an interactive processing device constructed to:
communicate, to a dynamic endpoint resolution (DER) server, session initiation request data comprising location information;
receive, from the DER server, session information; and
communicate, to a process controller, session establishment request data to establish a session of an interactive application with the process controller, the session establishment request data comprising a session token that uniquely identifies the session;
the process controller constructed to:
receive, from the DER server, the session information;
receive, from the interactive processing device, the session establishment request data;
determine whether the session token received from the interactive processing device matches a session token received from the DER server;
determine that the session token received from the interactive processing device matches the session token received from the DER server; and
establish the session with the interactive processing device via an application control layer of the interactive processing device;
and
the DER server operatively connecting the interactive processing device and the process controller, the DER server constructed to:
receive, from the interactive processing device, the session initiation request data;
communicate, to a geolocation server, the location information of the session initiation request data;
receive, from the geolocation server, location ID data determined based on the location information;
determine a management information entry based on the session initiation request data;
determine a process controller to use for the session requested in the session initiation request based on the determined management information entry;
generate session information, the session information comprising connection information for the process controller, the session token, and a deployment attribute value and a real currency credit wagering attribute value included in the management information entry;
store the session information in an active session database in association with the session initiation request data;
communicate, to the process controller, the session information; and
communicate, to the interactive processing device, the session information.

2. The dynamic endpoint resolution wagering system of claim 1,
wherein the interactive processing device and the process controller are constructed from the same device, and
wherein the process controller is operatively connected to the DER server using a communication link.

3. The dynamic endpoint resolution wagering system of claim 1,
wherein the DER server and the process controller are constructed from the same device, and
wherein the process controller is operatively connected to the interactive processing device using a communication link.

4. The dynamic endpoint resolution wagering system of claim 1, wherein the session initiation request data comprises: an interactive application identification of the interactive application of the interactive processing device; a user identification of a user of the interactive processing device; location information of the interactive processing device; and an operator identification of an operator of the interactive application.

5. The dynamic endpoint resolution wagering system of claim 1, wherein the interactive processing device determines the location information based on one or more of: information provided by a global positioning system (GPS) device of the interactive processing device, network data provided by a network device that is communicatively coupled to a communication interface device of the interactive processing device, and cellular tower location data received via the communication interface device of the interactive processing device.

6. The dynamic endpoint resolution wagering system of claim 1, wherein the management information entry comprises a plurality of attributes.

7. The dynamic endpoint resolution wagering system of claim 6, wherein the attributes comprise: a location identification attribute, an interactive application identification attribute, a user identification attribute, and an operator identification attribute.

8. The dynamic endpoint resolution wagering system of claim 6, wherein a priority value is assigned to each attribute, and the DER server determines the management information entry based on the priority values.

9. A dynamic endpoint resolution wagering system, comprising:
an interactive processing device of the dynamic endpoint resolution interleaved wagering system, the interactive processing device constructed to:
communicate, to a dynamic endpoint resolution (DER) server, session initiation request data comprising location information;
receive, from the DER server, session information; and
communicate, to a process controller, session establishment request data to establish a session of an interactive application with the process controller, the session establishment request data comprising a session token that uniquely identifies the session; and
the DER server of the dynamic endpoint resolution interleaved wagering system operatively connecting the interactive processing device to the process controller using a communication link, the DER server constructed to:
receive, from the interactive processing device, the session initiation request data;
communicate, to a geolocation server, the location information of the session initiation request data;
receive, from the geolocation server, location ID data determined based on the location information;
determine a management information entry based on the session initiation request data;
determine a process controller to use for the session requested in the session initiation request based on the determined management information entry;
generate session information, the session information comprising connection information for the process controller, the session token, and a deployment attribute value and a real currency credit wagering attribute value included in the management information entry;
store the session information in an active session database in association with the session initiation request data;
communicate, to the process controller, the session information; and
communicate, to the interactive processing device, the session information.

10. The dynamic endpoint resolution wagering system of claim 9, wherein the session initiation request data comprises: an interactive application identification of the interactive application of the interactive processing device; a user identification of a user of the interactive processing device; location information of the interactive processing device; and an operator identification of an operator of the interactive application.

11. The dynamic endpoint resolution wagering system of claim 9, wherein the interactive processing device determines the location information based on one or more of: information provided by a global positioning system (GPS) device of the interactive processing device, network data provided by a network device that is communicatively coupled to a communication interface device of the interactive processing device, and cellular tower location data received via the communication interface device of the interactive processing device.

12. The dynamic endpoint resolution wagering system of claim 9, wherein the management information entry comprises a plurality of attributes.

13. The dynamic endpoint resolution wagering system of claim 12, wherein the attributes comprise: a location identification attribute, an interactive application identification attribute, a user identification attribute, and an operator identification attribute.

14. The dynamic endpoint resolution wagering system of claim 12, wherein a priority value is assigned to each attribute, and the DER server determines the management information entry based on the priority values.

15. A dynamic endpoint resolution wagering system, comprising:
a process controller constructed to:
receive, from a dynamic endpoint resolution (DER) server, session information;
receive, from an interactive processing device, session establishment request data;
determine whether a session token received from the interactive processing device matches a session token received from the DER server;
determine that the session token received from the interactive processing device matches the session token received from the DER server; and
establish a session with the interactive processing device via an application control layer of the interactive processing device; and
the DER server of the dynamic endpoint resolution interleaved wagering system operatively connecting the process controller to the interactive processing device, the DER server constructed to:
receive, from the interactive processing device, the session initiation request data;
communicate, to a geolocation server, the location information of the session initiation request data;
receive, from the geolocation server, location ID data determined based on the location information;
determine a management information entry based on the session initiation request data;
determine a process controller to use for the session requested in the session initiation request based on the determined management information entry;
generate session information, the session information comprising connection information for the process controller, the session token, and a deployment attribute value and a real currency credit wagering attribute value included in the management information entry;
store the session information in an active session database in association with the session initiation request data;
communicate, to the process controller, the session information; and
communicate, to the interactive processing device, the session information.

16. The dynamic endpoint resolution wagering system of claim 15, wherein the session initiation request data comprises: an interactive application identification of the interactive application of the interactive processing device; a user identification of a user of the interactive processing device; location information of the interactive processing device; and an operator identification of an operator of the interactive application.

17. The dynamic endpoint resolution wagering system of claim 15, wherein the interactive processing device determines the location information based on one or more of: information provided by a global positioning system (GPS) device of the interactive processing device, network data provided by a network device that is communicatively coupled to a communication interface device of the interactive processing device, and cellular tower location data received via the communication interface device of the interactive processing device.

18. The dynamic endpoint resolution wagering system of claim 15, wherein the management information entry comprises a plurality of attributes.

19. The dynamic endpoint resolution wagering system of claim 18, wherein the attributes comprise: a location identification attribute, an interactive application identification attribute, a user identification attribute, and an operator identification attribute.

20. The dynamic endpoint resolution wagering system of claim 18, wherein a priority value is assigned to each attribute, and the DER server determines the management information entry based on the priority values.
